(19) United States
(12) Patent Application Publication
(10) Pub. No.: US 2024/0410441 A1
(43) Pub. Date: Dec. 12, 2024

(54) DAMPING FORCE GENERATION DEVICE

(71) Applicant: Hitachi Astemo, Ltd., Ibaraki (JP)

(72) Inventors: Takeru YOKOTA, Hitachinaka-shi (JP); Gota NAKANO, Hitachinaka-shi (JP); Mikio YAMASHITA, Hitachinaka-shi (JP)

(21) Appl. No.: 18/690,349

(22) PCT Filed: Dec. 21, 2022
(86) PCT No.: PCT/JP2022/047112

§ 371 Date: Mar. 8, 2024

(30) Foreign Application Priority Data
Dec. 24, 2021 (JP) 2021-210462

(51) Int. Cl. F16F 9/32; F16F 9/06; F16F 9/348; F16F 9/36; F16F 9/512

(52) U.S. Cl. CPC F16F 9/3214; F16F 9/348; F16F 9/369; F16F 9/512; F16F 9/065; F16F 2222/12; F16F 2228/066; F16F 2230/30

(57) ABSTRACT

A damping force generation device includes: a first regulation member configured to divide the inside of a tubular member into a first chamber and a second chamber and have a first flow path connected between the first chamber and the second chamber; and a second regulation member having a second flow path provided at least partially parallel to the first flow path and connected between the first chamber and the second chamber and a third flow path branching from the second flow path and connected to a pressure storage portion whose volume is changeable.

### TECHNICAL FIELD

The present invention relates to a damping force generation device.

Priority is claimed on Japanese Patent Application No. 2021-210462, filed Dec. 24, 2021, the content of which is incorporated herein by reference.

### BACKGROUND ART

There is a shock absorber having two valves that open in the same stroke (see, for example, Patent Document 1). Two valves that open in the same stroke are provided such that one valve can be opened in a lower piston speed region than the other valve and both valves can be opened in a higher speed region.

### CITATION LIST

### Patent Document

### [Patent Document 1]

Japanese Examined Patent Application, Second Publication No. H2-41666

### SUMMARY OF INVENTION

### Technical Problem

Meanwhile, in a damping force generation device, it is necessary to suppress the occurrence of abnormal noise.

An objective of the present invention is to provide a damping force generation device capable of suppressing the occurrence of abnormal noise.

### Solution to Problem

In order to achieve the above objective, according to an aspect of the present invention, there is provided a damping force generation device including: a first regulation member configured to divide an inside of a tubular member into a first chamber and a second chamber and have a first flow path connected between the first chamber and the second chamber; and a second regulation member having a second flow path provided at least partially parallel to the first flow path and connected between the first chamber and the second chamber and a third flow path branching from the second flow path and connected to a pressure storage portion whose volume is changeable.

### Advantageous Effects of Invention

A damping force generation device according to the above-described aspect of the present invention can suppress the occurrence of abnormal noise.

### BRIEF DESCRIPTION OF DRAWINGS

FIG. 1 is a cross-sectional view showing a shock absorber including a damping force generation device of a first embodiment according to the present invention.

FIG. 2 is a partial cross-sectional view showing the surroundings of the damping force generation device of the shock absorber including the damping force generation device of the first embodiment according to the present invention.

FIG. 3 is a partial cross-sectional view showing the surroundings of major portions of the damping force generation device of the shock absorber including the damping force generation device of the first embodiment according to the present invention.

FIG. 4 is a partial cross-sectional view showing the surroundings of major portions of a damping force generation device of a shock absorber including a damping force generation device of a second embodiment according to the present invention.

FIG. 5 is a partial cross-sectional view showing the surroundings of major portions of a damping force generation device of a shock absorber including a damping force generation device of a third embodiment according to the present invention.

FIG. 6 is a partial cross-sectional view showing the surroundings of major portions of a damping force generation device of a shock absorber including a damping force generation device of a fourth embodiment according to the present invention.

FIG. 7 is a partial cross-sectional view showing the surroundings of a damping force generation device of a shock absorber including the damping force generation device of a fifth embodiment according to the present invention.

FIG. 8 is a partial cross-sectional view showing the surroundings of the damping force generation device of the shock absorber including the damping force generation device of the fifth embodiment according to the present invention.

FIG. 9 is a partial cross-sectional view showing major portions of a damping force generation device of a shock absorber including the damping force generation device of a sixth embodiment according to the present invention.

FIG. 10 is a partial cross-sectional view showing major portions of a damping force generation device of a shock absorber including the damping force generation device of a seventh embodiment according to the present invention.

FIG. 11 is a partial cross-sectional view showing major portions of a damping force generation device of a shock absorber including the damping force generation device of an eighth embodiment according to the present invention.

FIG. 12 is a partial cross-sectional view showing major portions of a damping force generation device of a shock absorber including the damping force generation device of a ninth embodiment according to the present invention.

### DESCRIPTION OF EMBODIMENTS

### First Embodiment

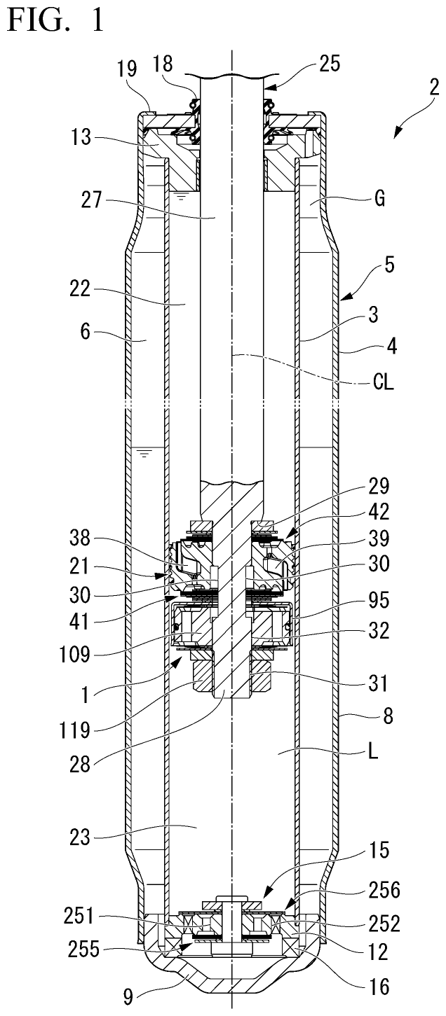

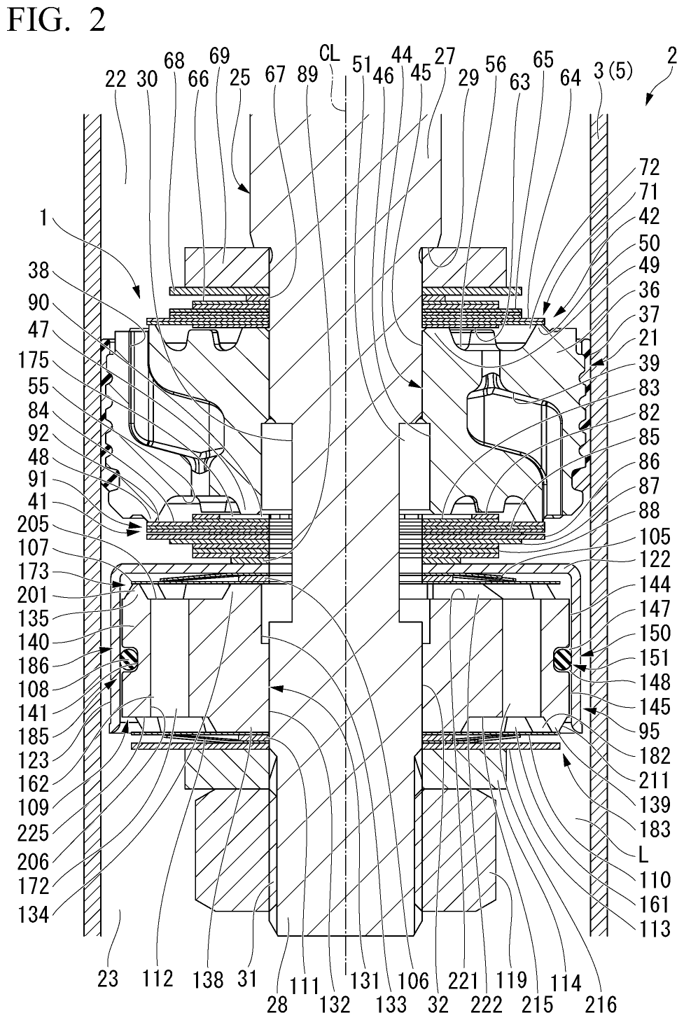

A first embodiment will be described on the basis of FIGS. 1 to 3. Hereinafter, for convenience of description, an upper side in FIGS. 1 and 2 will be referred to as “upper” and a lower side in FIGS. 1 and 2 will be referred to as “lower.” Moreover, reference sign CL of FIGS. 1 to 3 denotes a central axis of a damping force generation device 1.

### <Configuration>

As shown in FIG. 1, the damping force generation device 1 of the first embodiment is provided in a shock absorber 2. The shock absorber 2 is a shock absorber for use in a suspension device of a railway vehicle, a two-wheeled vehicle, or an automobile such as a four-wheeled vehicle. Specifically, the shock absorber 2 is a shock absorber for use in a suspension device of a four-wheeled automobile. The shock absorber 2 is a twin-tube shock absorber including a cylinder 5 having an inner tube 3 and an outer tube 4. The inner tube 3 is a tubular member, specifically a cylindrical member. The outer tube 4 is a bottomed tubular member having a larger diameter than the inner tube 3. The outer tube 4 is provided on a radially outward side of the inner tube 3 coaxially with the inner tube 3. A reservoir chamber 6 is between the outer tube 4 and the inner tube 3.

The outer tube 4 has a body member 8 and a bottom member 9. The body member 8 has a stepped cylindrical shape whose both axial ends have a smaller diameter than an intermediate portion in the axial direction. The bottom member 9 closes one end of the body member 8 in the axial direction. The opposite side of the bottom member 9 of the body member 8 is an opening.

The shock absorber 2 includes a valve body 12 and a rod guide 13. The valve body 12 is annular and is provided at one end of the inner tube 3 in the axial direction. The rod guide 13 is annular and is provided at the other ends of the inner tube 3 and the outer tube 4 in the axial direction. The valve body 12 constitutes a base valve 15 and the outer circumferential portion is in the shape of a step. In the valve body 12, a large diameter portion thereof is positioned and placed on the bottom member 9 in the radial direction. The rod guide 13 also has a stepped outer circumference.

The inner tube 3 has one end in the axial direction fitted to a small diameter portion of the outer circumferential portion of the valve body 12. The inner tube 3 has one end in the axial direction placed on the bottom member 9 of the outer tube 4 via the valve body 12. Moreover, the inner tube 3 has the other end in the axial direction fitted to a small diameter portion of the outer circumferential portion of the rod guide 13. The inner tube 3 has the other end in the axial direction fitted to the body member 8 of the outer tube 4 via the rod guide 13. In this state, the inner tube 3 is positioned in the radial direction with respect to the outer tube 4. Here, a space between the valve body 12 and the bottom member 9 is connected to a space between the inner tube 3 and the outer tube 4 via a passage groove 16 formed in the valve body 12. The space between the valve body 12 and the bottom member 9 constitutes the reservoir chamber 6 like the space between the inner tube 3 and the outer tube 4.

The shock absorber 2 includes a seal member 18. The seal member 18 is provided on the opposite side of the bottom member 9 of the rod guide 13. The seal member 18 is also fitted to the inner circumferential portion of the body member 8 like the rod guide 13. At an end of the opposite side of the bottom member 9 of the body member 8, a locking portion 19 is formed. The locking portion 19 is formed by plastically deforming the body member 8 radially inward by a caulking process such as curing. The seal member 18 is sandwiched between the locking portion 19 and the rod guide 13. The seal member 18 closes the opening of the outer tube 4 and is specifically an oil seal.

The damping force generation device 1 includes a piston 21 (first regulation member). The piston 21 is provided so that it can be slid into the cylinder 5. The piston 21 is slidably fitted to the inner tube 3 of the cylinder 5. The piston 21 divides the inner tube 3 into an upper chamber 22 (first chamber) and a lower chamber 23 (second chamber). The upper chamber 22 is provided between the piston 21 in the inner tube 3 and the rod guide 13. The lower chamber 23 is provided between the piston 21 in the inner tube 3 and the valve body 12. The lower chamber 23 is defined as the reservoir chamber 6 by the valve body 12. In the cylinder 5, an oil liquid L serving as a working fluid is enclosed in the upper chamber 22 and the lower chamber 23. In the cylinder 5, a gas G and an oil liquid L serving as a working fluid are enclosed in the reservoir chamber 6.

The damping force generation device 1 includes a piston rod 25 (shaft member). The piston rod 25 has a portion of one end in the axial direction arranged inside of the cylinder 5 and is connected to the piston 21. The piston rod 25 has a portion of the other end in the axial direction extended outside of the cylinder 5. The piston rod 25 is made of a metal and penetrates through the upper chamber 22. The piston rod 25 does not penetrate through the lower chamber 23. Therefore, the upper chamber 22 is a rod-side chamber through which the piston rod 25 penetrates. The lower chamber 23 is a bottom-side chamber on the bottom member 9 side of the cylinder 5.

The piston 21 is fixed to the piston rod 25 and moves integrally with the piston rod 25. In the extension stroke of the shock absorber 2 in which the piston rod 25 increases an amount of protrusion from the cylinder 5, the piston 21 moves to the upper chamber 22 side. In the compression stroke of the shock absorber 2 in which the piston rod 25 decreases the amount of protrusion from the cylinder 5, the piston 21 moves to the lower chamber 23 side.

Both the rod guide 13 and the seal member 18 are annular. The piston rod 25 is slidably inserted inside of each of the rod guide 13 and the seal members 18. The piston rod 25 is extended from the inside to the outside of the cylinder 5 through the rod guide 13 and the seal member 18. The piston rod 25 has a portion of one end in the axial direction fixed to the piston 21 inside of the cylinder 5. The piston rod 25 has the other end portion in the axial direction extending to the outside of the cylinder 5 via the rod guide 13 and the seal member 18.

The rod guide 13 supports the piston rod 25 with respect to the cylinder 5 so that the movement in its radial direction can be regulated and the movement in its axial direction is possible. The rod guide 13 guides the movement of the piston rod 25 in the axial direction.

The seal member 18 has an outer circumferential portion adhering to an inner circumferential portion on the opening side of the body member 8 of the outer tube 4 of the cylinder 5. The seal member 18 has an inner circumferential portion slidably in contact with the outer circumferential portion of the piston rod 25 moving in the axial direction. Thereby, the seal member 18 prevents the oil liquid L or the gas G in the cylinder 5 from leaking out.

The piston rod 25 has a main shaft portion 27 and a mounting shaft portion 28. The mounting shaft portion 28 has an outer diameter smaller than the outer diameter of the main shaft portion 27. The piston rod 25 has the main shaft portion 27 slidably fitted to the rod guide 13 and the seal member 18. In the piston rod 25, the mounting shaft portion 28 is arranged in the cylinder 5 and connected to the piston 21. An end of the mounting shaft portion 28 side of the main shaft portion 27 is an axial step portion 29 extending in an axial orthogonal direction.

A passage notch 30 is formed on the outer circumferential portion of the mounting shaft portion 28. The passage notch 30 is formed at an intermediate position of the mounting shaft portion 28 in the axial direction and extends in the axial direction of the mounting shaft portion 28. The passage notch 30 is formed, for example, by cutting out the outer circumferential portion of the mounting shaft portion 28 in a plane shape on a surface parallel to the central axis of the mounting shaft portion 28. The passage notch 30 is formed at two positions between which there is a difference of 180 degrees in a circumferential direction of the mounting shaft portion 28. On the outer circumferential portion of the mounting shaft portion 28, a male thread 31 is formed at a tip position on the opposite side of the main shaft portion 27 of the axial passage notch 30. A part of the mounting shaft portion 28 other than the male thread 31 serves as a fitting shaft portion 32. The fitting shaft portion 32 has a cylindrical shape whose outer circumferential surface is a cylindrical surface. The passage notch 30 is formed in an intermediate portion of the fitting shaft portion 32 in the axial direction.

In the twin-tube shock absorber 2, a protrusion portion from the cylinder 5 of the piston rod 25 is arranged on an upper part in a vertical direction and is supported by a vehicle body. At this time, in the shock absorber 2, the bottom member 9 of the cylinder 5 is arranged on a lower part in the vertical direction and connected to a wheel side. In contrast, in the case of a single-tube shock absorber, it is also possible to have the cylinder 5 side supported by the car body and the piston rod 25 connected to the wheel side.

As shown in FIG. 2, the piston 21 includes a piston body 36 made of a metal and a sliding member 37 made of a synthetic resin. The piston body 36 is connected to the piston rod 25. The sliding member 37 is integrally attached to the outer circumferential surface of the piston body 36. In the piston 21, the sliding member 37 comes into contact with the inner tube 3 of the cylinder 5 and slides in the inner tube 3.

The piston body 36 includes a plurality of passage holes 38 (only one location is shown in a cross-sectional relationship in FIG. 2) and a plurality of passage holes 39 (only one location is shown in the cross-sectional relationship in FIG. 2). Each of the plurality of passage holes 38 and the plurality of passage holes 39 can be connected to the upper chamber 22 and the lower chamber 23.

The plurality of passage holes 38 are arranged at equal pitches in the circumferential direction of the piston body 36. The plurality of passage holes 38 are arranged in the circumferential direction of the piston body 36 with one passage hole 39 sandwiched therebetween. The number of passage holes 38 is half the total number of passage holes 38 and 39. In each of the plurality of passage holes 38, the end of the lower chamber 23 side in the axial direction of the piston 21 opens further inward in the radial direction of the piston 21 than the end of the upper chamber 22 side. In the piston body 36, an annular groove 55 having an annular shape is formed on the lower chamber 23 side in the axial direction. The annular groove 55 connects the plurality of passage holes 38.

The damping force generation device 1 has a first damping force generation mechanism 41 on the lower chamber 23 side of the annular groove 55. The first damping force generation mechanism 41 generates a damping force by opening and closing a passage in the plurality of passage holes 38 and the annular groove 55. When the first damping force generation mechanism 41 is arranged on the lower chamber 23 side, the passage in the plurality of passage holes 38 and the annular groove 55 is an extension-side passage through which the oil liquid L flows out from the upper chamber 22 serving as an upstream side toward the lower chamber 23 serving as a downstream side in the movement of the piston 21 to the upper chamber 22 side, i.e., the extension stroke. The first damping force generation mechanism 41 is provided in the plurality of passage holes 38 of the extension side and the annular groove 55. The first damping force generation mechanism 41 is an extension-side damping force generation mechanism for generating a damping force by suppressing the flow of the oil liquid L from the passage in the plurality of passage holes 38 of the extension side and the annular groove 55 to the lower chamber 23.

The number of passage holes 39 is half the total number of passage holes 38 and 39 and the plurality of passage holes 39 are arranged at equal pitches in the circumferential direction of the piston body 36. The plurality of passage holes 39 are arranged with one passage hole 38 sandwiched therebetween. In each of the plurality of passage holes 39, the end of the upper chamber 22 side in the axial direction of the piston 21 opens further inward in the radial direction of the piston 21 than the end of the lower chamber 23 side. In the piston body 36, an annular groove 56 having an annular shape is formed on the upper chamber 22 side in the axial direction. The annular groove 56 connects the plurality of passage holes 39.

The damping force generation device 1 has a first damping force generation mechanism 42 on the upper chamber 22 side of the annular groove 56. The first damping force generation mechanism 42 generates a damping force by opening and closing the passage in the plurality of passage holes 39 and the annular groove 56. When the first damping force generation mechanism 42 is arranged on the upper chamber 22 side, the passage in the plurality of passage holes 39 and the annular groove 56 is a compression-side passage through which the oil liquid L flows out from the lower chamber 23 on the upstream side toward the upper chamber 22 on the downstream side in the movement of the piston 21 to the lower chamber 23 side, i.e., the compression stroke. The first damping force generation mechanism 42 is provided for the passage in the plurality of passage holes 39 of the compression side and the annular groove 56. The first damping force generation mechanism 42 is a compression-side damping force generation mechanism for generating a damping force by suppressing the flow of the oil liquid L from the passage in the plurality of passage holes 39 of the compression side and the annular groove 56 to the upper chamber 22.

The piston body 36 has substantially a disc shape and an insertion hole 44 is formed in the center in the radial direction. The insertion hole 44 penetrates through the piston body 36 in its axial direction. The mounting shaft portion 28 of the piston rod 25 is inserted into the insertion hole 44. The insertion hole 44 has a small diameter hole 45 and a large diameter hole 46. The small diameter hole 45 is arranged on one side from the center of the insertion hole 44 in the axial direction. The large diameter hole 46 is arranged on the other side from the center of the insertion hole 44 in the axial direction of the insertion hole 44. The inner diameter of the large diameter hole 46 is larger than the inner diameter of the small diameter hole 45. In the piston body 36, the small diameter hole 45 is provided on the upper chamber 22 side in the axial direction and the large diameter hole 46 is provided on the lower chamber 23 side in the axial direction. In the piston 21, the fitting shaft portion 32 of the piston rod 25 is fitted to the small diameter hole 45. Thereby, the piston 21 is positioned in the radial direction with respect to the piston rod 25.

At the end of the lower chamber 23 side in the axial direction of the piston body 36, an inner seat portion 47 and a valve seat portion 48 are formed. The inner seat portion 47 is arranged further inward in the radial direction of the piston body 36 than the opening on the lower chamber 23 side of the annular groove 55. The inner seat portion 47 is annular. The valve seat portion 48 is arranged further outward in the radial direction of the piston body 36 than the opening on the lower chamber 23 side of the annular groove 55. The valve seat portion 48 is annular. The valve seat portion 48 constitutes a part of the first damping force generation mechanism 41.

At the end of the upper chamber 22 side in the axial direction of the piston body 36, an inner seat portion 49 and a valve seat portion 50 are formed. The inner seat portion 49 is arranged further inward in the radial direction of the piston body 36 than the opening on the upper chamber 22 side of the annular groove 56. The inner seat portion 49 is annular. The valve seat portion 50 is arranged further outward in the radial direction of the piston body 36 than the opening on the upper chamber 22 side of the annular groove 56. The valve seat portion 50 is annular. The valve seat portion 50 constitutes a part of the first damping force generation mechanism 42.

In the insertion hole 44 of the piston body 36, a large diameter hole 46 is provided closer to the inner seat portion 47 side in the axial direction than the small diameter hole 45. The passage in the large diameter hole 46 of the piston body 36 overlaps the piston rod passage portion 51 in the passage notch 30 of the piston rod 25 at a position in the axial direction. The passage in the large diameter hole 46 is continuously connected to the piston rod passage portion 51.

In the piston body 36, an opening on the lower chamber 23 side of the passage hole 39 of the compression side is arranged on a radially outward side of the valve seat portion 48. Moreover, in the piston body 36, an opening on the upper chamber 22 side of the passage hole 38 on the extension side is arranged on the radially outward side of the valve seat portion 50.

The first damping force generation mechanism 42 of the compression side includes the valve seat portion 50 of the piston 21. The first damping force generation mechanism 42 includes a disc 63, a plurality of (specifically, two) discs 64, a plurality of (specifically, three) discs 65, a plurality of (specifically, two) discs 66, a disc 67, a disc 68, and an annular member 69 in order from the piston 21 side in the axial direction. The plurality of discs 64 have the same outer diameter as each other. The plurality of discs 65 have the same outer diameter as each other. The plurality of discs 66 have the same outer diameter as each other. Each of the discs 63 to 68 and the annular member 69 is made of a metal and has a perforated circular plate shape having a uniform thickness and a uniform radial width across the entire circumference. Each of the discs 63 to 68 and the annular member 69 is positioned in the radial direction with respect to the piston rod 25 by fitting the fitting shaft portion 32 inside. Each of the discs 63 to 68 is a plain disc. A plain disc is a planar disc without any protrusion protruding in the axial direction.

The disc 63 has an outer diameter larger than the outer diameter of the inner seat portion 49 of the piston 21 and smaller than the inner diameter of the valve seat portion 50. The disc 63 comes into contact with the inner seat portion 49. The plurality of discs 64 have an outer diameter equivalent to the outer diameter of the valve seat portion 50 of the piston 21. In the plurality of discs 64, the disc 64 closest to the disc 63 can be seated in the valve seat portion 50. The plurality of discs 65 have an outer diameter smaller than the outer diameter of the disc 64. The plurality of discs 66 have an outer diameter smaller than the outer diameter of the disc 65. The disc 67 has an outer diameter smaller than the outer diameter of the disc 66 and slightly smaller than the outer diameter of the inner seat portion 49 of the piston 21. The disc 68 has an outer diameter equivalent to the outer diameter of the disc 65. The annular member 69 has an outer diameter smaller than the outer diameter of the disc 68 and larger than the outer diameter of the axial step portion 29 of the piston rod 25. The annular member 69 is thicker and more rigid than the discs 63 to 68 and is in contact with the axial step portion 29.

The plurality of discs 64, the plurality of discs 65, and the plurality of discs 66 constitute a compression-side main valve 71 that can be detachably seated in the valve seat portion 50. The main valve 71 is seated away from the valve seat portion 50 and connects the passage in the plurality of passage holes 39 and the annular groove 56 to the upper chamber 22. At this time, the main valve 71 suppresses the flow of the oil liquid L with the valve seat portion 50 and generates a damping force. The annular member 69 regulates deformation of the main valve 71 in an opening direction at a regulation level or more with the disc 68 in contact with the main valve 71.

The passage in the plurality of passage holes 39 and the annular groove 56 and the passage between the main valve 71 and the valve seat portion 50 appearing at the time of valve opening constitute the first passage 72. The first passage 72 connects the lower chamber 23 and the upper chamber 22. In other words, the piston 21 has the first passage 72 configured to connect the lower chamber 23 and the upper chamber 22. The piston 21 defines the first passage 72. In the first passage 72, the oil liquid L flows out from the lower chamber 23 on the upstream side in the cylinder 5 to the upper chamber 22 on the downstream side due to the movement of the piston 21 to the lower chamber 23 side. The first passage 72 is a passage on the compression side. The compression-side first damping force generation mechanism 42 that generates the damping force includes the main valve 71 and the valve seat portion 50. Therefore, the first damping force generation mechanism 42 is provided in the first passage 72. The first passage 72 is provided on the piston 21 including the valve seat portion 50 and the oil liquid L passes therethrough when the piston rod 25 and the piston 21 move to the compression side.

Here, in the first damping force generation mechanism 42 on the compression side, no fixed orifice is formed in either the valve seat portion 50 or the main valve 71 in contact therewith. A fixed orifice connects the upper chamber 22 and the lower chamber 23 even if the valve seat portion 50 and the main valve 71 are in contact with each other. That is, the first damping force generation mechanism 42 on the compression side does not connect the upper chamber 22 and the lower chamber 23 if the valve seat portion 50 and the main valve 71 are in contact with each other across the entire circumference. In other words, a fixed orifice continuously connecting the upper chamber 22 and the lower chamber 23 is not provided in the first passage 72. The first passage 72 is not a passage continuously connecting the upper chamber 22 and the lower chamber 23.

The first damping force generation mechanism 41 on the extension side includes the valve seat portion 48 of the piston 21. The first damping force generation mechanism 41 includes a disc 82, a disc 83, a plurality of (specifically, three) discs 84, a disc 85, a disc 86, a disc 87, a plurality of (specifically, three) discs 88, and a disc 89 in order from the piston 21 side in the axial direction. The plurality of discs 84 have the same outer diameter as each other. The plurality of discs 88 have the same outer diameter as each other. The discs 82 to 89 are made of a metal and are annular. Each of the discs 83 to 89 is a plain disc having a perforated circular flat plate having a uniform thickness and a uniform radial width across the entire circumference. Each of the discs 82 to 89 is positioned in the radial direction with respect to the piston rod 25 by fitting the fitting shaft portion 32 inside.

The disc 82 has an outer diameter larger than the outer diameter of the inner seat portion 47 of the piston 21 and smaller than the inner diameter of the valve seat portion 48. The disc 82 is in contact with the inner seat portion 47. In the disc 82, a notch 90 is formed from an intermediate position outside of the inner seat portion 47 in the radial direction to an inner circumferential edge portion. The notch 90 continuously connects a passage in the annular groove 55 and the plurality of passage holes 38 to the passage in the large diameter hole 46 of the piston 21 and the piston rod passage portion 51 of the piston rod 25. The notch 90 is formed during press molding of the disc 82. The disc 83 has the same outer diameter as the disc 82 and no notch is formed as in the disc 82. The plurality of discs 84 have an outer diameter equivalent to the outer diameter of the valve seat portion 48 of the piston 21. A disc 84 closest to the disc 83 among the plurality of discs 84 can be seated in the valve seat portion 48. The disc 85 has an outer diameter smaller than the outer diameter of the disc 84. The disc 86 has an outer diameter equivalent to the outer diameter of the disc 84. The disc 87 has an outer diameter smaller than the outer diameter of the disc 86. The plurality of discs 88 have an outer diameter smaller than the outer diameter of the disc 87. The disc 89 has an outer diameter smaller than the outer diameter of the disc 88 and slightly larger than the outer diameter of the inner seat portion 47 of the piston 21.

The plurality of discs 84, the disc 85, the disc 86, the disc 87, and the plurality of discs 88 constitute an extension-side main valve 91 that can be detachably seated in the valve seat portion 48. The main valve 91 is seated away from the valve seat portion 48 and connects the passage in the annular groove 55 and the plurality of passage holes 38 to the lower chamber 23. At this time, the main valve 91 suppresses the flow of the oil liquid L with the valve seat portion 48 and generates a damping force.

The passage in the plurality of passage holes 38 and the annular groove 55 and the passage between the main valve 91 and the valve seat portion 48 appearing at the time of valve opening constitutes the first passage 92 (first flow path). The first passage 92 is formed on the piston 21. The first passage 92 connects the upper chamber 22 and the lower chamber 23. In other words, the piston 21 has the first passage 92 that connects the upper chamber 22 and the lower chamber 23. The piston 21 defines the first passage 92. In the first passage 92, the oil liquid L flows out from the upper chamber 22 on the upstream side in the cylinder 5 to the lower chamber 23 on the downstream side due to the movement of the piston 21 to the upper chamber 22 side. The first passage 92 is an extension-side passage. The extension-side first damping force generation mechanism 41 that generates the damping force includes the main valve 91 and the valve seat portion 48. Therefore, the first damping force generation mechanism 41 is provided in the first passage 92. The first passage 92 is provided on the piston 21 including the valve seat portion 48 and the oil liquid L passes therethrough when the piston rod 25 and the piston 21 move to the extension side.

In the first damping force generation mechanism 41 on the extension side, a fixed orifice is not formed on either the valve seat portion 48 or the main valve 91 in contact therewith. A fixed orifice connects the upper chamber 22 and the lower chamber 23 even if the valve seat portion 48 and the main valve 91 are in contact with each other. That is, the first damping force generation mechanism 41 on the extension side does not connect the upper chamber 22 and the lower chamber 23 if the valve seat portion 48 and the main valve 91 are in contact with each other across the entire circumference. In other words, a fixed orifice continuously connecting the upper chamber 22 and the lower chamber 23 is not provided in the first passage 92. The first passage 92 is not a passage continuously connecting the upper chamber 22 and the lower chamber 23.

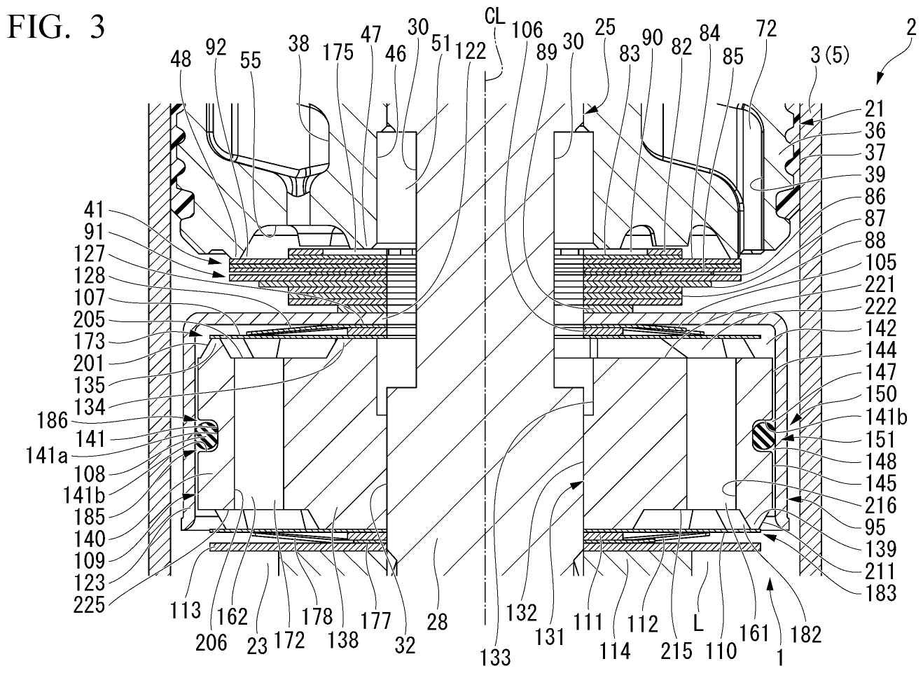

As shown in FIG. 3, the damping force generation device 1 has a case member 95, a spring member 105, a disc 106, a sub-valve 107, and a valve seat member 109 (second regulation member) in order from the disc 89 side on the opposite side of the piston 21 in the axial direction of the disc 89. Moreover, the damping force generation device 1 has an O-ring 108 (elastic member) provided on the outer circumferential side of the valve seat member 109. Moreover, the damping force generation device 1 has a sub-valve 110, a disc 111, a spring member 112, a disc 113, and an annular member 114 in order from the valve seat member 109 side on the opposite side of the sub-valve 107 in the axial direction of the valve seat member 109.

The case member 95, the spring members 105 and 112, the discs 106, 111, and 113, the sub-valves 107 and 110, and the valve seat member 109 are fitted inside of the fitting shaft portion 32 of the mounting shaft portion 28 of the piston rod 25. The annular member 114 causes the male thread 31 of the mounting shaft portion 28 to be fitted inside. Thereby, the case member 95, the spring members 105 and 112, the discs 106, 111, and 113, the sub-valves 107 and 110, the valve seat member 109, and the annular member 114 are positioned in the radial direction with respect to the piston rod 25.

As shown in FIG. 2, in the mounting shaft portion 28 of the piston rod 25, the male thread 31 is formed in a portion protruding from the annular member 114 in the axial direction on the opposite side of the disc 113. A nut 119 is screwed onto the male thread 31. The nut 119 is in contact with the annular member 114.

The annular members 69 and 114, the discs 63 to 68, 82 to 89, 106, 111, and 113, the piston 21, the case member 95, the spring members 105 and 112, the sub-valves 107 and 110, and the valve seat member 109 are clamped in the axial direction by the axial step portion 29 and the nut 119 on at least the inner circumferential side thereof in the radial direction. Therefore, the annular members 69 and 114, the discs 63 to 68, 82 to 89, 106, 111, and 113, the piston 21, the case member 95, the spring members 105 and 112, the sub-valves 107 and 110, and the valve seat member 109 are fixed to the piston rod 25 on at least the inner circumferential side thereof in the radial direction.

As shown in FIG. 3, the spring member 105, the disc 106, the sub-valve 107, the O-ring 108, and the valve seat member 109 are arranged in the case member 95. In other words, the spring member 105, the disc 106, the sub-valve 107, the O-ring 108, and the valve seat member 109 are covered with the case member 95. Each of the case member 95, the spring members 105 and 112, the discs 106, 111, and 113, the sub-valves 107 and 110, the valve seat member 109, and the annular member 114 is made of a metal. Each of the discs 106, 111, and 113, the sub-valves 107 and 110, and the annular member 114 is a plain disc having a perforated circular flat plate having a uniform thickness and a uniform radial width across the entire circumference. Each of the case member 95 and the valve seat member 109 has an annular shape having a uniform radial width across the entire circumference. The spring members 105 and 112 are annular.

The case member 95 is an integrally molded product in the shape of a bottomed tubular shape, and is formed by, for example, plastic processing or cutting of a metallic plate. The case member 95 has a bottom portion 122 and a tubular portion 123. The bottom portion 122 has a perforated disc shape of a certain thickness. The tubular portion 123 extends from the outer circumferential edge portion of the bottom portion 122 in the axial direction of the bottom portion 122. The tubular portion 123 has a cylindrical shape.

The bottom portion 122 has a perforated circular flat plate shape with a uniform radial width across the entire circumference. The bottom portion 122 causes the fitting shaft portion 32 of the piston rod 25 to be fitted to the inner circumferential portion. Thereby, the case member 95 is positioned in the radial direction with respect to the piston rod 25 and arranged in a coaxial shape. The case member 95 is arranged in a direction in which the bottom portion 122 is located closer to the piston 21 side than the tubular portion 123 in its axial direction and is in contact with the disc 89.

The case member 95 is thicker than one of the discs 84 to 88 and has a bottomed tubular shape, thereby making it more rigid than the discs 84 to 88. Therefore, the case member 95 regulates deformation in the opening direction of the main valve 91 including a plurality of discs 84 to 88 at a regulation level or more in contact with the main valve 91.

The spring member 105 has a substrate portion 127 and a plurality of spring plate portions 128. The substrate portion 127 has a perforated circular flat plate shape with a uniform radial width across the entire circumference. The substrate portion 127 causes the fitting shaft portion 32 to be fitted to the inner circumferential portion thereof. Thereby, the substrate portion 127 is positioned in the radial direction with respect to the piston rod 25 and is arranged in a coaxial shape. The plurality of spring plate portions 128 extend from positions at equal intervals in the circumferential direction of the substrate portion 127 to a position radially outward from the substrate portion 127. The spring plate portion 128 is inclined with respect to the substrate portion 127 to move away from the substrate portion 127 in the axial direction of the substrate portion 127 as a distance to an extension tip side decreases. In the spring member 105, the substrate portion 127 is in contact with the bottom portion 122 of the case member 95. The spring member 105 is attached to the mounting shaft portion 28 so that the spring plate portion 128 extends from the substrate portion 127 to the sub-valve 107 side in the axial direction of the substrate portion 127. In the spring member 105, a plurality of spring plate portions 128 are in contact with the sub-valve 107.

The disc 106 has an outer diameter smaller than the outer diameter of the substrate portion 127 of the spring member 105. In the spring member 105, the substrate portion 127 is in contact with the disc 106 and the plurality of spring plate portions 128 are in contact with the sub-valve 107.

The valve seat member 109 has a perforated disc shape. In the valve seat member 109, a through hole 131 is formed in the center in the radial direction. The through hole 131 extends in the axial direction of the valve seat member 109 and penetrates through the valve seat member 109 in the axial direction. The mounting shaft portion 28 of the piston rod 25 is inserted into the through hole 131. The through hole 131 has a first hole 132 and a second hole 133. An inner diameter of the second hole 133 is larger than an inner diameter of the first hole 132. The first hole 132 is provided on one side in the axial direction of the through hole 131 in the through hole 131. The second hole 133 is provided in the through hole 131 from the center in the axial direction of the through hole 131 to the other side. The fitting shaft portion 32 of the piston rod 25 is fitted to the first hole 132. Thereby, the valve seat member 109 is positioned in the radial direction with respect to the piston rod 25 and arranged in a coaxial shape.

The valve seat member 109 has an inner seat portion 134 and a valve seat portion 135 at the end of the second hole 133 side in the axial direction. The inner seat portion 134 is annular around the second hole 133. The valve seat portion 135 extends radially outward from the inner seat portion 134. Moreover, the valve seat member 109 has an inner seat portion 138 and a valve seat portion 139 at the end of the first hole 132 side on the opposite side in the axial direction. The inner seat portion 138 is annular around the first hole 132. The valve seat portion 139 extends radially outward from the inner seat portion 138. The valve seat member 109 has a main body portion 140 between the inner seat portion 134 and the valve seat portion 135 in the axial direction and the inner seat portion 138 and the valve seat portion 139. The main body portion 140 is in a perforated disc shape.

The inner seat portion 134 protrudes from the inner circumferential portion of the end of the second hole 133 side in the axial direction of the main body portion 140 to one side in the axial direction of the main body portion 140. The valve seat portion 135 protrudes from the main body portion 140 to the same side as the inner seat portion 134 in the axial direction of the main body portion 140 on the radially outward side of the inner seat portion 134. In the inner seat portion 134, a tip surface on the protrusion side, i.e., a tip surface on the opposite side of the main body portion 140, is a flat surface. In the valve seat portion 135, a tip surface on the protrusion side, i.e., a tip surface on the opposite side of the main body portion 140, is a flat surface. The tip surface on the protrusion side of the inner seat portion 134 and the tip surface on the protrusion side of the valve seat portion 135 are spread in an axial orthogonal direction of the valve seat member 109 and arranged on the same plane.

The inner seat portion 138 protrudes from the inner circumferential portion of the end of the axial first hole 132 side in the axis direction of the main body portion 140 to the opposite side of the inner seat portion 134 in the axial direction of the main body portion 140. The valve seat portion 139 protrudes from the main body portion 140 to the same side as the inner seat portion 138 in the axial direction of the main body portion 140 on the radially outward side of the inner seat portion 138. In the inner seat portion 138, a tip surface on the protrusion side, i.e., a tip surface on the opposite side of the main body portion 140, is a flat surface. In the valve seat portion 139, a tip surface on the protrusion side, i.e., a tip surface on the opposite side of the main body portion 140, is a flat surface. The tip surface on the protrusion side of the inner seat portion 138 and the tip surface on the protrusion side of the valve seat portion 139 are spread in the axial orthogonal direction of the valve seat member 109 and arranged on the same plane.

The valve seat portion 135 is a non-circular, petal-shaped variant seat. The valve seat portion 135 has a plurality of valve seat components 201. These valve seat components 201 have the same shape and are arranged at equal intervals in the circumferential direction of the valve seat member 109. The inner seat portion 134 forms an annular shape centered on the central axis of the valve seat member 109. The plurality of valve seat components 201 extend radially from the inner seat portion 134.

A passage concave portion 205 is formed inside of each valve seat component 201. The passage concave portion 205 is formed by being surrounded by a part of the inner seat portion 134 and the valve seat component 201. The passage concave portion 205 is concave in the axial direction of the valve seat member 109 from the tip surface of the protrusion side of the inner seat portion 134 and the tip surface of the protrusion side of the valve seat component 201. The bottom surface of the passage concave portion 205 is formed by the main body portion 140. The passage concave portion 205 is formed inside of all valve seat components 201.

A passage hole 206 is formed at a central position of the passage concave portion 205 in the circumferential direction of the valve seat member 109. The passage hole 206 penetrates through the valve seat member 109 in the axial direction by penetrating through the main body portion 140 in the axial direction. The passage hole 206 is a straight hole parallel to the central axis of the valve seat member 109. The passage hole 206 is formed on the bottom surfaces of all passage concave portions 205.

The valve seat portion 139 is also a non-circular, petal-shaped variant seat. The valve seat portion 139 has a plurality of valve seat components 211. These valve seat components 211 have the same shape and are arranged at equal intervals in the circumferential direction of the valve seat member 109. The inner seat portion 138 forms an annular shape centered on the central axis of the valve seat member 109. The plurality of valve seat components 201 extend radially from the inner seat portion 138. The valve seat component 211 has the same shape as the valve seat component 201.

A passage concave portion 215 is formed inside of each valve seat component 211. The passage concave portion 215 is formed by being surrounded by a part of the inner seat portion 138 and the valve seat component 211. The passage concave portion 215 is concave in the axial direction of the valve seat member 109 from the tip surface of the protrusion side of the inner seat portion 138 and the tip surface of the protrusion side of the valve seat component 211. The bottom surface of the passage concave portion 215 is formed by the main body portion 140. The passage concave portion 215 is formed inside of all valve seat components 211.

A passage hole 216 is formed at a central position of the passage concave portion 215 in the circumferential direction of the valve seat member 109. The passage hole 216 penetrates through the valve seat member 109 in the axial direction by penetrating through the main body portion 140 in the axial direction. The passage hole 216 is a straight hole parallel to the central axis of the valve seat member 109. The passage hole 216 is formed on the bottom surface of all passage concave portions 215.

Here, an arrangement pitch of the plurality of valve seat components 201 in the circumferential direction of the valve seat member 109 is the same as an arrangement pitch of the plurality of valve seat components 211 in the circumferential direction of the valve seat member 109. Also, the valve seat component 201 and the valve seat component 211 are shifted from each other by half the arrangement pitch in the circumferential direction of the valve seat member 109. The passage hole 206 is arranged between the valve seat component 211 and the valve seat component 211 adjacent in the circumferential direction of the valve seat member 109. Therefore, the passage hole 206 is arranged outside of the range of the valve seat portion 139. The passage hole 216 is arranged between the valve seat component 201 and the valve seat component 201 adjacent in the circumferential direction of the valve seat member 109. Therefore, the passage hole 216 is arranged outside of the range of the valve seat portion 135.

The valve seat member 109 has a passage groove 221 on the second hole 133 side in the axial direction. The passage groove 221 is formed on the inner seat portion 134 by crossing the inner seat portion 134 in its radial direction. The passage groove 221 is concave in the axial direction of the valve seat member 109 from the tip surface on the opposite side of the main body portion 140 of the inner seat portion 134. The passage groove 221 also includes a space between adjacent valve seat components 201 in the circumferential direction of the valve seat member 109. The passage hole 216 is open in the bottom surface of the passage groove 221. The radial passage 222 in the passage groove 221 extends in the radial direction of the valve seat member 109 and connects the passage in the passage hole 216 and the passage in the second hole 133. A plurality of radial passages 222 are provided in the valve seat member 109 at equal intervals in the circumferential direction of the valve seat member 109.

The passage in the passage hole 216 and the passage in the passage concave portion 215 in which the passage hole 216 is opened constitute a passage portion 161 provided in the valve seat member 109. In the valve seat member 109, a plurality of passage portions 161 are provided at equal intervals in the circumferential direction of the valve seat member 109. The passage portion 161 and the radial passage 222 are connected.

The valve seat member 109 has a passage groove 225 between adjacent valve seat components 211 in the circumferential direction of the valve seat member 109. The passage hole 206 is opened in the bottom surface of the passage groove 225. Therefore, the passage in the passage groove 225 is connected to the passage in the passage hole 206.

The passage hole 206 and the passage concave portion 205 in which the passage hole 206 is opened form a passage portion 162 provided in the valve seat member 109. In the valve seat member 109, a plurality of passage portions 162 are provided at equal intervals in the circumferential direction of the valve seat member 109. The passage portion 162 is connected to the passage in the passage groove 225.

In the valve seat member 109, a seal groove 141 is formed at a central position of the outer circumferential portion of the main body portion 140 in the axial direction. The seal groove 141 is annular and concave inward from the outer circumferential surface of the main body portion 140 in the radial direction. The seal groove 141 has a bottom portion 141a arranged inside of the valve seat member 109 in the radial direction and a pair of sidewall portions 141b arranged on both sides of the valve seat member 109 in the axial direction. The bottom portion 141a has a cylindrical surface shape in which the groove bottom surface facing the radially outward side of the valve seat member 109 is in the axial direction of the valve seat member 109. The pair of sidewall portions 141b have a planar shape in which wall surfaces facing each other in the axial direction of the valve seat member 109 extend perpendicular to the axial direction of the valve seat member 109. The O-ring 108 is arranged in the seal groove 141. The O-ring 108 is an annular part having elasticity such as rubber. In a state in which the O-ring 108 has an overall annular shape before being assembled to the valve seat member 109, a cross-section becomes a circle when the cross-section is taken along a plane including the central axis of the annular ring.

The valve seat member 109 is fitted to the tubular portion 123 of the case member 95 at the outer circumferential portion of the main body portion 140 in a state in which the inner seat portion 138 and the valve seat portion 139 are facing opposite to the bottom portion 122 of the case member 95. In this state, the O-ring 108 is in contact with an inner circumferential surface of the tubular portion 123 of the case member 95 and a groove bottom surface of the bottom portion 141a at an innermost end in the concave direction of the seal groove 141 of the valve seat member 109 to continuously seal a gap therebetween.

The case member 95 and the valve seat member 109 have a case chamber 142 inside. The case chamber 142 is provided between the bottom portion 122 of the case member 95 and the valve seat member 109. The spring member 105, the disc 106, and the sub-valve 107 are provided in the case chamber 142.

Here, the outer diameter of the portion other than the seal groove 141 of the main body portion 140 of the valve seat member 109 is smaller than the inner diameter of the tubular portion 123 of the case member 95 by a predetermined value. The valve seat member 109 is fitted to the fitting shaft portion 32 of the piston rod 25 and hence is positioned in the radial direction with respect to the mounting shaft portion 28. Moreover, the case member 95 is also fitted to the fitting shaft portion 32 of the piston rod 25 and hence is positioned in the radial direction with respect to the mounting shaft portion 28. In this state, a gap is formed across the entire circumference between the outer circumferential surface of the portion other than the seal groove 141 of the main body portion 140 and the inner circumferential surface of the tubular portion 123 of the case member 95. In this gap, a part of the bottom portion 122 side of the seal groove 141 in the axial direction of the valve seat member 109 becomes a passage portion 144 (third flow path). The passage portion 144 is continuously connected to the case chamber 142. Moreover, in this gap, a portion opposite to the bottom portion 122 of the seal groove 141 in the axial direction of the valve seat member 109 becomes a passage portion 145 (fourth flow path). The passage portion 145 is continuously connected to the lower chamber 23. The valve seat member 109 has the passage portion 144 and the passage portion 145 with the case member 95. The valve seat member 109 divides the case member 95 into the passage portion 144 and the passage portion 145.

An axial width of the seal groove 141, i.e., a distance between wall surfaces of a pair of sidewall portions 141b at both axial ends of the seal groove 141, is longer than an axial length of the O-ring 108 in a state in which the groove bottom surface of the bottom portion 141a of the seal groove 141 arranged in the seal groove 141 is in contact with the inner circumferential surface of the tubular portion 123. Therefore, the O-ring 108 can be moved in the axial direction of the seal groove 141 within the seal groove 141. During this movement, the O-ring 108 slides between the groove bottom surface of the bottom portion 141a of the seal groove 141 and the inner circumferential surface of the tubular portion 123. The O-ring 108 divides the inside of the seal groove 141 into a pressure storage chamber 147 (third chamber) and a pressure storage chamber 148 (fourth chamber).

The pressure storage chamber 147 is provided on the bottom portion 122 side of the O-ring 108 of the seal groove 141 in the axial direction of the valve seat member 109. The pressure storage chamber 147 is continuously connected to the passage portion 144.

The pressure storage chamber 148 is provided on the opposite side of the bottom portion 122 of the O-ring 108 of the seal groove 141 in the axial direction of the valve seat member 109. The pressure storage chamber 148 is continuously connected to the passage portion 145. A connection between the pressure storage chamber 147 and the pressure storage chamber 148 is continuously blocked by the O-ring 108.

The passage portion 144 is connected to the pressure storage chamber 147 that is one of the pressure storage chamber 147 and the pressure storage chamber 148. The passage portion 145 is connected to the pressure storage chamber 148 that is the other of the pressure storage chamber 147 and the pressure storage chamber 148. The case member 95 and the valve seat member 109 have the passage portion 144 that connects the case chamber 142 to the pressure storage chamber 147. The case member 95 and the valve seat member 109 have the passage portion 145 that connects the lower chamber 23 to the pressure storage chamber 148.

An inner circumferential portion of the tubular portion 123 of the case member 95 and an outer circumferential portion including the seal groove 141 of the main body portion 140 of the valve seat member 109 constitute the outer shell portion 150. In other words, the outer shell portion 150 is formed by an outer circumferential portion opposite to the piston rod 25 in the radial direction of the valve seat member 109 and an inner circumferential portion of the tubular portion 123 of the case member 95. The outer shell portion 150 constitutes the outer shell of the pressure storage chamber 147 and the pressure storage chamber 148. The outer shell portion 150 accommodates the O-ring 108. The O-ring 108 divides the inside of the outer shell portion 150 into the pressure storage chamber 147 and the pressure storage chamber 148.

As shown in FIG. 2, the valve seat member 109 of the annular shape and the case member 95 of the bottomed tubular shape are arranged in the lower chamber 23 that is one of the upper chamber 22 and the lower chamber 23. At this time, in the valve seat member 109, the valve seat portion 139 is arranged on the lower chamber 23 side.

As shown in FIG. 3, the pressure storage chamber 147 is continuously connected to the upper chamber 22 shown in FIG. 2 via the passage portion 144, the case chamber 142, the radial passage 222 in the passage groove 221 of the valve seat member 109, a passage in the second hole 133 of the valve seat member 109, the piston rod passage portion 51 of the piston rod 25, a passage in the large diameter hole 46 of the piston 21, a passage in the notch 90 of the disc 82, and a passage in the annular groove 55 of the piston 21 and the plurality of passage holes 38.

The volumes of the pressure storage chamber 147 and the pressure storage chamber 148 change when the O-ring 108 shown in FIG. 3 is moved in the axial direction or deformed in the axial direction in the seal groove 141. That is, the O-ring 108, the pressure storage chamber 147, the pressure storage chamber 148, and the outer shell portion 150 constitute the pressure storage portion 151 provided so that the volume can be changed. The volume of the pressure storage chamber 147 is increased to allow the inflow of oil liquid L from the upper chamber 22. At this time, the volume of the pressure storage chamber 148 decreases and the oil liquid L is discharged to the lower chamber 23 side. The volume of the pressure storage chamber 148 is increased to allow the inflow of oil liquid L from the lower chamber 23. At this time, the volume of the pressure storage chamber 147 decreases and the oil liquid L is discharged to the upper chamber 22 side. Thereby, the pressure storage portion 151 suppresses the blockage of the sliding and deformation of the O-ring 108 due to the oil liquid L of the pressure storage chamber 147 and the pressure storage chamber 148.

A plurality of passage grooves 225 of the valve seat member 109 are provided facing the lower chamber 23. The plurality of passage portions 162 are continuously connected to the lower chamber 23 via a passage in the plurality of passage grooves 225.

The sub-valve 107 is disc-shaped and has an outer diameter equivalent to the outer diameter of the tip surface of the valve seat portion 135 of the valve seat member 109. The sub-valve 107 is in contact with the inner seat portion 134 continuously and can be detachably seated in the valve seat portion 135. The sub-valve 107 is seated in the entire valve seat portion 135 and closes all passage portions 162. Moreover, the sub-valve 107 is seated in the entire valve seat component 201 of any one of the valve seat portions 135, and therefore closes the passage portion 162 inside of the valve seat component 201. The spring member 105 biases the sub-valve 107 so that it is in contact with the valve seat portion 135 of the valve seat member 109. The sub-valve 107 is seated in the valve seat portion 135 by a biasing force of the spring member 105 and closes the passage portion 162.

The sub-valve 107 capable of being detachably seated in the valve seat portion 135 is provided in the case chamber 142. The sub-valve 107 is seated away from the valve seat portion 135 in the case chamber 142. Then, the sub-valve 107 connects the plurality of passage portions 162 and the case chamber 142. As a result, the lower chamber 23 is connected to the upper chamber 22. At this time, the sub-valve 107 generates a damping force by suppressing the flow of the oil liquid L between the sub-valve 107 and the valve seat portion 135. The sub-valve 107 is an inflow valve that is opened when the oil liquid L flows from the lower chamber 23 to the upper chamber 22 side via the plurality of passage portions 162. The sub-valve 107 is a check valve that regulates the outflow of the oil liquid L from the upper chamber 22 to the lower chamber 23 via the passage portion 162. Here, the passage hole 216 constituting the passage portion 161 is opened outside of the range of the valve seat portion 135 in the valve seat member 109. For this reason, the passage hole 216 is continuously connected to the upper chamber 22 irrespective of the sub-valve 107 seated in the valve seat portion 135.

A passage in the plurality of passage grooves 225 of the valve seat member 109, the plurality of passage portions 162, a passage between the sub-valve 107 and the valve seat portion 135 appearing at the time of valve opening, the case chamber 142, the radial passage 222 of the valve seat member 109, a passage in the second hole 133 of the valve seat member 109, the piston rod passage portion 51 of the piston rod 25, a passage in the large diameter hole 46 of the piston 21, a passage in the notch 90 of the disc 82, a passage in the annular groove 55 of the piston 21 and the plurality of passage holes 38 constitute the second passage 172. In the second passage 172, the oil liquid L flows out from the lower chamber 23 on the upstream side in the cylinder 5 to the upper chamber 22 on the downstream side by moving the piston 21 to the lower chamber 23 side. In the second passage 172, the oil liquid L flows out from the lower chamber 23 on the upstream side to the upper chamber 22 on the downstream side in the movement of the piston 21 to the lower chamber 23 side, i.e., the compression stroke. The second passage 172 is a passage on the compression side. Likewise, the second passage 172 on the compression side is provided separately from the first passage 72 shown in FIG. 2 on the compression side. The second passage 172 is provided parallel to the first passage 72 in its entirety.

The bottom portion 122 of the case member 95 is thicker and more rigid than the sub-valve 107. The bottom portion 122 of the case member 95 is in contact with the sub-valve 107 when the sub-valve 107 is deformed and any further deformation of the sub-valve 107 is suppressed.

The sub-valve 107, the valve seat member 109 including the valve seat portion 135, the disc 106, and the spring member 105 constitute the second damping force generation mechanism 173. The second damping force generation mechanism 173 is provided in the piston rod 25. The second damping force generation mechanism 173 is provided in the second passage 172 on the compression side. The second damping force generation mechanism 173 opens and closes the second passage 172 and suppresses the flow of the oil liquid L from the lower chamber 23 to the upper chamber 22 via the second passage 172 to generate a damping force. The second damping force generation mechanism 173 is a second damping force generation mechanism on the compression side. The passage portion 145 is provided parallel to the second damping force generation mechanism 173 on the compression side.

In the second damping force generation mechanism 173, the valve seat portion 135 is provided in the valve seat member 109. The second damping force generation mechanism 173 is arranged separately from the first damping force generation mechanism 42 that generates a damping force in the same compression stroke. The sub-valve 107 constituting the second damping force generation mechanism 173 on the compression side is a sub-valve on the compression side.

As shown in FIG. 3, in the second passage 172, the passage in the notch 90 of the disc 82 becomes an orifice 175. The orifice 175 is arranged on the downstream side of the sub-valve 107 of the flow of the oil liquid L when the sub-valve 107 is opened and the oil liquid L flows in the second passage 172. Also, the orifice 175 may be arranged on the upstream side of the sub-valve 107 of the flow of the oil liquid L when the sub-valve 107 is opened and the oil liquid L flows in the second passage 172. The orifice 175 is formed by notching the disc 82 in contact with the piston 21 within the first damping force generation mechanism 41.

In the second damping force generation mechanism 173 on the compression side, a fixed orifice is not formed on either the valve seat portion 135 or the sub-valve 107 in contact therewith. The fixed orifice connects the upper chamber 22 and the lower chamber 23 shown in FIG. 2 even if the valve seat portion 135 and the sub-valve 107 are in contact with each other. That is, the second damping force generation mechanism 173 on the compression side is not connected to the upper chamber 22 and the lower chamber 23 when the valve seat portion 135 and the sub-valve 107 are in contact with each other. In other words, a fixed orifice, which continuously connects the upper chamber 22 and the lower chamber 23, is not formed in the second passage 172. The second passage 172 is not a passage that continuously connects the upper chamber 22 and the lower chamber 23.

The compression-side second passage 172 capable of connecting the upper chamber 22 and the lower chamber 23 is in its entirety parallel to the first passage 72, which is a compression-side passage that can also connect the upper chamber 22 and the lower chamber 23. The first damping force generation mechanism 42 is provided in the first passage 72. The second damping force generation mechanism 173 is provided in the second passage 172. Therefore, the first damping force generation mechanism 42 and the second damping force generation mechanism 173 on the compression side are arranged in parallel.

As shown in FIG. 3, the sub-valve 110 is disc-shaped and has an outer diameter equivalent to the outer diameter of the tip surface of the valve seat portion 139 of the valve seat member 109. The sub-valve 110 is in contact with the inner seat portion 138 continuously and can be detachably seated in the valve seat portion 139. The sub-valve 110 is seated across the entire valve seat portion 139. Then, the sub-valve 110 closes all passage portions 161. Moreover, the sub-valve 110 is seated in any entire valve seat component 211 within the valve seat portions 139. Then, the sub-valve 110 closes the passage portion 161 inside of the valve seat component 211. The sub-valve 110 can be a common part having the same shape as the sub-valve 107.

The disc 111 is a common part having the same shape as the disc 106. The outer diameter of the disc 111 is smaller than the outer diameter of the sub-valve 110 and smaller than the outer diameter of the inner seat portion 138.

The spring member 112 includes a substrate portion 177 and a plurality of spring plate portions 178. The substrate portion 177 has a perforated circular flat plate shape with a uniform width across the entire circumference in the radial direction. The substrate portion 177 causes the fitting shaft portion 32 to be fitted to the inner circumferential portion thereof. Thereby, the substrate portion 177 is positioned in the radial direction with respect to the piston rod 25 and arranged in a coaxial shape. The plurality of spring plate portions 178 extend from positions at equal intervals in the circumferential direction of the substrate portion 177 to a position radially outward from the substrate portion 177. The spring plate portion 178 is inclined with respect to the substrate portion 177 to move away from the substrate portion 177 in the axial direction of the substrate portion 177 as a distance to an extension tip side decreases. The spring member 112 is in contact with the disc 111 in the substrate portion 177. The spring member 112 is attached to the mounting shaft portion 28 so that the spring plate portion 128 extends from the substrate portion 177 to the sub-valve 110 side in the axial direction of the substrate portion 177. In the spring member 112, a plurality of spring plate portions 178 are in contact with the sub-valve 110. The spring member 112 biases the sub-valve 110 so that it is in contact with the valve seat portion 139 of the valve seat member 109. The sub-valve 110 is seated in the valve seat portion 139 and closes the passage portion 161 according to a biasing force of the spring member 112.

The sub-valve 110 is provided in the lower chamber 23. The sub-valve 110 is seated separately from the valve seat portion 139, and therefore connects the upper chamber 22 and the pressure storage chamber 147 and the lower chamber 23. At this time, the sub-valve 110 generates a damping force by suppressing the flow of the oil liquid L between the sub-valve 110 and the valve seat portion 139. The sub-valve 110 is a discharge valve that is opened when the oil liquid L is discharged from the inside of the upper chamber 22 and the pressure storage chamber 147 to the lower chamber 23 via the plurality of passage portions 161 of the valve seat member 109. The sub-valve 110 is a check valve that regulates the inflow of the oil liquid L from the lower chamber 23 to the inside of the upper chamber 22 and the pressure storage chamber 147 via the passage portion 161. Here, the passage hole 206 constituting the passage portion 162 is opened outside of the range of the valve seat portion 139 in the valve seat member 109. For this reason, the passage hole 206 is continuously connected to the lower chamber 23 irrespective of the sub-valve 110 seated in the valve seat portion 139.

A passage in the plurality of passage holes 38 of the piston 21 and the annular groove 55, the orifice 175 in the notch 90 of the disc 82, a passage in the large diameter hole 46 of the piston 21, the piston rod passage portion 51 of the piston rod 25, a passage in the second hole 133 of the valve seat member 109, the radial passage 222 of the valve seat member 109, the case chamber 142, the plurality of passage portions 161 of the valve seat member 109, and a passage between the sub-valve 110 and the valve seat portion 139 appearing at the time of valve opening constitutes the second passage 182 (second flow path). The second passage 182 connects the upper chamber 22 and the lower chamber 23. In other words, the valve seat member 109 has the second passage 182 that connects the upper chamber 22 and the lower chamber 23. The valve seat member 109 defines the second passage 182. In the second passage 182, the oil liquid L flows out from the upper chamber 22 on the upstream side in the cylinder 5 to the lower chamber 23 on the downstream side due to the movement of the piston 21 to the upper chamber 22 side. The second passage 182 is an extension-side passage where the oil liquid L flows out from the upper chamber 22 on the upstream side to the lower chamber 23 on the downstream side in the movement of the piston 21 to the upper chamber 22 side, i.e., the extension stroke.

As shown in FIG. 2, the extension-side second passage 182 capable of connecting the upper chamber 22 and the lower chamber 23 is parallel to the first passage 92, which is an extension-side passage capable of similarly connecting the upper chamber 22 and the lower chamber 23, except for the passage in the annular groove 55 of the upper chamber 22 side and the plurality of passage holes 38. The second passage 182 may be parallel to the first passage 92 in its entirety. That is, it is only necessary for the second passage 182 to be at least partially parallel to the first passage 92. The passage portion 144 branches from the second passage 182 and connects to the pressure storage portion 151.

The outer diameter of the disc 113 is equivalent to the outer diameter of the sub-valve 110. The disc 113 is thicker and more rigid than the sub-valve 110. The disc 113 is in contact with the sub-valve 110 when the sub-valve 110 is deformed and suppresses any further deformation of the sub-valve 110. The annular member 114 has an outer diameter smaller than the outer diameter of the disc 113. The annular member 114 is a common part having the same shape as the annular member 69.

The sub-valve 110, the valve seat member 109 including the valve seat portion 139, the discs 111 and 113, and the spring member 112 constitute the second damping force generation mechanism 183. The second damping force generation mechanism 183 is provided in the second passage 182 on the extension side and opens and closes the second passage 182. The second damping force generation mechanism 183 suppresses the flow of the oil liquid L from the second passage 182 to the lower chamber 23 and generates a damping force. The second damping force generation mechanism 183 is a second damping force generation mechanism on the extension side. The second damping force generation mechanism 183 is provided in the piston rod 25 and the valve seat portion 139 is provided in the valve seat member 109. The second damping force generation mechanism 183 is arranged separately from the first damping force generation mechanism 41 that generates a damping force in the same extension stroke. The sub-valve 110 constituting the second damping force generation mechanism 183 on the extension side is a sub-valve on the extension side. The passage portion 144 is provided parallel to the second damping force generation mechanism 183 on the extension side.

The valve seat member 109 includes the second passage 182, the passage portions 144 and 145, and the pressure storage chambers 147 and 148.

As shown in FIG. 3, the O-ring 108 and the pressure storage chamber 148 constitute a lower-chamber-side volume variable mechanism 185 that changes the volume on the lower chamber 23 side by changing the volume of the pressure storage chamber 148. The lower-chamber-side volume variable mechanism 185 is connected to the passage portion 145 on the compression side.

The lower-chamber-side volume variable mechanism 185 makes a change to increase the volume of the pressure storage chamber 148 when the O-ring 108 is moved in proximity to the bottom portion 122 in the axial direction of the valve seat member 109 or crushed in contact with the wall surface of the sidewall portion 141b on the bottom portion 122 side in the axial direction of the seal groove 141. At this time, the O-ring 108 maintains a state in which the pressure storage chamber 148 and the pressure storage chamber 147 are blocked.

Moreover, the lower-chamber-side volume variable mechanism 185 makes a change to decrease the volume of the pressure storage chamber 148 when the O-ring 108 is moved away from the bottom portion 122 in the axial direction of the valve seat member 109 or crushed in contact with the wall surface of the sidewall portion 141b on the opposite side of the bottom portion 122 in the axial direction of the seal groove 141. At this time, the O-ring 108 also maintains a state in which the pressure storage chamber 148 and the pressure storage chamber 147 are blocked.

The O-ring 108 and the pressure storage chamber 147 constitute the upper-chamber-side volume variable mechanism 186. The upper-chamber-side volume variable mechanism 186 changes the volume on the upper chamber 22 side by changing the volume of the pressure storage chamber 147. The upper-chamber-side volume variable mechanism 186 is connected to the passage portion 144 on the extension side.

The upper-chamber-side volume variable mechanism 186 makes a change to increase the volume of the pressure storage chamber 147 when the O-ring 108 is moved away from the bottom portion 122 in the axial direction of the valve seat member 109 or crushed in contact with the wall surface of the sidewall portion 141b on the opposite side of the bottom portion 122 in the axial direction of the seal groove 141. At this time, the O-ring 108 maintains a state in which the pressure storage chamber 147 and the pressure storage chamber 148 are blocked.

Moreover, the upper-chamber-side volume variable mechanism 186 makes a change to decrease the volume of the pressure storage chamber 147 when the O-ring 108 is moved in proximity to the bottom portion 122 in the axial direction of the valve seat member 109 or crushed in contact with the wall surface of the sidewall portion 141b of the bottom portion 122 in the axial direction of the seal groove 141. At this time, the O-ring 108 maintains a state in which the pressure storage chamber 147 and the pressure storage chamber 148 are blocked.

The O-ring 108 is shared by the lower-chamber-side volume variable mechanism 185 and the upper-chamber-side volume variable mechanism 186. The lower-chamber-side volume variable mechanism 185 including the pressure storage chamber 148 and the upper-chamber-side volume variable mechanism 186 including the pressure storage chamber 147 are provided in the pressure storage portion 151 for storing an oil liquid as a working fluid.

In the second passage 182, the passage in the notch 90 of the disc 82 also becomes the orifice 175. The orifice 175 is common to the second passages 172 and 182. The orifice 175 is arranged on the upstream side of the sub-valve 110 of the flow of the oil liquid L when the sub-valve 110 is opened and the oil liquid L flows in the second passage 182. Also, the orifice 175 may be arranged on the downstream side of the sub-valve 110 of the flow of the oil liquid L when the sub-valve 110 is opened and the oil liquid L flows in the second passage 182. The sub-valve 110 and the sub-valve 107 described above are opened and closed independently.

In the second damping force generation mechanism 183 on the extension side, a fixed orifice is not formed in either the valve seat portion 139 or the sub-valve 110 in contact therewith. The fixed orifice connects the upper chamber 22 and the lower chamber 23 even if the valve seat portion 139 and the sub-valve 110 are in contact with each other. That is, the second damping force generation mechanism 183 on the extension side does not connect the upper chamber 22 and the lower chamber 23 if the valve seat portion 139 and the sub-valve 110 are in contact with each other. In other words, a fixed orifice that continuously connects the upper chamber 22 and the lower chamber 23 is not formed in the second passage 182. The second passage 182 is not a passage that continuously connects the upper chamber 22 and the lower chamber 23. The annular member 114 regulates deformation of the sub-valve 110 at a regulation level or more in the opening direction with the disc 113.

The shock absorber 2 can connect the upper chamber 22 and the lower chamber 23 only via the first damping force generation mechanisms 41 and 42 and the second damping force generation mechanisms 173 and 183 as a flow through which the oil liquid L is allowed to pass in the axial direction in the range of the piston 21. In the shock absorber 2, a fixed orifice that continuously connects the upper chamber 22 and the lower chamber 23 is not provided on the passage through which the oil liquid L is allowed to pass in the axial direction in the range of the piston 21.

As described above, the second passage 182 and the first passage 92 are parallel except for the passage in the annular groove 55 and the plurality of passage holes 38. In a parallel portion of the second passage 182 and the first passage 92, the first damping force generation mechanism 41 is provided in the first passage 92 and the second damping force generation mechanism 183 is provided in the second passage 182. Therefore, both the first damping force generation mechanism 41 and the second damping force generation mechanism 183 on the extension side are arranged in parallel.

The case member 95 has a bottomed tubular shape and is provided between the piston 21 and the valve seat member 109 in the second passages 172 and 182. The valve seat member 109 is provided in the case member 95. The sub-valve 110 is provided on the lower chamber 23 side of the valve seat member 109. The sub-valve 107 is provided in the case chamber 142 between the bottom portion 122 of the case member 95 and the valve seat member 109.

As shown in FIG. 2, the inner circumferential side of the main valve 71 is clamped to the disc 63 and the disc 67 in a state in which the main valve 71 is assembled to the piston rod 25. Together with this, the outer circumferential side of the main valve 71 is in contact with the valve seat portion 50 of the piston 21 across the entire circumference side. Moreover, in this state, the inner circumferential side of the main valve 91 is clamped to the disc 83 and the disc 89. Together with this, the outer circumferential side of the main valve 91 is in contact with the valve seat portion 48 of the piston 21 across the entire circumference side.

Moreover, in this state, the inner circumferential side of the sub-valve 107 is clamped to the inner seat portion 134 of the valve seat member 109 and the disc 106. Together with this, the sub-valve 107 is in contact with the valve seat portion 135 of the valve seat member 109 across the entire circumference. Moreover, in this state, the inner circumferential side of the sub-valve 110 is clamped to the inner seat portion 138 of the valve seat member 109 and the disc 111. Together with this, the sub-valve 110 is in contact with the valve seat portion 139 of the valve seat member 109 across the entire circumference.

As shown in FIG. 1, a liquid passage 251 and a liquid passage 252 that penetrate in the axial direction are formed in the valve body 12. The liquid passages 251 and 252 can connect the lower chamber 23 and the reservoir chamber 6. The base valve 15 has a damping force generation mechanism 255 on the bottom member 9 side of the valve body 12 in the axial direction. The damping force generation mechanism 255 can open and close the liquid passage 251. The damping force generation mechanism 255 is a damping force generation mechanism on the compression side. Moreover, the base valve 15 has a damping force generation mechanism 256 on the opposite side of the axial bottom member 9 of the valve body 12. The damping force generation mechanism 256 can open and close the liquid passage 252. The damping force generation mechanism 256 is a damping force generation mechanism on the extension side.

The piston rod 25 moves to the compression side and the piston 21 moves in a direction in which the lower chamber 23 is narrowed. Thereby, when the pressure of the lower chamber 23 becomes higher than the pressure of the reservoir chamber 6 by a predetermined value, the damping force generation mechanism 255 opens the liquid passage 251 of the base valve 15 and the oil liquid L of the lower chamber 23 flows into the reservoir chamber 6. The damping force generation mechanism 255 generates a damping force at this time. In other words, when the piston rod 25 moves to the compression side and moves the piston 21, the oil liquid L is outgoing to the reservoir chamber 6 in the liquid passage 251. The damping force generation mechanism 255 is a damping force generation mechanism on the compression side. The damping force generation mechanism 255 does not block the flow of the oil liquid L in the liquid passage 252.

The piston rod 25 moves to the extension side and the piston 21 moves in a direction in which the lower chamber 23 is expanded. Thereby, when the pressure of the lower chamber 23 becomes lower than the pressure of the reservoir chamber 6 by a predetermined value or more, the damping force generation mechanism 256 opens the liquid passage 252 of the base valve 15 and the oil liquid L of the reservoir chamber 6 flows into the lower chamber 23. At this time, the damping force generation mechanism 256 generates a damping force. In other words, when the piston rod 25 moves to the extension side and moves the piston 21, the oil liquid L is outgoing to the lower chamber 23 in the liquid passage 252. The damping force generation mechanism 256 is a damping force generation mechanism on the extension side. The damping force generation mechanism 256 does not block the flow of the oil liquid L in the liquid passage 251. The damping force generation mechanism 256 may also be used as a suction valve that allows the oil liquid L to flow from the reservoir chamber 6 to the lower chamber 23 without substantially generating the damping force.

### <Operation>

As shown in FIG. 3, the main valve 91 of the first damping force generation mechanism 41 between the first damping force generation mechanism 41 and the second damping force generation mechanism 183 on the extension side is more rigid than the sub-valve 110 of the second damping force generation mechanism 183 and has a higher opening pressure than the sub-valve 110. Therefore, in the extension stroke, in the extremely low-speed region where the piston speed is less than a predetermined value, the second damping force generation mechanism 183 opens the valve in a state in which the first damping force generation mechanism 41 closes the valve. In other words, the second damping force generation mechanism 183 opens the valve when the piston speed is lower than that of the first damping force generation mechanism 41 and generates a damping force. In the normal speed region where the piston speed is greater than or equal to this predetermined value, both the first damping force generation mechanism 41 and the second damping force generation mechanism 183 open the valves. The sub-valve 110 is an extremely low-speed valve that is opened in an area where the piston speed is extremely low and generates a damping force.

That is, in the extension stroke of the shock absorber 2, the piston 21 moves to the upper chamber 22 side, and therefore the pressure of the upper chamber 22 increases and the pressure of the lower chamber 23 decreases. Here, none of the first damping force generation mechanisms 41 and 42 and the second damping force generation mechanisms 173 and 183 has a fixed orifice that continuously connects the upper chamber 22 and the lower chamber 23. Therefore, the oil liquid L of the upper chamber 22 flows into the pressure storage chamber 147 via a passage in the plurality of passage holes 38 of the piston 21 and the annular groove 55, the orifice 175, a passage in the large diameter hole 46 of the piston 21, the piston rod passage portion 51 of the piston rod 25, a passage in the second hole 133 of the valve seat member 109, the radial passage 222 of the valve seat member 109, the case chamber 142, and the passage portion 144. In other words, the oil liquid L of the upper chamber 22 flows into the pressure storage chamber 147 via the second passage 182 and the passage portion 144 branching from the second passage 182. Thereby, the pressure of the pressure storage chamber 147 increases. Therefore, in the upper-chamber-side volume variable mechanism 186, the O-ring 108 is moved to the opposite side of the bottom portion 122 or crushed in contact with the wall surface of the sidewall portion 141b on the opposite side of the bottom portion 122 of the seal groove 141 before the second damping force generation mechanism 183 opens the valve. Then, the O-ring 108 increases the capacity of the pressure storage chamber 147. Thereby, the upper-chamber-side volume variable mechanism 186 suppresses the increase in the pressure of the pressure storage chamber 147. At this time, the lower-chamber-side volume variable mechanism 185 including the O-ring 108 decreases the volume of the pressure storage chamber 148.

Here, an amount of oil liquid L flowing from the upper chamber 22 to the pressure storage chamber 147 as described above is large in the extension stroke at the time of low-frequency input (at the time of large amplitude excitation) of the shock absorber 2. For this reason, the O-ring 108 is moved to a limit at the initial stage of the extension stroke and crushed to the limit. Then, thereafter, the O-ring 108 does not move or deform. Thereby, the capacity of the pressure storage chamber 147 does not increase. As a result, the pressure of the second passage 182 is increased before the second damping force generation mechanism 183 opens the valve.

At this time, none of the first damping force generation mechanisms 41 and 42 and the second damping force generation mechanisms 173 and 183 has a fixed orifice that continuously connects the upper chamber 22 and the lower chamber 23. For this reason, in the extension stroke in which the piston speed is less than a first predetermined value at which the second damping force generation mechanism 183 opens the valve, the damping force rises rapidly. Moreover, in an extremely low-speed region where the piston speed is less than a second predetermined value greater than the first predetermined value as a high-speed region from the first predetermined value, the first damping force generation mechanism 41 closes the valve and the second damping force generation mechanism 183 opens the valve.

That is, the sub-valve 110 is seated away from the valve seat portion 139 and connects the upper chamber 22 and the lower chamber 23 on the second passage 182 on the extension side. Therefore, the oil liquid L of the upper chamber 22 flows into the lower chamber 23 via a passage in the plurality of passage holes 38 of the piston 21 and the annular groove 55, the orifice 175, a passage in the large diameter hole 46 of the piston 21, the piston rod passage portion 51 of the piston rod 25, a passage in the second hole 133 of the valve seat member 109, the radial passage 222 of the valve seat member 109, the case chamber 142, the passage portion 161 in the valve seat member 109, and a passage between the sub-valve 110 and the valve seat portion 139. That is, the oil liquid L of the upper chamber 22 flows into the lower chamber 23 via the second passage 182. Thereby, even in an extremely low-speed region where the piston speed is less than the second predetermined value, a damping force of the valve characteristic (the characteristic in which the damping force is substantially proportional to the piston speed) is obtained.

Moreover, in the extension stroke at the time of low-frequency input of the shock absorber 2, in a normal speed region where the piston speed is greater than or equal to the second predetermined value, the first damping force generation mechanism 41 opens the valve while the second damping force generation mechanism 183 opens the valve. That is, as described above, the sub-valve 110 is seated away from the valve seat portion 139 and the flow of the oil liquid L is narrowed down by the orifice 175 provided on the downstream side of the main valve 91 in the second passage 182 while the oil liquid L flows from the upper chamber 22 to the lower chamber 23 in the second passage 182 on the extension side. Thereby, a pressure applied to the main valve 91 increases, a differential pressure increases, the main valve 91 is seated away from the valve seat portion 48, and the oil liquid L flows from the upper chamber 22 to the lower chamber 23 in the first passage 92 on the extension side. Therefore, the oil liquid L of the upper chamber 22 flows into the lower chamber 23 via the passage in the plurality of passage holes 38 and the annular groove 55 and the passage between the main valve 91 and the valve seat portion 48. That is, the oil liquid L of the upper chamber 22 flows into the lower chamber 23 via the first passage 92.

Thereby, even in the normal speed region where the piston speed is greater than or equal to the second predetermined value, a damping force of the valve characteristic (the damping force is substantially proportional to the piston speed) can be obtained. An increase rate in the damping force on the extension side for the increase in the piston speed in the normal speed region is lower than an increase rate in the damping force on the extension side for the increase in the piston speed in the extremely low-speed region. In other words, a slope of the increase rate in the damping force on the extension side for the increase in the piston speed in the normal speed region can be less than in the extremely low-speed region.

In the extension stroke at the time of high-frequency input (at the time of small amplitude excitation) in which a frequency higher than the low-frequency input described above is input to the shock absorber 2, an amount of oil liquid L flowing from the upper chamber 22 to the pressure storage chamber 147 is small. For this reason, the sliding and deformation of the O-ring 108 are small. As a result, the upper-chamber-side volume variable mechanism 186 can absorb a volume of the inflow of the oil liquid L into the pressure storage chamber 147 by sliding and deforming the O-ring 108. Therefore, the pressure boost of the pressure storage chamber 147 decreases. For this reason, when the extremely low-speed damping force rises, the state is similar to a state when there is no O-ring 108. In other words, when the extremely low-speed damping force rises, a state in which the pressure storage chamber 147 is continuously connected to the lower chamber 23, i.e., a state similar to that of a structure in which there is no second damping force generation mechanism 183, is possible.

Therefore, in the extension stroke at the time of high-frequency input, the rise of the extremely low-speed damping force is gradual at the time of low-frequency input or with respect to the conventional damping force characteristic.

Here, in the above extension stroke, the characteristics are also combined with the damping force characteristics of the damping force generation mechanism 256.

The main valve 71 of the first damping force generation mechanism 42 between the first damping force generation mechanism 42 and the second damping force generation mechanism 173 on the compression side is more rigid than the sub-valve 107 of the second damping force generation mechanism 173 and has a higher opening pressure than the sub-valve 107. Therefore, in the compression stroke, in the extremely low-speed region where the piston speed is less than a predetermined value, the second damping force generation mechanism 173 opens the valve in a state in which the first damping force generation mechanism 42 closes the valve. In other words, the second damping force generation mechanism 173 opens the valve when the piston speed is lower than that of the first damping force generation mechanism 42 and generates a damping force. In the normal speed region where the piston speed is greater than or equal to this predetermined value, both the first damping force generation mechanism 42 and the second damping force generation mechanism 173 open the valves. The sub-valve 107 is an extremely low-speed valve that is opened in an area where the piston speed is extremely low and generates a damping force.

That is, in the compression stroke of the shock absorber 2, the piston 21 moves to the lower chamber 23 side, and therefore the pressure of the lower chamber 23 increases and the pressure of the upper chamber 22 decreases. Here, none of the first damping force generation mechanisms 41 and 42 and the second damping force generation mechanisms 173 and 183 has a fixed orifice that continuously connects the lower chamber 23 and the upper chamber 22. Therefore, the oil liquid L of the lower chamber 23 flows into the pressure storage chamber 148 via a passage portion between the case member 95 and the valve seat member 109. Thereby, the pressure of the pressure storage chamber 147 is increased. For this reason, in the lower-chamber-side volume variable mechanism 185, the O-ring 108 is moved to the bottom portion 122 side or crushed in contact with the wall surface of the sidewall portion 141b on the bottom portion 122 side of the seal groove 141 before the second damping force generation mechanism 173 opens the valve. Then, the O-ring 108 increases the capacity of the pressure storage chamber 148. Thereby, the lower-chamber-side volume variable mechanism 185 suppresses the increase in the pressure of the pressure storage chamber 148. At this time, the upper-chamber-side volume variable mechanism 186 including the O-ring 108 decreases the volume of the pressure storage chamber 147.

Here, an amount of oil liquid L flowing from the lower chamber 23 to the pressure storage chamber 148 as described above is large in the compression stroke at the time of low-frequency input (at the time of large amplitude excitation) of the shock absorber 2. For this reason, the O-ring 108 is moved to a limit at the initial stage of the compression stroke and crushed to the limit. Then, thereafter, the O-ring 108 does not move or deform. Thereby, the capacity of the pressure storage chamber 148 does not increase. As a result, the pressure of the second passage 172 is increased before the second damping force generation mechanism 173 opens the valve.

At this time, none of the first damping force generation mechanisms 41 and 42 and the second damping force generation mechanisms 173 and 183 has a fixed orifice that continuously connects the lower chamber 23 and the upper chamber 22. For this reason, in the compression stroke in which the piston speed is less than a third predetermined value at which the second damping force generation mechanism 173 opens the valve, the damping force rises rapidly. Moreover, in an extremely low-speed region where the piston speed is less than a fourth predetermined value greater than the third predetermined value as a high-speed region from the third predetermined value, the second damping force generation mechanism 173 opens the valve in a state in which the first damping force generation mechanism 42 closes the valve.

That is, the sub-valve 107 is seated away from the valve seat portion 135 and connects the lower chamber 23 and the upper chamber 22 in the second passage 172 on the compression side. Therefore, the oil liquid L of the lower chamber 23 flows into the upper chamber 22 via the passage portion 162 in the valve seat member 109, a passage between the sub-valve 107 and the valve seat portion 135, the case chamber 142, the radial passage 222 of the valve seat member 109, a passage in the second hole 133 of the valve seat member 109, the piston rod passage portion 51 of the piston rod 25, a passage in the large diameter hole 46 of the piston 21, the orifice 175, and a passage in the annular groove 55 of the piston 21 and the plurality of passage holes 38. That is, the oil liquid L of the lower chamber 23 flows into the upper chamber 22 via the second passage 172. Thereby, even in an extremely low-speed region where the piston speed is less than the fourth predetermined value, a damping force of the valve characteristic (the characteristic in which the damping force is substantially proportional to the piston speed) is obtained.

Moreover, in the compression stroke at the time of low-frequency input of the shock absorber 2, in a normal speed region where the piston speed is greater than or equal to the fourth predetermined value, the first damping force generation mechanism 42 opens the valve while the second damping force generation mechanism 173 opens the valve. That is, as described above, the sub-valve 107 is seated away from the valve seat portion 135 and the flow of the oil liquid L is narrowed down by the orifice 175 provided on the downstream side of the sub-valve 107 in the second passage 172 while the oil liquid L flows from the lower chamber 23 to the upper chamber 22 in the second passage 172 on the compression side. Thereby, a pressure applied to the main valve 71 increases, a differential pressure increases, the main valve 71 is seated away from the valve seat portion 50, and the oil liquid L flows from the lower chamber 23 to the upper chamber 22 in the first passage 72 on the compression side. Therefore, the oil liquid L of the lower chamber 23 flows into the upper chamber 22 via the passage in the plurality of passage holes 39 and the annular groove 56 and the passage between the main valve 71 and the valve seat portion 50. That is, the oil liquid L of the lower chamber 23 flows into the upper chamber 22 via the first passage 72.

Thereby, even in the normal speed region where the piston speed is greater than or equal to the fourth predetermined value, a damping force of the valve characteristic (the damping force is substantially proportional to the piston speed) can be obtained. An increase rate in the damping force on the compression side for the increase in the piston speed in the normal speed region is lower than an increase rate in the damping force on the compression side for the increase in the piston speed in the extremely low-speed region. In other words, a slope of the increase rate in the damping force on the extension side for the increase in the piston speed in the normal speed region can be less than in the extremely low-speed region.

In the compression stroke at the time of high-frequency input (at the time of small amplitude excitation) in which a frequency higher than the low-frequency input described above is input to the shock absorber 2, an amount of oil liquid L flowing from the lower chamber 23 to the pressure storage chamber 148 is small. For this reason, the sliding and deformation of the O-ring 108 are small. As a result, the lower-chamber-side volume variable mechanism 185 can absorb a volume of the inflow of the oil liquid L into the pressure storage chamber 148 by sliding and deforming the O-ring 108. Therefore, the pressure boost of the pressure storage chamber 148 decreases. For this reason, when the extremely low-speed damping force rises, the state is similar to a state when there is no O-ring 108. In other words, when the extremely low-speed damping force rises, a state in which the pressure storage chamber 148 is continuously connected to the pressure storage chamber 147, i.e., a state similar to that of a structure in which there is no second damping force generation mechanism 173, is possible.

Therefore, in the compression stroke at the time of high-frequency input, the rise of the extremely low-speed damping force is gradual at the time of low-frequency input or with respect to the conventional damping force characteristic.

Here, in the compression stroke of the shock absorber 2, the characteristics are also combined with the damping force characteristics of the damping force generation mechanism 255.

Patent Document 1 described above describes a shock absorber having two valves that open in the same stroke. By adopting a structure having two valves that open in the same stroke in this way, one valve can be opened in a region where the piston speed is slower than the other valve and both valves can be opened even in a higher-speed region.

Meanwhile, it is necessary to suppress the occurrence of abnormal noise in the damping force generation device.

The damping force generation device 1 of the first embodiment includes the piston 21 configured to divide the inside of the cylinder 5 into the upper chamber 22 and the lower chamber 23 and have the first passage 92 that connects the upper chamber 22 and the lower chamber 23 and the valve seat member 109 having the second passage 182 provided at least partially parallel to the first passage 92 and connecting the upper chamber 22 and the lower chamber 23. The passage portion 144 branching from the second passage 182 in a direction from the upper chamber 22 to the second damping force generation mechanism 183 and connected to the pressure storage portion 151 is provided in the valve seat member 109. A damping coefficient during the stroke reversal is made dependent on the frequency with the pressure storage portion 151, such that the acceleration generated in the piston rod 25 during the stroke reversal can be significantly reduced and the occurrence of abnormal noise generated at the time of the stroke reversal can be suppressed.

Moreover, the damping force generation device 1 includes the O-ring 108 in which the pressure storage portion 151 is an elastic member and the outer shell portion 150 whose inside is divided into the pressure storage chamber 147 and the pressure storage chamber 148 by the O-ring 108. Also, the passage portion 144 is connected to the pressure storage chamber 147, which is one of the pressure storage chamber 147 and the pressure storage chamber 148.

Thereby, even if the damping force is set to be generated at the time of low-frequency input in the extremely low-speed region in the extension stroke, the volume of the pressure storage chamber 147 provided parallel to the second passage 182 can be easily and smoothly changed by the O-ring 108 at the time of high-frequency input. Therefore, it is possible to reduce the flow rate of the oil liquid L flowing through the second passage 182 at the time of high-frequency input as compared with the time of low-frequency input. Therefore, in the extension stroke, even if the damping force is set to be generated at the time of low-frequency input in the extremely low-speed region, it is possible to suppress the occurrence of abnormal noise in the extension stroke at the time of high-frequency input.

Moreover, the damping force generation device 1 can improve the property of being sealed between the pressure storage chamber 147 and the pressure storage chamber 148 by using the O-ring 108.

Moreover, in the damping force generation device 1, because the O-ring 108 constituting the pressure storage portion 151 seals the gap between the case member 95 and the valve seat member 109, only one O-ring is required. Therefore, the number of parts can be reduced.

Moreover, in the damping force generation device 1, the valve seat member 109 has the passage portion 145 configured to connect the lower chamber 23 to the pressure storage chamber 148, which is the other of the pressure storage chamber 147 and the pressure storage chamber 148.

Thereby, even if the damping force is set to be generated at the time of low-frequency input in the extremely low-speed region in the compression stroke, the O-ring 108 makes it possible to easily and smoothly change the volume of the pressure storage chamber 148 provided parallel to the second passage 172 at the time of high-frequency input. Therefore, it is possible to reduce the flow rate of the oil liquid L flowing through the second passage 172 at the time of high-frequency input as compared with the time of low-frequency input. Therefore, in the compression stroke, even if the damping force is set to be generated at the time of low-frequency input in the extremely low-speed region, it is possible to suppress the occurrence of abnormal noise in the compression stroke at the time of high-frequency input.

Moreover, because the damping force generation device 1 can discharge the oil liquid L from the pressure storage chamber 148 to the lower chamber 23 with the passage portion 145, the sliding and deformation of the O-ring 108 are facilitated when the oil liquid L is introduced into the pressure storage chamber 147 and the introduction of the oil liquid L into the pressure storage chamber 147 is further facilitated.

Moreover, because the damping force generation device 1 can discharge the oil liquid L from the pressure storage chamber 147 to the upper chamber 22 with the passage portion 144, the sliding and deformation of the O-ring 108 are facilitated when the oil liquid L is introduced into the pressure storage chamber 148 and the introduction of the oil liquid L into the pressure storage chamber 148 is further facilitated.

Moreover, when the stroke is reversed from the extension stroke to the compression stroke, the damping force generation device 1 can immediately introduce the oil liquid L of the lower chamber 23 into the pressure storage chamber 148 with the passage portion 145 and the O-ring 108 can be immediately returned to its original state.

### Second Embodiment

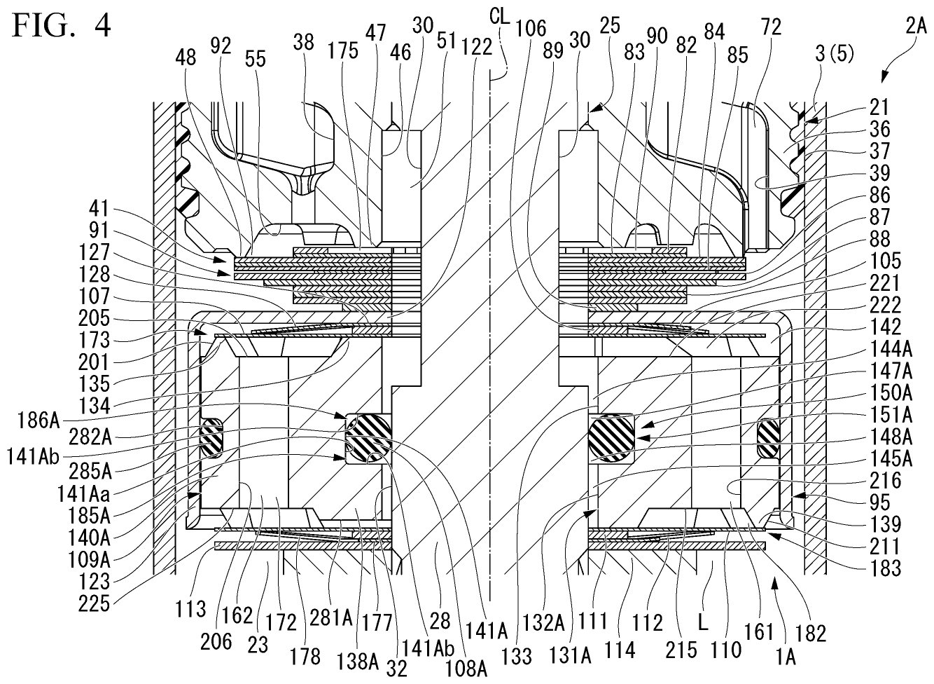

Next, a second embodiment will be described mainly on the basis of the differences from the first embodiment on the basis of FIG. 4. Also, parts identical to those of the first embodiment are represented by the same designation and the same reference numerals. Moreover, reference sign CL in FIG. 4 denotes a central axis of a damping force generation device 1A.

### <Configuration>

As shown in FIG. 4, a damping force generation device 1A of the second embodiment is partially different from the damping force generation device 1. A shock absorber 2A is different from the shock absorber 2 in that it has a damping force generation device 1A instead of the damping force generation device 1. The damping force generation device 1A has a valve seat member 109A partially different from the valve seat member 109 instead of the valve seat member 109.

In the valve seat member 109A, a through hole 131A is formed instead of the through hole 131. The through hole 131A is formed at the center of the valve seat member 109A in a radial direction. The through hole 131A extends in an axial direction of the valve seat member 109A and penetrates through the valve seat member 109A in the axial direction. A mounting shaft portion 28 of a piston rod 25 is inserted into the through hole 131A. The through hole 131A has a first hole 132A, a second hole 133 similar to the through hole 131, and a seal groove 141A.

The first hole 132A is arranged at an end of the opposite side of an inner seat portion 134 in the axial direction of the through hole 131A in the through hole 131A. An inner diameter of the first hole 132A is the same as an inner diameter of the second hole 133.

The seal groove 141A is arranged between the second hole 133 and the first hole 132A in the axial direction of the through hole 131A. The seal groove 141A is annular and concave further outward in the radial direction of the valve seat member 109A than the first hole 132A and the second hole 133. The seal groove 141A has a bottom portion 141Aa arranged on the radially outward side of the valve seat member 109A and a pair of sidewall portions 141Ab arranged on both sides in the axial direction of the valve seat member 109A. The bottom portion 141Aa has a cylindrical surface shape in which a groove bottom surface facing radially inward from the valve seat member 109A is in the axial direction of the valve seat member 109A. A pair of sidewall portions 141Ab have a planar shape in which wall surfaces facing each other in the axial direction of the valve seat member 109A are spread perpendicular to the axial direction of the valve seat member 109A. The through hole 131A has an inner diameter larger than an outer diameter of a fitting shaft portion 32 across the entire length.

The valve seat member 109A has an inner seat portion 138A partly different from the inner seat portion 138 instead of the inner seat portion 138. The inner seat portion 138A is different from the inner seat portion 138 in that a first hole 132A having a larger inner diameter than the first hole 132 is provided. Moreover, a passage groove 281A is formed in the inner seat portion 138A. The passage groove 281A is concave in the direction of the inner seat portion 134 from the tip surface opposite to the inner seat portion 134 of the inner seat portion 138A in the axial direction of the valve seat member 109A. The passage groove 281A crosses the inner seat portion 138A in the radial direction of the inner seat portion 138A. A passage in the passage groove 281A is connected to a passage in the passage groove 225.

The valve seat member 109A has a main body portion 140A partially different from the main body portion 140 instead of the main body portion 140. An outer diameter of the main body portion 140A is larger than an outer diameter of the main body portion 140. The main body portion 140A is fitted to the tubular portion 123 of the case member 95, and therefore positioned in the radial direction with respect to the case member 95. Apart of the first hole 132A, a part of the second hole 133, and all of the seal groove 141A are formed in the main body portion 140A.

The main body portion 140A has a seal groove 282A axially longer than the seal groove 141 instead of the seal groove 141. The damping force generation device 1A has an O-ring 285A instead of the O-ring 108. The O-ring 285A is arranged in the seal groove 282A. The O-ring 285A is also an annular part having elasticity such as rubber. In a state in which the O-ring 285A has an overall annular shape before being assembled to the valve seat member 109A, a cross-section becomes an ellipse when the cross-section is taken along a plane including the central axis of the annular ring.

The valve seat member 109A is fitted to the tubular portion 123 of the case member 95 in the outer circumferential portion of the main body portion 140A with the inner seat portion 138A and the valve seat portion 139 facing opposite to the bottom portion 122 of the case member 95.

In this state, the O-ring 285A is in contact with the inner circumferential surface of the tubular portion 123 of the case member 95 and the groove bottom surface at an innermost end of a concave direction of the seal groove 282A of the valve seat member 109A and a gap therebetween is continuously sealed. Moreover, in this state, the O-ring 285A is also in contact with the wall surfaces at both axial ends of the seal groove 282A.

The damping force generation device 1A has an O-ring 108A and the O-ring 108A is arranged in the seal groove 141A of the valve seat member 109A. The O-ring 108A is an annular part having elasticity such as rubber. In a state in which the O-ring 108A has an overall annular shape before being assembled to the valve seat member 109A, a cross-section becomes an ellipse when the cross-section is taken along a plane including the central axis of the annular ring. The O-ring 108A is in contact with the outer circumferential surface of the fitting shaft portion 32 of the piston rod 25 and the groove bottom surface of the bottom portion 141Aa of the innermost end of the concave direction of the seal groove 141A of the valve seat member 109A and a gap therebetween is continuously sealed.

Here, inner diameters of the first hole 132A and the second hole 133 of the through hole 131A of the valve seat member 109A are larger than an outer diameter of the fitting shaft portion 32 of the piston rod 25 by a predetermined value. The valve seat member 109A is fitted to the tubular portion 123 of the case member 95, and therefore positioned in the radial direction with respect to the case member 95. The case member 95 is fitted to the fitting shaft portion 32 of the piston rod 25, and therefore positioned in the radial direction with respect to the piston rod 25. Thereby, the valve seat member 109A is positioned in the radial direction with respect to the piston rod 25. In this state, a gap is formed across the entire circumference between the inner circumferential surface of the first hole 132A and the inner circumferential surface of the second hole 133 and the outer circumferential surface of the fitting shaft portion 32. In this gap, a portion on the bottom portion 122 side of the seal groove 141A in the axial direction of the valve seat member 109A, i.e., a portion in the second hole 133, becomes a passage portion 144A (third flow path). The passage portion 144A is continuously connected to the piston rod passage portion 51. Moreover, in this gap, a portion opposite to the bottom portion 122 of the seal groove 141A in the axial direction of the valve seat member 109A, i.e., a portion in the first hole 132A, is a passage portion 145A (fourth flow path). The passage portion 145A is continuously connected to the lower chamber 23 via a passage in the passage groove 281A and a passage in the passage groove 225. The valve seat member 109A has the passage portion 144A and the passage portion 145A with the piston rod 25. The valve seat member 109A defines the passage portion 144A and the passage portion 145A with the piston rod 25.

An axial width of the seal groove 141A, i.e., a distance between wall surfaces of a pair of sidewall portions 141Ab at both axial ends of the seal groove 141A, is longer than an axial length of the O-ring 108A in a state in which the groove bottom surface of the bottom portion 141Aa of the seal groove 141A arranged in the seal groove 141A is in contact with the outer circumferential surface of the fitting shaft portion 32. Therefore, the O-ring 108A can be moved in the axial direction of the seal groove 141A in the seal groove 141A. During this movement, the O-ring 108A slides between the groove bottom surface of the bottom portion 141Aa of the seal groove 141A and the outer circumferential surface of the fitting shaft portion 32. The O-ring 108A divides the inside of the seal groove 141A into a pressure storage chamber 147A (third chamber) and a pressure storage chamber 148A (fourth chamber).

The pressure storage chamber 147A is provided on the bottom portion 122 side of the O-ring 108A of the seal groove 141A in the axial direction of the valve seat member 109A. The pressure storage chamber 147A is continuously connected to the passage portion 144A.

The pressure storage chamber 148A is provided on the side opposite to the bottom portion 122 of the O-ring 108A of the seal groove 141A in the axial direction of the valve seat member 109A. The pressure storage chamber 148A is continuously connected to the passage portion 145A. A connection between the pressure storage chamber 147A and the pressure storage chamber 148A is continuously blocked by the O-ring 108A.

The passage portion 144A is connected to the pressure storage chamber 147A that is one of the pressure storage chamber 147A and the pressure storage chamber 148A. The passage portion 145A is connected to the pressure storage chamber 148A that is the other of the pressure storage chamber 147A and the pressure storage chamber 148A. The valve seat member 109A and the piston rod 25 have the passage portion 144A that connects the upper chamber 22 (see FIG. 2) to the pressure storage chamber 147A. The valve seat member 109A and the piston rod 25 have the passage portion 145A that connects the lower chamber 23 to the pressure storage chamber 148A.

The outer circumferential portion of the fitting shaft portion 32 of the piston rod 25 and the inner circumferential portion including the seal groove 141A of the main body portion 140A of the valve seat member 109A constitute an outer shell portion 150A. In other words, the outer shell portion 150A is formed by an inner circumferential portion on the piston rod 25 side in the radial direction of the valve seat member 109A and an outer circumferential portion of the fitting shaft portion 32 of the piston rod 25. In other words, the outer shell portion 150A is provided between the valve seat member 109A and the fitting shaft portion 32 of the piston rod 25 inserted into the valve seat member 109A. The outer shell portion 150A constitutes the outer shell of the pressure storage chamber 147A and the pressure storage chamber 148A. The outer shell portion 150A accommodates the O-ring 108A. The O-ring 108A divides the inside of the outer shell portion 150A into the pressure storage chamber 147A and the pressure storage chamber 148A.

The pressure storage chamber 147A is continuously connected to the upper chamber 22 (see FIG. 2) via the passage portion 144A and the second passage 182. In other words, the passage portion 144A branches from the second passage 182 and is connected to the pressure storage portion 151A.

The volumes of the pressure storage chamber 147A and the pressure storage chamber 148A change when the O-ring 108A is moved in the axial direction or deformed in the axial direction in the seal groove 141A. That is, the O-ring 108A, the pressure storage chamber 147A, the pressure storage chamber 148A, and the outer shell portion 150A constitute the pressure storage portion 151A provided so that the volume can be changed. The volume of the pressure storage chamber 147A is increased to allow the inflow of the oil liquid L from the upper chamber 22. At this time, the volume of the pressure storage chamber 148A decreases and the oil liquid L is discharged to the lower chamber 23 side. The volume of the pressure storage chamber 148A is increased to allow the inflow of the oil liquid L from the lower chamber 23. At this time, the volume of the pressure storage chamber 147A decreases and the oil liquid L is discharged to the upper chamber 22 side. The valve seat member 109A includes the second passage 182, the passage portions 144A and 145A, and the pressure storage chambers 147A and 148A.

The O-ring 108A and the pressure storage chamber 148A constitute a lower-chamber-side volume variable mechanism 185A that changes the volume on the lower chamber 23 side by changing the volume of the pressure storage chamber 148A. The lower-chamber-side volume variable mechanism 185A is connected to the passage portion 145A on the compression side.

The lower-chamber-side volume variable mechanism 185A makes a change to increase the volume of the pressure storage chamber 148A when the O-ring 108A is moved in proximity to the bottom portion 122 in the axial direction of the valve seat member 109A or crushed in contact with the wall surface of the sidewall portion 141Ab on the bottom portion 122 side in the axial direction of the seal groove 141A. At this time, the O-ring 108A maintains a state in which the pressure storage chamber 148A and the pressure storage chamber 147A are blocked.

Moreover, the lower-chamber-side volume variable mechanism 185A makes a change to decrease the volume of the pressure storage chamber 148A when the O-ring 108A is moved away from the bottom portion 122 in the axial direction of the valve seat member 109A or crushed in contact with the wall surface of the sidewall portion 141Ab on the opposite side of the bottom portion 122 in the axial direction of the seal groove 141A. At this time, the O-ring 108A also maintains a state in which the pressure storage chamber 148A and the pressure storage chamber 147A are blocked.

The O-ring 108A and the pressure storage chamber 147A constitute the upper-chamber-side volume variable mechanism 186A. The upper-chamber-side volume variable mechanism 186A changes the volume on the upper chamber 22 (see FIG. 2) side by changing the volume of the pressure storage chamber 147A. The upper-chamber-side volume variable mechanism 186A is connected to the passage portion 144A on the extension side.

The upper-chamber-side volume variable mechanism 186A makes a change to increase the volume of the pressure storage chamber 147A when the O-ring 108A is moved away from the bottom portion 122 in the axial direction of the valve seat member 109A or crushed in contact with the wall surface of the sidewall portion 141Ab on the opposite side of the bottom portion 122 in the axial direction of the seal groove 141A. At this time, the O-ring 108A maintains a state in which the pressure storage chamber 147A and the pressure storage chamber 148A are blocked.

Moreover, the upper-chamber-side volume variable mechanism 186A makes a change to decrease the volume of the pressure storage chamber 147A when the O-ring 108A is moved in proximity to the bottom portion 122 in the axial direction of the valve seat member 109A or crushed in contact with the wall surface of the sidewall portion 141Ab of the bottom portion 122 in the axial direction of the seal groove 141A. At this time, the O-ring 108A maintains a state in which the pressure storage chamber 147A and the pressure storage chamber 148A are blocked.

The O-ring 108A is shared by the lower-chamber-side volume variable mechanism 185A and the upper-chamber-side volume variable mechanism 186A. The lower-chamber-side volume variable mechanism 185A including the pressure storage chamber 148A and the upper-chamber-side volume variable mechanism 186A including the pressure storage chamber 147A are provided in the pressure storage portion 151A for storing an oil liquid as a working fluid.

### <Operation>

In the extension stroke of the shock absorber 2A, the piston 21 moves to the upper chamber 22 (see FIG. 2) side, and therefore the pressure of the upper chamber 22 (see FIG. 2) increases and the pressure of the lower chamber 23 decreases. Here, none of the first damping force generation mechanism 41, the first damping force generation mechanism 42 (see FIG. 2), and the second damping force generation mechanisms 173 and 183 has a fixed orifice that continuously connects the upper chamber 22 (see FIG. 2) and the lower chamber 23. Therefore, the oil liquid L of the upper chamber 22 (see FIG. 2) flows into the pressure storage chamber 147A via the second passage 182 and the passage portion 144A branching from the second passage 182. Thereby, the pressure of the pressure storage chamber 147A is increased. For this reason, in the upper-chamber-side volume variable mechanism 186A, the O-ring 108A is moved to the opposite side of the bottom portion 122 or crushed in contact with the wall surface of the sidewall portion 141Ab on the opposite side of the bottom portion 122 of the seal groove 141A before the second damping force generation mechanism 183 opens the valve. Then, the O-ring 108A increases the capacity of the pressure storage chamber 147A. Thereby, the upper-chamber-side volume variable mechanism 186A suppresses the increase in the pressure of the pressure storage chamber 147A. At this time, the lower-chamber-side volume variable mechanism 185A including the O-ring 108A decreases the volume of the pressure storage chamber 148A.

Here, an amount of oil liquid L flowing from the upper chamber 22 (see FIG. 2) to the pressure storage chamber 147A as described above is large in the extension stroke at the time of low-frequency input (at the time of large amplitude excitation) of the shock absorber 2A. For this reason, the O-ring 108A is moved to a limit at the initial stage of the extension stroke and crushed to the limit. Then, thereafter, the O-ring 108A does not move or deform. Thereby, the capacity of the pressure storage chamber 147A does not increase. As a result, the pressure of the second passage 182 is increased before the second damping force generation mechanism 183 opens the valve.

At this time, none of the first damping force generation mechanisms 41 and 42 (see FIG. 2) and the second damping force generation mechanisms 173 and 183 has a fixed orifice that continuously connects the upper chamber 22 (see FIG. 2) and the lower chamber 23. For this reason, in the extension stroke in which the piston speed is less than a first predetermined value at which the second damping force generation mechanism 183 opens the valve, the damping force rises rapidly. Moreover, in an extremely low-speed region where the piston speed is less than a second predetermined value greater than the first predetermined value as a high-speed region from the first predetermined value, the first damping force generation mechanism 41 closes the valve and the second damping force generation mechanism 183 opens the valve.

That is, the sub-valve 110 is seated away from the valve seat portion 139 and connects the upper chamber 22 (see FIG. 2) and the lower chamber 23 in the second passage 182 on the extension side. Therefore, the oil liquid L of the upper chamber 22 (see FIG. 2) flows into the lower chamber 23 via the second passage 182. Thereby, even in an extremely low-speed region where the piston speed is less than the second predetermined value, a damping force of the valve characteristic (the characteristic in which the damping force is substantially proportional to the piston speed) is obtained.

Moreover, in the extension stroke at the time of low-frequency input of the shock absorber 2A, in a normal speed region where the piston speed is greater than or equal to the second predetermined value, the first damping force generation mechanism 41 opens the valve while the second damping force generation mechanism 183 opens the valve. That is, as described above, the main valve 91 is seated away from the valve seat portion 48 and the oil liquid L flows from the upper chamber 22 (see FIG. 2) to the lower chamber 23 in the first passage 92 on the extension side while the sub-valve 110 is seated away from the valve seat portion 139 and the oil liquid L flows from the upper chamber 22 (see FIG. 2) to the lower chamber 23 in the second passage 182 on the extension side. Therefore, the oil liquid L of the upper chamber 22 (see FIG. 2) flows into the lower chamber 23 via the first passage 92.

Thereby, even in the normal speed region where the piston speed is greater than or equal to the second predetermined value, a damping force of the valve characteristic (the damping force is substantially proportional to the piston speed) can be obtained. An increase rate in the damping force on the extension side for the increase in the piston speed in the normal speed region is lower than an increase rate in the damping force on the extension side for the increase in the piston speed in the extremely low-speed region.

In the extension stroke at the time of high-frequency input (at the time of small amplitude excitation) in which a frequency higher than the low-frequency input described above is input to the shock absorber 2A, the amount of oil liquid L flowing from the upper chamber 22 (see FIG. 2) to the pressure storage chamber 147A is small. For this reason, the sliding and deformation of the O-ring 108A are small. As a result, the upper-chamber-side volume variable mechanism 186A can absorb the volume of the inflow of the oil liquid L into the pressure storage chamber 147A by sliding and deforming the O-ring 108A. Therefore, the pressure boost of the pressure storage chamber 147A decreases. For this reason, when the extremely low-speed damping force rises, the state is similar to a state when there is no O-ring 108A.

Therefore, in the extension stroke at the time of high-frequency input, the rise of the extremely low-speed damping force is gradual at the time of low-frequency input or with respect to the conventional damping force characteristic.

In the compression stroke of the shock absorber 2A, the piston 21 moves to the lower chamber 23 side, and therefore the pressure of the lower chamber 23 increases and the pressure of the upper chamber 22 (see FIG. 2) decreases. Here, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). Therefore, the oil liquid L of the lower chamber 23 flows into the pressure storage chamber 148A via a passage in the passage groove 225, a passage in the passage groove 281A, and the passage portion 145A. Thereby, the pressure of the pressure storage chamber 148A is increased. For this reason, in the lower-chamber-side volume variable mechanism 185A, the O-ring 108A is moved to the bottom portion 122 side or crushed in contact with the wall surface of the sidewall portion 141Ab on the bottom portion 122 side of the seal groove 141A before the second damping force generation mechanism 173 opens the valve. Then, the O-ring 108A increases the capacity of the pressure storage chamber 148A. Thereby, the lower-chamber-side volume variable mechanism 185A suppresses the increase in the pressure of the pressure storage chamber 148A. At this time, the upper-chamber-side volume variable mechanism 186A including the O-ring 108A decreases the volume of the pressure storage chamber 147A.

Here, an amount of oil liquid L flowing from the lower chamber 23 to the pressure storage chamber 148A as described above is large in the compression stroke at the time of low-frequency input (at the time of large amplitude excitation) of the shock absorber 2A. For this reason, the O-ring 108A is moved to a limit at the initial stage of the compression stroke and crushed to the limit. Then, thereafter, the O-ring 108A does not move or deform. Thereby, the capacity of the pressure storage chamber 148A does not increase. As a result, the pressure of the second passage 172 is increased before the second damping force generation mechanism 173 opens the valve.

At this time, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). For this reason, in the compression stroke in which the piston speed is less than a third predetermined value at which the second damping force generation mechanism 173 opens the valve, the damping force rises rapidly. Moreover, in an extremely low-speed region where the piston speed is less than a fourth predetermined value greater than the third predetermined value as a high-speed region from the third predetermined value, the second damping force generation mechanism 173 opens the valve in a state in which the first damping force generation mechanism 42 (see FIG. 2) closes the valve.

That is, the sub-valve 107 is seated away from the valve seat portion 135 and connects the lower chamber 23 and the upper chamber 22 (see FIG. 2) in the second passage 172 on the compression side. Therefore, the oil liquid L of the lower chamber 23 flows into the upper chamber 22 (see FIG. 2) via the second passage 172. Thereby, even in an extremely low-speed region where the piston speed is less than the fourth predetermined value, a damping force of the valve characteristic (the characteristic in which the damping force is substantially proportional to the piston speed) is obtained.

Moreover, in the compression stroke at the time of low-frequency input of the shock absorber 2A, in a normal speed region where the piston speed is greater than or equal to the fourth predetermined value, the first damping force generation mechanism 42 (see FIG. 2) opens the valve while the second damping force generation mechanism 173 opens the valve. That is, as described above, the main valve 71 (see FIG. 2) is seated away from the valve seat portion 50 (see FIG. 2) and the oil liquid L flows from the lower chamber 23 to the upper chamber 22 (see FIG. 2) in the first passage 72 on the compression side while the sub-valve 107 is seated away from the valve seat portion 135 and the oil liquid L flows from the lower chamber 23 to the upper chamber 22 (see FIG. 2) in the second passage 172 on the compression side. Therefore, the oil liquid L of the lower chamber 23 flows into the upper chamber 22 (see FIG. 2) via the first passage 72.

Thereby, even in the normal speed region where the piston speed is greater than or equal to the fourth predetermined value, a damping force of the valve characteristic (the damping force is substantially proportional to the piston speed) can be obtained. An increase rate in the damping force on the compression side for the increase in the piston speed in the normal speed region is lower than an increase rate in the damping force on the compression side for the increase in the piston speed in the extremely low-speed region.

In the compression stroke at the time of high-frequency input (at the time of small amplitude excitation) in which a frequency higher than the low-frequency input described above is input to the shock absorber 2A, the amount of oil liquid L flowing from the lower chamber 23 to the pressure storage chamber 148A is small. For this reason, the sliding and deformation of the O-ring 108A are small. As a result, the lower-chamber-side volume variable mechanism 185A can absorb the volume of the inflow of oil liquid L into the pressure storage chamber 148A by sliding and deforming the O-ring 108A. Therefore, the pressure boost of the pressure storage chamber 148A decreases. For this reason, when the extremely low-speed damping force rises, the state is similar to a state when there is no O-ring 108A.

Therefore, in the compression stroke at the time of high-frequency input, the rise of the extremely low-speed damping force is gradual at the time of low-frequency input or with respect to the conventional damping force characteristic.

The damping force generation device 1A of the second embodiment has the valve seat member 109A provided at least partially parallel to the first passage 92 and having the second passage 182 that connects the upper chamber 22 (see FIG. 2) and the lower chamber 23. Also, the passage portion 144A branching from the second passage 182 in a direction from the upper chamber 22 to the second damping force generation mechanism 183 and connected to the pressure storage portion 151A is provided in the valve seat member 109A. Because a function of the pressure storage portion 151A is similar to that of the pressure storage portion 151, the effect of the damping force generation device 1A is similar to that of the damping force generation device 1.

Moreover, in the damping force generation device 1A, because the outer shell portion 150A is provided between the valve seat member 109A and the fitting shaft portion 32 of the piston rod 25 inserted into the valve seat member 109A, a dedicated part for forming the outer shell portion 150A is not required and the number of parts can be reduced.

### Third Embodiment

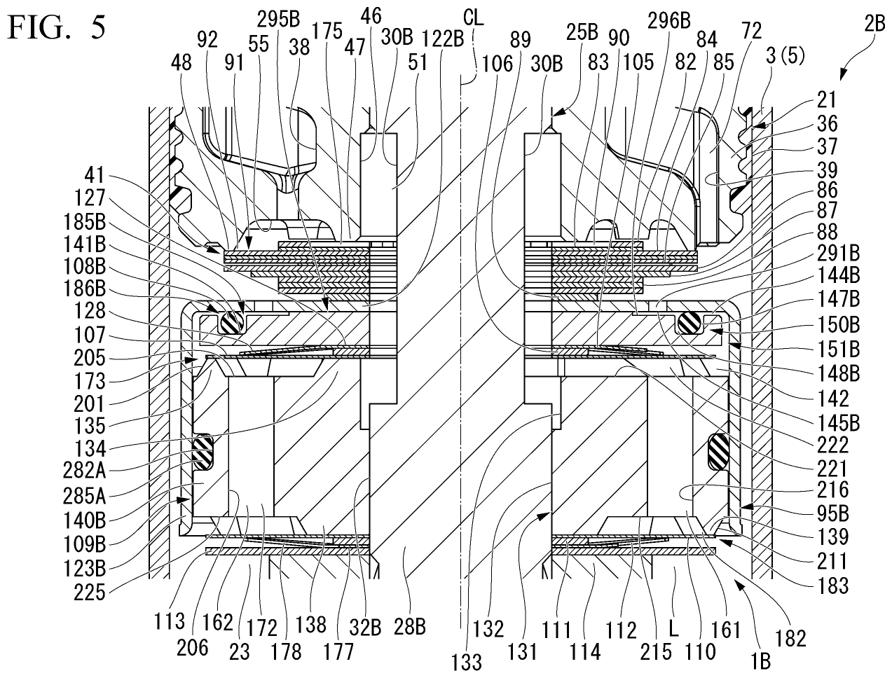

Next, a third embodiment will be described mainly on the basis of the differences from the first and second embodiments on the basis of FIG. 5. Also, parts identical to those of the first and second embodiments are represented by the same designation and the same reference numerals. Moreover, reference sign CL in FIG. 5 denotes a central axis of a damping force generation device 1B.

### <Configuration>

As shown in FIG. 5, the damping force generation device 1B of the third embodiment is partially different from the damping force generation device 1. A shock absorber 2B is different from the shock absorber 2 in that it has the damping force generation device 1B instead of the damping force generation device 1. The damping force generation device 1B has a piston rod 25B partially different from the piston rod 25 instead of the piston rod 25. The piston rod 25B has a mounting shaft portion 28B with a longer axial length than the mounting shaft portion 28 instead of the mounting shaft portion 28. The mounting shaft portion 28B has a fitting shaft portion 32B with a longer axial length than the fitting shaft portion 32 instead of the fitting shaft portion 32. The fitting shaft portion 32B has a passage notch 30B with a longer axial length of the fitting shaft portion 32B than the passage notch 30 instead of the passage notch 30.

Moreover, the damping force generation device 1B has a case member 95B partially different from the case member 95 instead of the case member 95. The case member 95B has a tubular portion 123B with a longer axial length than the tubular portion 123 instead of the tubular portion 123. The case member 95B has a bottom portion 122B partially different from the bottom portion 122 instead of the bottom portion 122. The bottom portion 122B is different from the bottom portion 122 in that a passage hole 291B penetrating in the axial direction of the bottom portion 122B is formed. A plurality of passage holes 291B are provided at equal intervals in a circumferential direction of the bottom portion 122B in the bottom portion 122B. The passage hole 291B is arranged outside of an outer end of a disc 89 in the radial direction of the bottom portion 122B.

Moreover, the damping force generation device 1B has a valve seat member 109B partially different from the valve seat member 109 instead of the valve seat member 109. The valve seat member 109B has a main body portion 140B partially different from the main body portion 140 instead of the main body portion 140. An outer diameter of the main body portion 140B is larger than an outer diameter of the main body portion 140. The main body portion 140B has a seal groove 282A as in the second embodiment. The damping force generation device 1B has an O-ring 285A as in the second embodiment. The valve seat member 109B is fitted to the tubular portion 123B of the case member 95B in the outer circumferential portion of the main body portion 140B with the inner seat portion 138 and the valve seat portion 139 facing opposite to the bottom portion 122B of the case member 95B. In this state, the O-ring 285A is in contact with the inner circumferential surface of the tubular portion 123B of the case member 95B, the groove bottom surface of the seal groove 282A of the valve seat member 109B, and wall surfaces of both axial ends of the seal groove 282A.

Moreover, in the damping force generation device 1B, a chamber forming member 295B (second regulation member) is provided between the bottom portion 122B of the case member 95B and the spring member 105 in the axial direction of the piston rod 25B.

The chamber forming member 295B is made of a metal and has a perforated circular flat plate shape with a uniform radial width across the entire circumference. The chamber forming member 295B has an outer diameter smaller than the inner diameter of the tubular portion 123B of the case member 95B. The chamber forming member 295B is positioned in the radial direction with respect to the piston rod 25B by fitting the fitting shaft portion 32B inside. The chamber forming member 295B is clamped to the bottom portion 122B of the case member 95B and the substrate portion 127 of the spring member 105 in the axial direction of the piston rod 25B.

The chamber forming member 295B has a step portion 296B on the outer circumference side. The step portion 296B is annular and concave in the axial direction of the chamber forming member 295B from an end surface of the one side of the chamber forming member 295B in the axial direction. The step portion 296B extends to an outer end surface of the chamber forming member 295B in the radial direction. The chamber forming member 295B has an axial thickness thinner in a portion in which the step portion 296B is formed than in an inner portion of the step portion 296B in the radial direction. In the radial direction of the chamber forming member 295B, a position of the step portion 296B overlaps a position of the passage hole 291B of the case member 95B.

In the chamber forming member 295B, a seal groove 141B is formed in the range of the step portion 296B in its radial direction. The seal groove 141B is annular and concave in the axial direction of the chamber forming member 295B from an end surface of one side of the step portion 296B in the axial direction. In the radial direction of the chamber forming member 295B, the seal groove 141B is arranged outside of the passage hole 291B of the case member 95B in its entirety.

The O-ring 108B is arranged in the seal groove 141B. The O-ring 108B is an annular part having elasticity such as rubber. In a state in which the O-ring 108B has an overall annular shape before being assembled to the chamber forming member 295B, a cross-section becomes a circle when the cross-section is taken along a plane including the central axis of the annular ring.

The chamber forming member 295B is fitted to the fitting shaft portion 32B with the step portion 296B facing the bottom portion 122 side of the case member 95B. Also, in the chamber forming member 295B, an inner end surface of the step portion 296B in its radial direction is in contact with the bottom portion 122B. In this state, the O-ring 108B provided in the seal groove 141B is in contact with an inner end surface of the tubular portion 123B side in the axial direction of the bottom portion 122B of the case member 95B and a groove bottom surface at an innermost end in the concave direction of the seal groove 141B of the chamber forming member 295B to continuously seal a gap therebetween. In the chamber forming member 295B, an end surface opposite to the bottom portion 122B in the axial direction is in contact with the substrate portion 127 of the spring member 105. The chamber forming member 295B forms the case chamber 142 with the valve seat member 109B in its axial direction.

A gap is formed between the step portion 296B and the inner end surface of the bottom portion 122B of the case member 95B across the entire circumference. This gap is a passage portion 144B (third flow path) in a portion outside of the seal groove 141B in the radial direction of the chamber forming member 295B. The passage portion 144B is continuously connected to the case chamber 142. Moreover, this gap is a passage portion 145B (fourth flow path) in an inner portion of the seal groove 141B in the radial direction of the chamber forming member 295B. The passage portion 145B is continuously connected to the lower chamber 23 via a passage in the passage hole 291B of the case member 95B. The chamber forming member 295B has the passage portion 144B and the passage portion 145B with the case member 95B. The chamber forming member 295B defines the passage portion 144B and the passage portion 145B with the case member 95B.

The radial width of the seal groove 141B, i.e., the distance between the wall surfaces of both radial ends of the seal groove 141B, is longer than half a difference between an outer diameter and an inner diameter of the O-ring 108B arranged in the seal groove 141B and in contact with the groove bottom surface of the seal groove 141B and the inner end surface of the bottom portion 122B. Therefore, the O-ring 108B can be moved in the radial direction of the seal groove 141B in the seal groove 141B. During this movement, the O-ring 108B slides on the groove bottom surface of the seal groove 141B and the inner end surface of the bottom portion 122B. The O-ring 108B divides the inside of the seal groove 141B into the pressure storage chamber 147B (third chamber) and the pressure storage chamber 148B (fourth chamber).

The pressure storage chamber 147B is provided outside of the O-ring 108B of the seal groove 141B in the radial direction of the chamber forming member 295B. The pressure storage chamber 147B is continuously connected to the passage portion 144B.

The pressure storage chamber 148B is provided inside of the O-ring 108B of the seal groove 141B in the radial direction of the chamber forming member 295B. The pressure storage chamber 148B is continuously connected to the passage portion 145B. A connection between the pressure storage chamber 147B and the pressure storage chamber 148B is continuously blocked by the O-ring 108B.

The passage portion 144B is connected to the pressure storage chamber 147B, that is one of the pressure storage chamber 147B and the pressure storage chamber 148B. The passage portion 145B is connected to the pressure storage chamber 148B that is the other of the pressure storage chamber 147B and the pressure storage chamber 148B. The case member 95B and the chamber forming member 295B have the passage portion 144B connected to the upper chamber 22 (see FIG. 2). The case member 95B and the chamber forming member 295B have the passage portion 145B that connects the lower chamber 23 to the pressure storage chamber 148B.

A portion on the inner end surface side of the bottom portion 122B of the case member 95B and the step portion 296B including the seal groove 141B of the chamber forming member 295B constitutes the outer shell portion 150B. The outer shell portion 150B constitutes the outer shell of the pressure storage chamber 147B and the pressure storage chamber 148B. The outer shell portion 150B accommodates the O-ring 108B. The O-ring 108B divides the inside of the outer shell portion 150B into the pressure storage chamber 147B and the pressure storage chamber 148B.

The pressure storage chamber 147B is continuously connected to the upper chamber 22 (see FIG. 2) via the passage portion 144B and the second passage 182.

The volumes of the pressure storage chamber 147B and the pressure storage chamber 148B change as the O-ring 108B deforms while moving radially in the seal groove 141B. That is, the O-ring 108B, the pressure storage chamber 147B, the pressure storage chamber 148B, and the outer shell portion 150B constitute the pressure storage portion 151B provided so that the volume can be changed. The volume of the pressure storage chamber 147B is increased to allow the inflow of oil liquid L from the upper chamber 22 (see FIG. 2). At this time, the pressure storage chamber 148B decreases in volume and discharges the oil liquid L to the lower chamber 23 side. The volume of the pressure storage chamber 148B is increased to allow the inflow of oil liquid L from the lower chamber 23. At this time, the pressure storage chamber 147B decreases in volume and discharges the oil liquid L to the upper chamber 22 (see FIG. 2). The chamber forming member 295B has the second passage 182, the passage portions 144B and 145B, and the pressure storage chambers 147B and 148B with the case member 95B. The passage portion 144B branches from the second passage 182 and is connected to the pressure storage portion 151B.

The O-ring 108B and the pressure storage chamber 148B constitute a lower-chamber-side volume variable mechanism 185B that changes the volume on the lower chamber 23 side by changing the volume of the pressure storage chamber 148B. The lower-chamber-side volume variable mechanism 185B is connected to the passage portion 145B on the compression side.

The lower-chamber-side volume variable mechanism 185B makes a change to increase the volume of the pressure storage chamber 148B when the O-ring 108B is deformed while moving radially outward or is deformed radially outward in contact with a radially outward wall surface of the seal groove 141B. At this time, the O-ring 108B maintains a state in which the pressure storage chamber 148B and the pressure storage chamber 147B are blocked.

Moreover, the lower-chamber-side volume variable mechanism 185B is changed to decrease the volume of the pressure storage chamber 148B when the O-ring 108B is deformed while moving radially inward or crushed radially inward in contact with a radially inward wall surface of the seal groove 141B. At this time, the O-ring 108B also maintains a state in which the pressure storage chamber 148B and the pressure storage chamber 147B are blocked.

The O-ring 108B and the pressure storage chamber 147B constitute the upper-chamber-side volume variable mechanism 186B. The upper-chamber-side volume variable mechanism 186B changes the volume of the upper chamber 22 (see FIG. 2) side by changing the volume of the pressure storage chamber 147B. The upper-chamber-side volume variable mechanism 186B is connected to the passage portion 144B on the extension side.

The upper-chamber-side volume variable mechanism 186B is changed to increase the volume of the pressure storage chamber 147B when the O-ring 108B is deformed while moving radially inward or crushed radially inward in contact with a radially inward wall surface of the seal groove 141B. At this time, the O-ring 108B maintains a state in which the pressure storage chamber 147B and the pressure storage chamber 148B are blocked.

Moreover, the upper-chamber-side volume variable mechanism 186B is changed to decrease the volume of the pressure storage chamber 147B when the O-ring 108B is deformed while moving radially outward or crushed radially outward in contact with a radially outward wall surface of the seal groove 141B. At this time, the O-ring 108B also maintains a state in which the pressure storage chamber 147B and the pressure storage chamber 148B are blocked.

The O-ring 108B is shared by the lower-chamber-side volume variable mechanism 185B and the upper-chamber-side volume variable mechanism 186B. The lower-chamber-side volume variable mechanism 185B including the pressure storage chamber 148B and the upper-chamber-side volume variable mechanism 186B including the pressure storage chamber 147B are provided in the pressure storage portion 151B that stores the oil liquid L as a working fluid.

### <Operation>

In the extension stroke of the shock absorber 2B, the piston 21 moves to the upper chamber 22 (see FIG. 2) side, and therefore the pressure of the upper chamber 22 (see FIG. 2) increases and the pressure of the lower chamber 23 decreases. Here, none of the first damping force generation mechanism 41, the first damping force generation mechanism 42 (see FIG. 2), and the second damping force generation mechanisms 173 and 183 has a fixed orifice that continuously connects the upper chamber 22 (see FIG. 2) and the lower chamber 23. Therefore, the oil liquid L of the upper chamber 22 (see FIG. 2) flows into the pressure storage chamber 147B via the second passage 182 and the passage portion 144B branching from the second passage 182. Thereby, the pressure of the pressure storage chamber 147B is increased. For this reason, in the upper-chamber-side volume variable mechanism 186B, the O-ring 108B is deformed while moving radially inward or crushed in contact with the wall surface inside of the seal groove 141B in the radial direction before the second damping force generation mechanism 183 opens the valve. Then, the O-ring 108B increases the capacity of the pressure storage chamber 147B. Thereby, the upper-chamber-side volume variable mechanism 186B suppresses the increase in the pressure of the pressure storage chamber 147B. At this time, the lower-chamber-side volume variable mechanism 185B including the O-ring 108B decreases the volume of the pressure storage chamber 148B.

Here, an amount of oil liquid L flowing from the upper chamber 22 (see FIG. 2) to the pressure storage chamber 147B as described above is large in the extension stroke at the time of low-frequency input (at the time of large amplitude excitation) of the shock absorber 2B. For this reason, the O-ring 108B is deformed to a limit at the initial stage of the extension stroke and crushed to the limit. Then, thereafter, the O-ring 108B does not deform. Thereby, the capacity of the pressure storage chamber 147B does not increase. As a result, the pressure of the second passage 182 is increased before the second damping force generation mechanism 183 opens the valve.

At this time, none of the first damping force generation mechanism 41, the first damping force generation mechanism 42 (see FIG. 2), and the second damping force generation mechanisms 173 and 183 has a fixed orifice that continuously connects the upper chamber 22 (see FIG. 2) and the lower chamber 23. For this reason, in the extension stroke in which the piston speed is less than a first predetermined value at which the second damping force generation mechanism 183 opens the valve, the damping force rises rapidly. Moreover, in an extremely low-speed region where the piston speed is less than a second predetermined value greater than the first predetermined value as a high-speed region from the first predetermined value, the first damping force generation mechanism 41 closes the valve and the second damping force generation mechanism 183 opens the valve.

That is, the sub-valve 110 is seated away from the valve seat portion 139 and connects the upper chamber 22 (see FIG. 2) and the lower chamber 23 in the second passage 182 on the extension side. Therefore, the oil liquid L of the upper chamber 22 (see FIG. 2) flows into the lower chamber 23 via the second passage 182. Thereby, even in an extremely low-speed region where the piston speed is less than the second predetermined value, a damping force of the valve characteristic (the characteristic in which the damping force is substantially proportional to the piston speed) is obtained.

Moreover, in the extension stroke at the time of low-frequency input of the shock absorber 2B, in a normal speed region where the piston speed is greater than or equal to the second predetermined value, the first damping force generation mechanism 41 opens the valve while the second damping force generation mechanism 183 opens the valve. That is, as described above, the main valve 91 is seated away from the valve seat portion 48 and the oil liquid L flows from the upper chamber 22 (see FIG. 2) to the lower chamber 23 in the first passage 92 on the extension side while the sub-valve 110 is seated away from the valve seat portion 139 and the oil liquid L flows from the upper chamber 22 (see FIG. 2) to the lower chamber 23 in the second passage 182 on the extension side. Therefore, the oil liquid L of the upper chamber 22 (see FIG. 2) flows into the lower chamber 23 via the first passage 92.

Thereby, even in the normal speed region where the piston speed is greater than or equal to the second predetermined value, a damping force of the valve characteristic (the damping force is substantially proportional to the piston speed) can be obtained. An increase rate in the damping force on the extension side for the increase in the piston speed in the normal speed region is lower than an increase rate in the damping force on the extension side for the increase in the piston speed in the extremely low-speed region.

In the extension stroke at the time of high-frequency input (at the time of small amplitude excitation) in which a frequency higher than the low-frequency input described above is input to the shock absorber 2B, the amount of oil liquid L flowing from the upper chamber 22 (see FIG. 2) to the pressure storage chamber 147B is small. For this reason, the sliding and deformation of the O-ring 108B are small. As a result, the upper-chamber-side volume variable mechanism 186B can absorb the volume of the inflow of the oil liquid L into the pressure storage chamber 147B by sliding and deforming the O-ring 108B. Therefore, the pressure boost of the pressure storage chamber 147B decreases. For this reason, when the extremely low-speed damping force rises, the state is similar to a state when there is no O-ring 108B.

Therefore, in the extension stroke at the time of high-frequency input, the rise of the extremely low-speed damping force is gradual at the time of low-frequency input or with respect to the conventional damping force characteristic.

In the compression stroke of the shock absorber 2B, the piston 21 moves to the lower chamber 23 side, and therefore the pressure of the lower chamber 23 increases and the pressure of the upper chamber 22 (see FIG. 2) decreases. Here, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). Therefore, the oil liquid L of the lower chamber 23 flows into the pressure storage chamber 148B via a passage in the passage hole 291B and the passage portion 145B. Thereby, the pressure of the pressure storage chamber 148B is increased. For this reason, in the lower-chamber-side volume variable mechanism 185B, the O-ring 108B is moved radially outward or crushed in contact with a radially outward wall surface of the seal groove 141B before the second damping force generation mechanism 173 opens the valve. Then, the O-ring 108B increases the capacity of the pressure storage chamber 148B. Thereby, the lower-chamber-side volume variable mechanism 185B suppresses the increase in the pressure of the pressure storage chamber 148B. At this time, the upper-chamber-side volume variable mechanism 186B including the O-ring 108B decreases the volume of the pressure storage chamber 147B.

Here, an amount of oil liquid L flowing from the lower chamber 23 to the pressure storage chamber 148B as described above is large in the compression stroke at the time of low-frequency input (at the time of large amplitude excitation) of the shock absorber 2B. For this reason, the O-ring 108B is moved to a limit at the initial stage of the compression stroke and crushed to the limit. Then, thereafter, the O-ring 108B does not deform. Thereby, the capacity of the pressure storage chamber 148B does not increase. As a result, the pressure of the second passage 172 is increased before the second damping force generation mechanism 173 opens the valve.

At this time, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). For this reason, in the compression stroke in which the piston speed is less than a third predetermined value at which the second damping force generation mechanism 173 opens the valve, the damping force rises rapidly. Moreover, in an extremely low-speed region where the piston speed is less than a fourth predetermined value greater than the third predetermined value as a high-speed region from the third predetermined value, the second damping force generation mechanism 173 opens the valve in a state in which the first damping force generation mechanism 42 (see FIG. 2) closes the valve.

That is, the sub-valve 107 is seated away from the valve seat portion 135 and connects the lower chamber 23 and the upper chamber 22 (see FIG. 2) in the second passage 172 on the compression side. Therefore, the oil liquid L of the lower chamber 23 flows into the upper chamber 22 (see FIG. 2) via the second passage 172. Thereby, even in an extremely low-speed region where the piston speed is less than the fourth predetermined value, a damping force of the valve characteristic (the characteristic in which the damping force is substantially proportional to the piston speed) is obtained.

Moreover, in the compression stroke at the time of low-frequency input of the shock absorber 2B, in a normal speed region where the piston speed is greater than or equal to the fourth predetermined value, the first damping force generation mechanism 42 (see FIG. 2) opens the valve while the second damping force generation mechanism 173 opens the valve. That is, as described above, the main valve 71 (see FIG. 2) is seated away from the valve seat portion 50 (see FIG. 2) and the oil liquid L flows from the lower chamber 23 to the upper chamber 22 (see FIG. 2) in the first passage 72 on the compression side while the sub-valve 107 is seated away from the valve seat portion 135 and the oil liquid L flows from the lower chamber 23 to the upper chamber 22 (see FIG. 2) in the second passage 172 on the compression side. Therefore, the oil liquid L of the lower chamber 23 flows into the upper chamber 22 (see FIG. 2) via the first passage 72.

Thereby, even in the normal speed region where the piston speed is greater than or equal to the fourth predetermined value, a damping force of the valve characteristic (the damping force is substantially proportional to the piston speed) can be obtained. An increase rate in the damping force on the compression side for the increase in the piston speed in the normal speed region is lower than an increase rate in the damping force on the compression side for the increase in the piston speed in the extremely low-speed region.

In the compression stroke at the time of high-frequency input (at the time of small amplitude excitation) in which a frequency higher than the low-frequency input described above is input to the shock absorber 2B, the amount of oil liquid L flowing from the lower chamber 23 to the pressure storage chamber 148B is small. For this reason, the sliding and deformation of the O-ring 108B are small. As a result, the lower-chamber-side volume variable mechanism 185B can absorb the volume of the inflow of oil liquid L into the pressure storage chamber 148B by sliding and deforming the O-ring 108B radially outward. Therefore, the pressure boost of the pressure storage chamber 148B decreases. For this reason, when the extremely low-speed damping force rises, the state is similar to a state when there is no O-ring 108B.

Therefore, in the compression stroke at the time of high-frequency input, the rise of the extremely low-speed damping force is gradual at the time of low-frequency input or with respect to the conventional damping force characteristic.

The damping force generation device 1B of the third embodiment has the chamber forming member 295B provided at least partially parallel to the first passage 92 and having the second passage 182 that connects the upper chamber 22 (see FIG. 2) and the lower chamber 23. Also, the passage portion 144B branching from the second passage 182 in a direction from the upper chamber 22 to the second damping force generation mechanism 183 and connected to the pressure storage portion 151B is provided in the chamber forming member 295B. Because a function of the pressure storage portion 151B is similar to that of the pressure storage portion 151, the effect of the damping force generation device 1B is similar to that of the damping force generation device 1.

### Fourth Embodiment

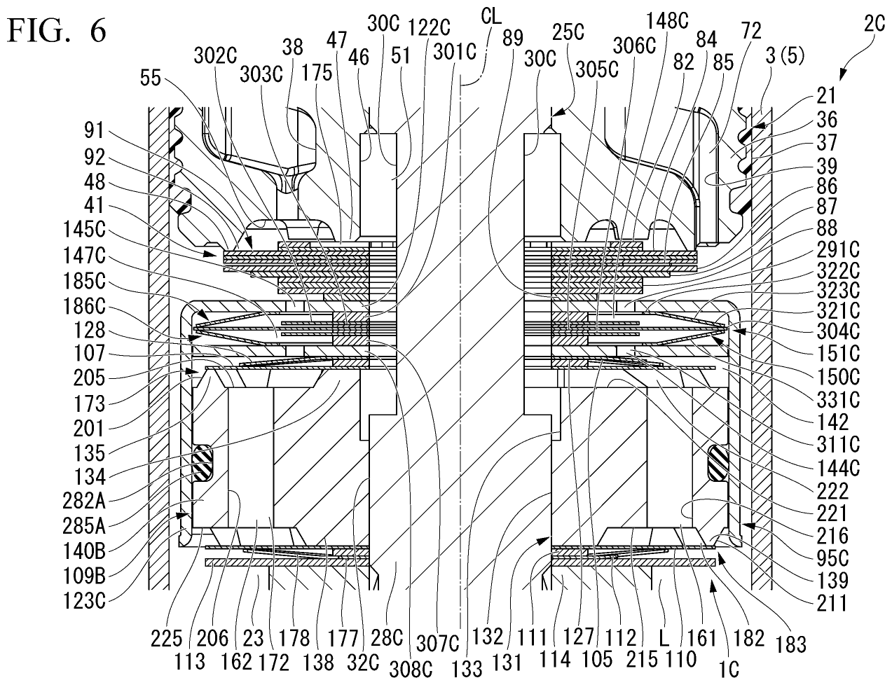

Next, a fourth embodiment will be described mainly on the basis of the differences from the third embodiment on the basis of FIG. 6. Also, parts identical to those of the third embodiment are represented by the same designation and the same reference numerals. Moreover, reference sign CL in FIG. 6 denotes a central axis of a damping force generation device 1C.

### <Configuration>

As shown in FIG. 6, the damping force generation device 1C of the fourth embodiment is partially different from the damping force generation device 1B. A shock absorber 2C is different from the shock absorber 2B in that it has the damping force generation device 1C instead of the damping force generation device 1B. The damping force generation device 1C has a piston rod 25C partly different from the piston rod 25B instead of the piston rod 25B. The piston rod 25C has a mounting shaft portion 28C with a longer axial length than the mounting shaft portion 28B instead of the mounting shaft portion 28B. The mounting shaft portion 28C has a fitting shaft portion 32C with a longer axial length than the fitting shaft portion 32B instead of the fitting shaft portion 32B. The fitting shaft portion 32C has a passage notch 30C with a longer axial length than the passage notch 30B of the fitting shaft portion 32C instead of the passage notch 30B.

Moreover, the damping force generation device 1C has a case member 95C (second regulation member) partially different from the case member 95B instead of the case member 95B. The case member 95C has a tubular portion 123C with a longer axial length than the tubular portion 123B instead of the tubular portion 123B. The case member 95C has a bottom portion 122C partially different from the bottom portion 122B instead of the bottom portion 122B. The bottom portion 122C has a passage hole 291C whose position is different from that of the passage hole 291B instead of the passage hole 291B. A plurality of passage holes 291C are provided at equal intervals in a circumferential direction of the bottom portion 122C in the bottom portion 122C. The passage hole 291C is arranged outside of an outer end of a disc 89 in the radial direction of the bottom portion 122C. The passage portion 145C (fourth flow path) in the passage hole 291C is continuously connected to the lower chamber 23.

Moreover, the damping force generation device 1C includes a disc 301C, a disc 302C, a disc 302C, a disc 303C, an elastic disc 304C (elastic member), a disc 305C, and a disc 306C, a disc 307C, and a passage disc 308C (second regulation member) in order from the bottom portion 122C side between the bottom portion 122C of the case member 95C in the axial direction of the piston rod 25C and the spring member 105. Each of the discs 301C to 303C and 305C to 307C, the elastic disc 304C, and the passage disc 308C is made of a metal and has a perforated circular flat plate with a uniform thickness and a uniform radial width across the entire circumference. Each of the discs 301C to 303C and 305C to 307C, the elastic disc 304C, and the passage disc 308C is positioned in the radial direction with respect to the piston rod 25C by fitting the fitting shaft portion 32C inside. Each of the discs 301C to 303C and 305C to 307C, the elastic disc 304C, and the passage disc 308C is a plain disc. The discs 301C to 303C and 305C to 307C, the elastic disc 304C, and the passage disc 308C are clamped to the bottom portion 122C and the substrate portion 127 of the spring member 105 in the axial direction of the piston rod 25C.

An outer diameter of the disc 301C is smaller than twice a minimum distance from the center of the case member 95C to the passage hole 291C. The disc 301C is in contact with the bottom portion 122C of the case member 95C. An outer diameter of the disc 302C is larger than an outer diameter of the disc 301C. An outer diameter of the disc 303C is smaller than the outer diameter of the disc 301C. The elastic disc 304C has an outer diameter larger than the outer diameter of the disc 302C and slightly smaller than the inner diameter of the tubular portion 123C. The elastic disc 304C is formed in the shape of a plate and can be flexed. The disc 305C is a common part having the same shape as the disc 303C. The disc 306C is a common part having the same shape as the disc 302C. The disc 307C is a common part having the same shape as the disc 301C. The thicknesses of both the discs 301C and 307C are thicker than the thicknesses of the discs 302C, 303C, 305C, and 306C and the elastic disc 304C.

The outer diameter of the passage disc 308C is equivalent to the outer diameter of the elastic disc 304C and is slightly smaller than the inner diameter of the tubular portion 123C. The thickness of the passage disc 308C is thicker than the thicknesses of the discs 303C, 303C, 305C, and 306C and the elastic discs 304C. In the passage disc 308C, a passage hole 311C that penetrates through the passage disc 308C in its axial direction is formed. A plurality of passage holes 311C are provided in the passage disc 308C at equal intervals in the circumferential direction of the passage disc 308C. The passage hole 311C is arranged outside of the outer end of the disc 307C in the radial direction of the passage disc 308C. The passage disc 308C forms the case chamber 142 of the second passage 182 with the valve seat member 109B in the axial direction. Therefore, the passage disc 308C has a second passage 182 with the valve seat member 109B. The passage portion 144C (third flow path) in the passage hole 311C is continuously connected to the case chamber 142. The passage disc 308C defines the passage portion 144C.

Moreover, the damping force generation device 1C has a disc spring 321C (first disc spring) between the bottom portion 122C in the axial direction of the piston rod 25C and the elastic disc 304C. The discs 301C to 303C are arranged on a radially inward side of the disc spring 321C. The disc spring 321C is annular and has a substrate portion 322C and a plate spring portion 323C. The substrate portion 322C has a perforated circular flat plate shape. The plate spring portion 323C is annular and extends from an outer circumferential edge portion of the substrate portion 322C to the outward side in the radial direction of the substrate portion 322C. The plate spring portion 323C is tapered in the axial direction of the substrate portion 322C from the substrate portion 322C toward a radially outward side.

An inner diameter of the disc spring 321C, i.e., an inner diameter of the substrate portion 322C, is larger than twice a maximum distance from the center of the case member 95C to the passage hole 291C. An outer diameter of the disc spring 321C, i.e., an outer diameter of the plate spring portion 323C, is larger than the outer diameter of the disc 302C and slightly smaller than the outer diameter of the elastic disc 304C. In the disc spring 321C, the substrate portion 322C is in contact with the bottom portion 122C across the entire circumference according to its spring force. In the disc spring 321C, an end edge portion of a large diameter side of the plate spring portion 323C is in contact with the elastic disc 304C across the entire circumference according to its spring force. The disc spring 321C is positioned in the radial direction with respect to the case member 95C on the inner circumferential surface of the tubular portion 123C.

Moreover, the damping force generation device 1C has the disc spring 331C (second disc spring) between the elastic disc 304C and the passage disc 308C in the axial direction of the piston rod 25C. The discs 305C to 307C are arranged on a radially inward side of the disc spring 331C. The disc spring 331C is a common part having the same shape as the disc spring 321C.

An inner diameter of the disc spring 331C, i.e., an inner diameter of the substrate portion 322C, is larger than twice a maximum distance from the center of the passage disc 308C to the passage hole 311C. An outer diameter of the disc spring 331C, i.e., an outer diameter of the plate spring portion 323C, is larger than the outer diameter of the disc 306C and slightly smaller than the outer diameter of the elastic disc 304C. In the disc spring 331C, the substrate portion 322C is in contact with the passage disc 308C across the entire circumference according to its spring force. In the disc spring 331C, an end edge portion of a large diameter side of the plate spring portion 323C is in contact with the elastic disc 304C across the entire circumference according to its spring force. The disc spring 331C is positioned in the radial direction with respect to the case member 95C on the inner circumferential surface of the tubular portion 123C.

Both the disc springs 321C and 331C have the plate spring portion 323C having a convex and annular shape in a direction away from the elastic disc 304C. The elastic disc 304C is sandwiched between them by spring forces of the disc springs 321C and 331C. The disc springs 321C and 331C are biased to maintain a portion on the outer circumferential side of the elastic disc 304C at a predetermined position in the axial direction. The elastic disc 304C is basically elastically deformed in a concave or convex shape in an axial direction between a portion on the inner circumferential side clamped to the discs 303C and 305C and a portion on the outer circumferential side sandwiched between the disc springs 321C and 331C.

A portion surrounded by the elastic disc 304C, the discs 305C to 307C, the passage disc 308C, and the disc spring 331C is a pressure storage chamber 147C (third chamber). The pressure storage chamber 147C is continuously connected to the passage portion 144C. That is, the pressure storage chamber 147C is continuously connected to the upper chamber 22 via the passage portion 144C.

The portion surrounded by the bottom portion 122C, the discs 301C to 303C, the elastic disc 304C, and the disc spring 321C is the pressure storage chamber 148C (fourth chamber). The pressure storage chamber 148C is continuously connected to the passage portion 145C. That is, the pressure storage chamber 148C is continuously connected to the lower chamber 23 via the passage portion 145C.

The bottom portion 122C, the discs 301C to 303C and 305C to 307C, the disc springs 321C and 331C, and the passage disc 308C constitute the outer shell portion 150C. Therefore, the outer shell portion 150C is formed by the disc springs 321C and 331C. The elastic disc 304C divides the inside of the outer shell portion 150C into the pressure storage chamber 147C and the pressure storage chamber 148C. The outer shell portion 150C constitutes the outer shell of the pressure storage chamber 147C and the pressure storage chamber 148C.

The passage portion 144C is connected to the pressure storage chamber 147C that is one of the pressure storage chamber 147C and the pressure storage chamber 148C. The passage portion 145C is connected to the pressure storage chamber 148C that is the other of the pressure storage chamber 147C and the pressure storage chamber 148C. The passage disc 308C has the passage portion 144C connected to the upper chamber 22 (see FIG. 2). The case member 95C has the passage portion 145C that connects the lower chamber 23 to the pressure storage chamber 148C.

The pressure storage chamber 147C is continuously connected to the upper chamber 22 (see FIG. 2) via the passage portion 144C and the second passage 182.

The volumes of the pressure storage chamber 147C and the pressure storage chamber 148C change due to the elastic disc 304C elastically deforming in a concave or convex shape in the axial direction. That is, the elastic disc 304C, the pressure storage chamber 147C, the pressure storage chamber 148C, and the outer shell portion 150C constitute a pressure storage portion 151C provided so that the volume can be changed. The volume of the pressure storage chamber 147C is increased to allow the inflow of oil liquid L from the upper chamber 22 (see FIG. 2). At this time, the volume of the pressure storage chamber 148C decreases and the pressure storage chamber 148C discharges the oil liquid L to the lower chamber 23 side. The volume of the pressure storage chamber 148C is increased to allow the inflow of the oil liquid L from the lower chamber 23. At this time, the volume of the pressure storage chamber 147C decreases and the pressure storage chamber 147C discharges the oil liquid L to the upper chamber 22 (see FIG. 2) side. The passage portion 144C branches from the second passage 182 and is connected to the pressure storage portion 151C.

The elastic disc 304C, the pressure storage chamber 148C, and the disc spring 321C constitute a lower-chamber-side volume variable mechanism 185C that changes the volume of the lower chamber 23 side by changing the volume of the pressure storage chamber 148C. The lower-chamber-side volume variable mechanism 185C is connected to the passage portion 145C on the compression side.

The lower-chamber-side volume variable mechanism 185C makes a change to increase the volume of the pressure storage chamber 148C when the elastic disc 304C is deformed in a concave shape in a direction away from the bottom portion 122C.

Moreover, the lower-chamber-side volume variable mechanism 185C makes a change to decrease the volume of the pressure storage chamber 148C when the elastic disc 304C is deformed in a convex shape in a direction close to the bottom portion 122C.

The elastic disc 304C, the pressure storage chamber 147C, and the disc spring 331C constitute an upper-chamber-side volume variable mechanism 186C that changes the volume of the upper chamber 22 side by changing the volume of the pressure storage chamber 147C. The upper-chamber-side volume variable mechanism 186C is connected to the passage portion 144C on the extension side.

The upper-chamber-side volume variable mechanism 186C makes a change to increase the volume of the pressure storage chamber 147C when the elastic disc 304C is deformed in a concave shape in a direction away from the passage disc 308C.

Moreover, the upper-chamber-side volume variable mechanism 186C makes a change to decrease the volume of the pressure storage chamber 147C when the elastic disc 304C is deformed in a convex shape in a direction close to the passage disc 308C.

The elastic disc 304C is shared by the lower-chamber-side volume variable mechanism 185C and the upper-chamber-side volume variable mechanism 186C. The lower-chamber-side volume variable mechanism 185C including the pressure storage chamber 148C and the upper-chamber-side volume variable mechanism 186C including the pressure storage chamber 147C are provided in the pressure storage portion 151C for storing the oil liquid L as a working fluid.

### <Operation>

In the extension stroke of the shock absorber 2C, the piston 21 moves to the upper chamber 22 (see FIG. 2), and therefore the pressure of the upper chamber 22 (see FIG. 2) increases and the pressure of the lower chamber 23 decreases. Here, none of the first damping force generation mechanism 41, the first damping force generation mechanism 42 (see FIG. 2), and the second damping force generation mechanisms 173 and 183 has a fixed orifice that continuously connects the upper chamber 22 (see FIG. 2) and the lower chamber 23. Therefore, the oil liquid L of the upper chamber 22 (see FIG. 2) flows into the pressure storage chamber 147C via the second passage 182 and the passage portion 144C branching from the second passage 182. Thereby, the pressure of the pressure storage chamber 147C is increased. For this reason, the upper-chamber-side volume variable mechanism 186C elastically deforms so that the elastic disc 304C expands the volume of the pressure storage chamber 147C before the second damping force generation mechanism 183 opens the valve. Thereby, the upper-chamber-side volume variable mechanism 186C suppresses the increase in the pressure of the pressure storage chamber 147C. At this time, the lower-chamber-side volume variable mechanism 185C including the elastic disc 304C decreases the volume of the pressure storage chamber 148C.

Here, in the extension stroke at the time of low-frequency input (at the time of large amplitude excitation) of the shock absorber 2C, an amount of oil liquid L flowing from the upper chamber 22 (see FIG. 2) to the pressure storage chamber 147C as described above is large. For this reason, the elastic disc 304C deforms to the limit on the bottom portion 122C side while the disc springs 321C and 331C are deformed at the initial stage of the extension stroke. Then, thereafter, the elastic disc 304C does not deform. Thereby, the capacity of the pressure storage chamber 147C does not increase. As a result, the pressure of the second passage 182 is increased before the second damping force generation mechanism 183 opens the valve.

At this time, none of the first damping force generation mechanism 41, the first damping force generation mechanism 42 (see FIG. 2), and the second damping force generation mechanisms 173 and 183 has a fixed orifice that continuously connects the upper chamber 22 (see FIG. 2) and the lower chamber 23. For this reason, in the extension stroke in which the piston speed is less than a first predetermined value at which the second damping force generation mechanism 183 opens the valve, the damping force rises rapidly. Moreover, in an extremely low-speed region where the piston speed is less than a second predetermined value greater than the first predetermined value as a high-speed region from the first predetermined value, the first damping force generation mechanism 41 closes the valve and the second damping force generation mechanism 183 opens the valve.

That is, the sub-valve 110 is seated away from the valve seat portion 139 and connects the upper chamber 22 (see FIG. 2) and the lower chamber 23 in the second passage 182 on the extension side. Therefore, the oil liquid L of the upper chamber 22 (see FIG. 2) flows into the lower chamber 23 via the second passage 182. Thereby, even in an extremely low-speed region where the piston speed is less than the second predetermined value, a damping force of the valve characteristic (the characteristic in which the damping force is substantially proportional to the piston speed) is obtained.

Moreover, in the extension stroke at the time of low-frequency input of the shock absorber 2C, in a normal speed region where the piston speed is greater than or equal to the second predetermined value, the first damping force generation mechanism 41 opens the valve while the second damping force generation mechanism 183 opens the valve. That is, as described above, the main valve 91 is seated away from the valve seat portion 48 and the oil liquid L flows from the upper chamber 22 (see FIG. 2) to the lower chamber 23 in the first passage 92 on the extension side while the sub-valve 110 is seated away from the valve seat portion 139 and the oil liquid L flows from the upper chamber 22 (see FIG. 2) to the lower chamber 23 in the second passage 182 on the extension side. Therefore, the oil liquid L of the upper chamber 22 (see FIG. 2) flows into the lower chamber 23 via the first passage 92.

Thereby, even in the normal speed region where the piston speed is greater than or equal to the second predetermined value, a damping force of the valve characteristic (the damping force is substantially proportional to the piston speed) can be obtained. An increase rate in the damping force on the extension side for the increase in the piston speed in the normal speed region is lower than an increase rate in the damping force on the extension side for the increase in the piston speed in the extremely low-speed region.

In the extension stroke at the time of high-frequency input (at the time of small amplitude excitation) in which a frequency higher than the low-frequency input described above is input to the shock absorber 2C, the amount of oil liquid L flowing from the upper chamber 22 (see FIG. 2) to the pressure storage chamber 147C is small. For this reason, the deformation of the elastic disc 304C is small. As a result, the upper-chamber-side volume variable mechanism 186C can absorb the volume of the inflow of the oil liquid L into the pressure storage chamber 147C by deforming the elastic disc 304C. Therefore, the pressure boost of the pressure storage chamber 147C decreases. For this reason, when the extremely low-speed damping force rises, the state is similar to a state when there is no elastic disc 304C.

Therefore, in the extension stroke at the time of high-frequency input, the rise of the extremely low-speed damping force is gradual at the time of low-frequency input or with respect to the conventional damping force characteristic.

In the compression stroke of the shock absorber 2C, the piston 21 moves to the lower chamber 23 side, and therefore the pressure of the lower chamber 23 increases and the pressure of the upper chamber 22 (see FIG. 2) decreases. Here, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). Therefore, the oil liquid L of the lower chamber 23 flows into the pressure storage chamber 148C via the passage portion 145C. Thereby, the pressure of the pressure storage chamber 148C is increased. For this reason, the elastic disc 304C is deformed in the lower-chamber-side volume variable mechanism 185C before the second damping force generation mechanism 173 opens the valve. Then, the elastic disc 304C increases the capacity of the pressure storage chamber 148C. Thereby, the lower-chamber-side volume variable mechanism 185C suppresses the increase in the pressure of the pressure storage chamber 148C. At this time, the upper-chamber-side volume variable mechanism 186C including the elastic disc 304C decreases the volume of the pressure storage chamber 147C.

Here, in the compression stroke at the time of low-frequency input (at the time of large amplitude excitation) of the shock absorber 2C, an amount of oil liquid L flowing from the lower chamber 23 to the pressure storage chamber 148C as described above is large. For this reason, the elastic disc 304C deforms to the limit on the passage disc 308C side while the disc springs 321C and 331C are deformed at the initial stage of the compression stroke. Then, thereafter, the elastic disc 304C does not deform. Thereby, the capacity of the pressure storage chamber 148C does not increase. As a result, the pressure of the second passage 172 is increased before the second damping force generation mechanism 173 opens the valve.

At this time, none of the first damping force generation mechanism 41, the first damping force generation mechanism 42 (see FIG. 2), and the second damping force generation mechanisms 173 and 183 has a fixed orifice that continuously connects the lower chamber 23 and the upper chamber 22 (see FIG. 2). For this reason, in the compression stroke in which the piston speed is less than a third predetermined value at which the second damping force generation mechanism 173 opens the valve, the damping force rises rapidly. Moreover, in an extremely low-speed region where the piston speed is less than a fourth predetermined value greater than the third predetermined value as a high-speed region from the third predetermined value, the second damping force generation mechanism 173 opens the valve in a state in which the first damping force generation mechanism 42 (see FIG. 2) closes the valve.

That is, the sub-valve 107 is seated away from the valve seat portion 135 and connects the lower chamber 23 and the upper chamber 22 (see FIG. 2) in the second passage 172 on the compression side. Therefore, the oil liquid L of the lower chamber 23 flows into the upper chamber 22 (see FIG. 2) via the second passage 172. Thereby, even in an extremely low-speed region where the piston speed is less than the fourth predetermined value, a damping force of the valve characteristic (the characteristic in which the damping force is substantially proportional to the piston speed) is obtained.

Moreover, in the compression stroke at the time of low-frequency input of the shock absorber 2C, in a normal speed region where the piston speed is greater than or equal to the fourth predetermined value, the first damping force generation mechanism 42 (see FIG. 2) opens the valve while the second damping force generation mechanism 173 opens the valve. That is, as described above, the main valve 71 (see FIG. 2) is seated away from the valve seat portion 50 (see FIG. 2) and the oil liquid L flows from the lower chamber 23 to the upper chamber 22 (see FIG. 2) in the first passage 72 on the compression side while the sub-valve 107 is seated away from the valve seat portion 135 and the oil liquid L flows from the lower chamber 23 to the upper chamber 22 (see FIG. 2) in the second passage 172 on the compression side. Therefore, the oil liquid L of the lower chamber 23 flows into the upper chamber 22 (see FIG. 2) via the first passage 72.

Thereby, even in the normal speed region where the piston speed is greater than or equal to the fourth predetermined value, a damping force of the valve characteristic (the damping force is substantially proportional to the piston speed) can be obtained. An increase rate in the damping force on the compression side for the increase in the piston speed in the normal speed region is lower than an increase rate in the damping force on the compression side for the increase in the piston speed in the extremely low-speed region.

In the compression stroke at the time of high-frequency input (at the time of small amplitude excitation) in which a frequency higher than the low-frequency input described above is input to the shock absorber 2C, an amount of oil liquid L flowing from the lower chamber 23 to the pressure storage chamber 148C is small. For this reason, the deformation of the elastic disc 304C is small. As a result, the lower-chamber-side volume variable mechanism 185C can absorb the volume of the inflow of oil liquid L into the pressure storage chamber 148C by deforming the elastic disc 304C. Therefore, the pressure boost of the pressure storage chamber 148C decreases. For this reason, when the extremely low-speed damping force rises, the state is similar to a state when there is no elastic disc 304C.

Therefore, in the compression stroke at the time of high-frequency input, the rise of the extremely low-speed damping force is gradual at the time of low-frequency input or with respect to the conventional damping force characteristic.

The damping force generation device 1C of the third embodiment includes the passage disc 308C provided at least partially parallel to the first passage 92 and having the second passage 182 that connects the upper chamber 22 (see FIG. 2) and the lower chamber 23. Also, the passage portion 144C branching from the second passage 182 in a direction from the upper chamber 22 to the second damping force generation mechanism 183 and connected to the pressure storage portion 151C is provided in the passage disc 308C. Because a function of the pressure storage portion 151C is similar to that of the pressure storage portion 151, the effect of the damping force generation device 1C is similar to that of the damping force generation device 1.

Moreover, the damping force generation device 1C has the elastic disc 304C formed in a plate shape. Moreover, the outer shell portion 150C is formed by the disc spring 321C and the disc spring 331C having the plate spring portion 323C with a convex and annular shape in a direction away from the elastic disc 304C. Also, the elastic disc 304C is sandwiched by spring forces of the disc spring 321C and the disc spring 331C. Therefore, durability can be improved.

### Fifth Embodiment

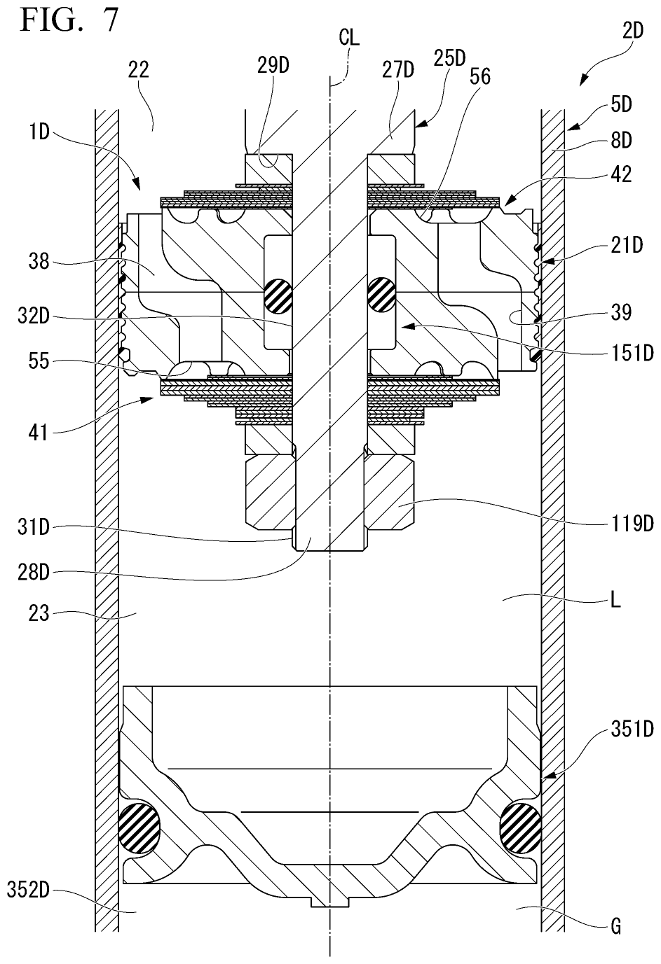

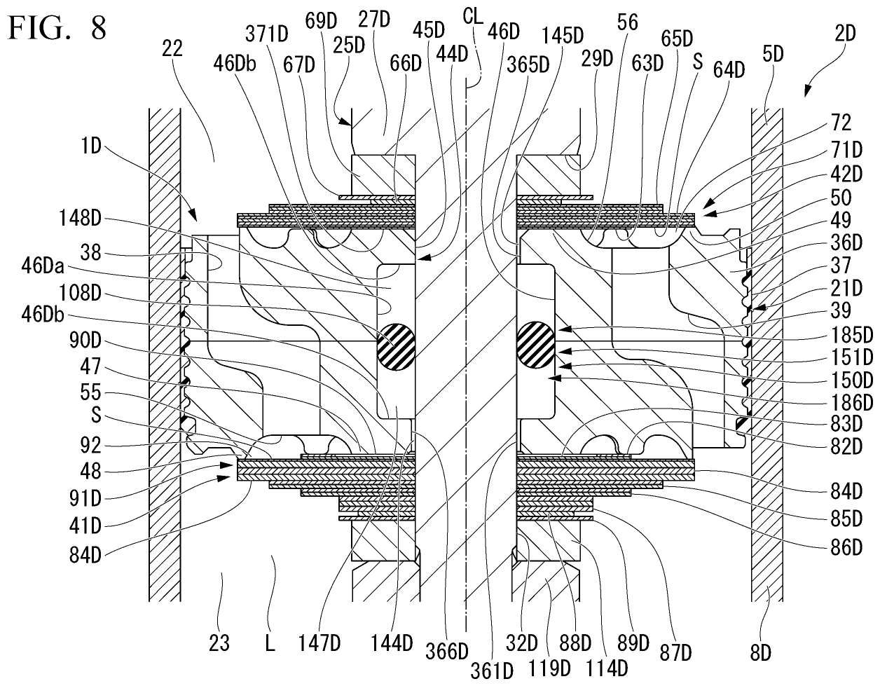

Next, a fifth embodiment will be described mainly on the basis of the differences from the first embodiment on the basis of FIGS. 7 and 8. Also, parts identical to those of the first embodiment are represented by the same designation and the same reference numerals. Moreover, reference sign CL in FIGS. 7 and 8 denotes a central axis of a damping force generation device 1D.

### <Configuration>

As shown in FIG. 7, the damping force generation device 1D of the fifth embodiment is provided in a shock absorber 2D. The shock absorber 2D is a single-tube shock absorber equipped with a cylinder 5D. The cylinder 5D is a tubular member, specifically a bottomed tubular member. The cylinder 5D has a tubular body portion 8D and a bottom portion (not shown) for closing one end of the body portion 8D in the axial direction and an opposite side of the bottom portion of the body portion 8D is an opening (not shown). The shock absorber 2D has a rod guide (not shown) and a seal member (not shown) on the opening side of the body portion 8D.

The damping force generation device 1D has a piston 21D (the first regulation member and the second regulation member) partially different from the piston 21 instead of the piston 21. The piston 21D is slidably provided in the body portion 8D of the cylinder 5D.

The shock absorber 2D has a free piston 351D. The free piston 351D is provided on a bottom portion side (not shown) of the piston 21D in the axial direction of the cylinder 5D. The free piston 351D is slidably provided in the body portion 8D of the cylinder 5D.

The piston 21D divides the inside of the cylinder 5D into an upper chamber 22 and a lower chamber 23. The free piston 351D divides the inside of the cylinder 5D into the lower chamber 23 and a gas chamber 352D. The upper chamber 22 is provided between the piston 21D in the cylinder 5D and a rod guide (not shown). The lower chamber 23 is provided between the piston 21D and the free piston 351D in the cylinder 5D. The gas chamber 352D is provided between the free piston 351D in the cylinder 5D and a bottom portion (not shown) of the cylinder 5D. In the cylinder 5D, an oil liquid L as a working fluid is enclosed in the upper chamber 22 and the lower chamber 23. In the cylinder 5D, a gas G is enclosed in the gas chamber 352D.

The damping force generation device 1D has a piston rod 25D (shaft member) different from the piston rod 25 instead of the piston rod 25. The piston rod 25D has a main shaft portion 27D and a mounting shaft portion 28D. The mounting shaft portion 28D has an outer diameter smaller than an outer diameter of the main shaft portion 27D. In the piston rod 25D, the main shaft portion 27D is slidably fitted to the rod guide (not shown) and a seal member (not shown). In the piston rod 25D, the mounting shaft portion 28D is arranged in the cylinder 5D and connected to the piston 21D. An end of the mounting shaft portion 28D side of the main shaft portion 27D is an axial step portion 29D that extends in an axial orthogonal direction.

On the outer circumferential portion of the mounting shaft portion 28D, a male thread 31D is formed at a tip position on the opposite side of the axial main shaft portion 27D. In the mounting shaft portion 28D, a portion other than the male thread 31D becomes a fitting shaft portion 32D. The fitting shaft portion 32D has a cylindrical shape in which the outer circumferential surface becomes a cylindrical surface. The piston 21D is fitted to the fitting shaft portion 32D and the nut 119D is screwed onto the male thread 31D.

As shown in FIG. 8, the piston 21D has a piston body 36D partially different from the piston body 36 instead of the piston body 36. The piston body 36D has an insertion hole 44D partially different from the insertion hole 44 instead of the insertion hole 44. The insertion hole 44D includes a small diameter hole 45D, a large diameter hole 46D, and a small diameter hole 361D. The small diameter hole 45D is arranged on one end side in the axial direction of the insertion hole 44D. The small diameter hole 361D is arranged on the other end side in the axial direction of the insertion hole 44D. The large diameter hole 46D is arranged between the small diameter hole 45D and the small diameter hole 361D. The large diameter hole 46D is annular and concave radially outward from the small diameter hole 45D and the small diameter hole 361D. The large diameter hole 46D has a bottom portion 46Da arranged on a radially outward side of the piston 21D and a pair of sidewall portions 46Db arranged on both sides in the axial direction of the piston 21D. In the bottom portion 46Da, the groove bottom surface facing a radially inward side of the piston 21D has a cylindrical surface shape in the axial direction of the piston 21D. The pair of sidewall portions 46Db are a planar shape in which wall surfaces facing each other in the axial direction of the piston 21D extend perpendicular to the axial direction of the piston 21D.

The small diameter hole 45D and the small diameter hole 361D have inner diameters equivalent to each other. The inner diameter of the large diameter hole 46D is larger than the inner diameters of the small diameter holes 45D and 361D. In the small diameter hole 45D, a passage groove 365D concave on its radially outward side and penetrating through the small diameter hole 45D in the axial direction is formed. In the small diameter hole 361D, the passage groove 366D concave on its radially outward side and penetrating through the small diameter hole 361D in the axial direction is formed. In the piston body 36D, the small diameter hole 45D is provided on the upper chamber 22 side in the axial direction and the small diameter hole 361D is provided on the lower chamber 23 side in the axial direction. In the piston 21D, the fitting shaft portion 32D of the piston rod 25D is fitted to the small diameter holes 45D and 361D. Thereby, the piston 21D is positioned in the radial direction with respect to the piston rod 25D.

The damping force generation device 1D has a first damping force generation mechanism 41D on the extension side different from the first damping force generation mechanism 41 instead of the first damping force generation mechanism 41. The damping force generation device 1D has a first damping force generation mechanism 42D on the compression side different from the first damping force generation mechanism 42 instead of the first damping force generation mechanism 42.

The first damping force generation mechanism 42D includes a valve seat portion 50 of the piston 21D. The first damping force generation mechanism 42D includes a disc 63D, a disc S, a plurality of (specifically, four) discs 64D, a plurality of (specifically, three) discs 65D, a disc 66D, a disc 67D, and an annular member 69D in order from the piston 21D in the axial direction. The plurality of discs 64D have the same outer diameter as each other. The plurality of discs 65D have the same outer diameter as each other. Each of the discs 64D to 67D and the annular member 69D is made of a metal and forms a perforated circular flat plate shape with a uniform thickness and a uniform radial width across the entire circumference. Each of the discs 63D to 67D and the annular member 69D is positioned in the radial direction with respect to the piston rod 25D by fitting the fitting shaft portion 32D inside. Each of the discs 63D to 67D and the annular member 69D is a plain disc.

The disc 63D has an outer diameter larger than the outer diameter of the inner seat portion 49 of the piston 21D and smaller than the inner diameter of the valve seat portion 50. The disc 63D is in contact with the inner seat portion 49. In the disc 63D, a notch 371D is formed from an intermediate position outside of the radial inner seat portion 49 to an inner circumferential edge portion. The notch 371D is formed during the press molding of the disc 63D. The passage in the notch 371D continuously connects a first passage 72 (first flow path) to the passage in the passage groove 365D. The passage groove 365D constitutes the passage portion 145D (fourth flow path). The disc S and the plurality of discs 64D have outer diameters equivalent to the outer diameter of the valve seat portion 50 of the piston 21D. The disc S can be seated in the valve seat portion 50. The disc S has a notch that continuously connects the passage in the plurality of passage holes 39 and the annular groove 56 to the upper chamber 22 on its outer circumferential side even if it is seated in the valve seat portion 50. The passage in this notch is a fixed orifice. The plurality of discs 65D have outer diameters smaller than the outer diameter of the disc 64D. The disc 66D has an outer diameter smaller than the outer diameter of the disc 65D. The disc 67D has an outer diameter larger than the outer diameter of the disc 66D. The annular member 69D has an outer diameter smaller than the outer diameter of the disc 67D. The annular member 69D is in contact with the axial step portion 29D.

The disc S, the plurality of discs 64D, and the plurality of discs 65D constitute a main valve 71D that can be detachably seated in the valve seat portion 50. The main valve 71D is seated away from the valve seat portion 50 and connects the passage in the plurality of passage holes 39 and the annular groove 56, i.e., the first passage 72, to the upper chamber 22. At this time, the main valve 71D generates a damping force by suppressing the flow of the oil liquid L between the valve seat portion 50.

The first damping force generation mechanism 41D on the extension side includes a valve seat portion 48 of the piston 21D. The first damping force generation mechanism 41D includes a disc 82D, a disc 83D, a disc S, a plurality of (specifically, three) discs 84D, a plurality of (specifically, two) discs 85D, a plurality of (specifically, two) discs 86D, a plurality of (specifically, three) discs 87D, a disc 88D, a disc 89D, and one annular member 114D in order from the piston 21D side in the axial direction. The disc 82D and the disc 83D have the same outer diameter as each other. The plurality of discs 84D have the same outer diameter as each other. The disc S and the plurality of discs 85D have the same outer diameter as each other. The plurality of discs 86D have the same outer diameter as each other. The plurality of discs 87D have the same outer diameter as each other. The discs 82D to 89D and the annular member 114D are made of a metal and are annular. Each of the discs 83D to 89D and the annular member 114D is a plain disc forming a perforated circular flat plate shape with a uniform thickness and a uniform radial width across the entire circumference. Each of the discs 82D to 89D and the annular member 114D is positioned in the radial direction with respect to the piston rod 25D by fitting the fitting shaft portion 32D inside.

The disc 82D has an outer diameter larger than the outer diameter of the inner seat portion 47 of the piston 21D and smaller than the inner diameter of the valve seat portion 48. The disc 82D is in contact with the inner seat portion 47. In the disc 82D, the notch 90D is formed from an intermediate position outside of the inner seat portion 47 in the radial direction to the inner circumferential edge portion. The notch 90D is formed during the press molding of the disc 82D. The passage in the notch 90D continuously connects the first passage 92 (second flow path) to the passage in the passage groove 366D. The inside of the passage groove 366D is the passage portion 144D (third flow path). The disc 83D has the same outer diameter as the disc 82D and no notch is formed as in the disc 82D. The disc S and the plurality of discs 84D have outer diameters equivalent to the outer diameter of the valve seat portion 48 of the piston 21D. The disc S can be seated in the valve seat portion 48. The disc S has a notch on the outer circumference side that continuously connects the passage in the plurality of passage holes 38 and the annular groove 55 to the lower chamber 23 even if it is seated in the valve seat portion 48. The passage in this notch is a fixed orifice. The disc 85D has an outer diameter smaller than the outer diameter of the disc 84D. The disc 86D has an outer diameter smaller than the outer diameter of the disc 85D. The disc 87D has an outer diameter smaller than the outer diameter of the disc 86D. The disc 88D has an outer diameter smaller than the outer diameter of the disc 87D. The disc 89D has an outer diameter larger than the outer diameter of the disc 88D. The annular member 114D has an outer diameter smaller than the outer diameter of the disc 89D. The annular member 114D is in contact with the nut 119D.

The disc S, the plurality of discs 84D, the plurality of discs 85D, the plurality of discs 86D, and the plurality of discs 87D constitute the main valve 91D on the extension side that can be detachably seated in the valve seat portion 48. The main valve 91D is seated away from the valve seat portion 48 and connects the first passage 92 to the lower chamber 23. At this time, the main valve 91D generates a damping force by suppressing the flow of the oil liquid L with the valve seat portion 48.

The piston 21D has a passage portion 144D and a passage portion 145D with the fitting shaft portion 32D of the piston rod 25D. The piston 21D defines the passage portion 144D and the passage portion 145D with the piston rod 25D.

An O-ring 108D is arranged between the large diameter hole 46D of the piston 21D and the fitting shaft portion 32D of the piston rod 25D. The O-ring 108D is an annular part having elasticity such as rubber. In a state in which the O-ring 108D has an overall annular shape before being assembled to the piston 21D, a cross-section becomes a circle when the cross-section is taken along a plane including the central axis of the annular ring. The O-ring 108D is in contact with the inner circumferential surface of the large diameter hole 46D of the piston 21D and the outer circumferential surface of the fitting shaft portion 32D of the piston rod 25D and continuously seals the gap therebetween.

An axial length of the large diameter hole 46D, i.e., a distance between the wall surfaces of the sidewall portion 46Db at both axial ends of the large diameter hole 46D, is longer than an axial length of the O-ring 108D arranged in the large diameter hole 46D. Therefore, the O-ring 108D can be moved in the axial direction of the large diameter hole 46D in the large diameter hole 46D. During this movement, the O-ring 108D slides between the inner circumferential surface of the large diameter hole 46D and the outer circumferential surface of the fitting shaft portion 32D. The O-ring 108D divides the inside of the large diameter hole 46D into a pressure storage chamber 147D (third chamber) and a pressure storage chamber 148D (fourth chamber).

The pressure storage chamber 147D is provided on the hole 361D side having a smaller diameter than the O-ring 108D of the large diameter hole 46D in the axial direction of the piston 21D. The pressure storage chamber 147D is continuously connected to the passage portion 144D.

The pressure storage chamber 148D is provided on the small diameter hole 45D side of the large diameter hole 46D in the axial direction of the piston 21D. The pressure storage chamber 148D is continuously connected to the passage portion 145D. A connection between the pressure storage chamber 147D and the pressure storage chamber 148D is continuously blocked by the O-ring 108D.

The passage portion 144D is connected to the pressure storage chamber 147D that is one of the pressure storage chamber 147D and the pressure storage chamber 148D. The passage portion 145D is connected to the pressure storage chamber 148D that is the other of the pressure storage chamber 147D and the pressure storage chamber 148D. The piston 21D has the passage portion 144D that connects the first passage 92 to the pressure storage chamber 147D via a passage in the notch 90D. The piston 21D has the passage portion 145D that connects the first passage 72 to the pressure storage chamber 148D via a passage in the notch 371D.

The inner circumferential portion of the large diameter hole 46D of the piston 21D and the outer circumferential portion of the fitting shaft portion 32D of the piston rod 25D constitute the outer shell portion 150D. In other words, the outer shell portion 150D is formed by an inner circumferential portion on the piston rod 25D side in the radial direction of the piston 21D and an outer circumferential portion of the piston rod 25D. The outer shell portion 150D constitutes the outer shell of the pressure storage chamber 147D and the pressure storage chamber 148D. The outer shell portion 150D accommodates the O-ring 108D. The O-ring 108D divides the inside of the outer shell portion 150D into the pressure storage chamber 147D and the pressure storage chamber 148D.

The pressure storage chamber 147D is continuously connected to the upper chamber 22 via the passage portion 144D, the passage in the notch 90D, and the passage in the annular groove 55 of the piston 21D and the plurality of passage holes 38.

The pressure storage chamber 148D is continuously connected to the lower chamber 23 via the passage portion 145D, the passage in the notch 371D, and the passage in the annular groove 56 of the piston 21D and the plurality of passage holes 39.

The volumes of the pressure storage chamber 147D and the pressure storage chamber 148D change when the O-ring 108D moves or deforms in the axial direction in the large diameter hole 46D. That is, the O-ring 108D, the pressure storage chamber 147D, the pressure storage chamber 148D, and the outer shell portion 150D constitute a pressure storage portion 151D provided so that the volume can be changed. The volume of the pressure storage chamber 147D increases to allow the inflow of the oil liquid L from the upper chamber 22. At this time, the volume of the pressure storage chamber 148D decreases and the pressure storage chamber 148D discharges the oil liquid L to the lower chamber 23 side. The volume of the pressure storage chamber 148D increases to allow the inflow of oil liquid L from the lower chamber 23. At this time, the volume of the pressure storage chamber 147D decreases and the pressure storage chamber 147D discharges the oil liquid L to the upper chamber 22 side.

The piston 21D includes the first passage 72, the first passage 92, the passage portions 144D and 145D, and the pressure storage chambers 147D and 148D.

The O-ring 108D and the pressure storage chamber 148D constitute a lower-chamber-side volume variable mechanism 185D that changes the volume of the lower chamber 23 side by changing the volume of the pressure storage chamber 148D. The lower-chamber-side volume variable mechanism 185D is connected to the passage portion 145D on the compression side.

The lower-chamber-side volume variable mechanism 185D makes a change to increase the volume of the pressure storage chamber 148D when the O-ring 108D is moved in proximity to the small diameter hole 361D in the axial direction of the piston 21D or crushed in contact with the wall surface of the sidewall portion 46Db on the small diameter hole 361D side in the axial direction of the large diameter hole 46D. At this time, the O-ring 108D maintains a state in which the pressure storage chamber 148D and the pressure storage chamber 147D are blocked.

Moreover, the lower-chamber-side volume variable mechanism 185D makes a change to decrease the volume of the pressure storage chamber 148D when the O-ring 108D is moved away from the small diameter hole 361D in the axial direction of the piston 21D or crushed in contact with the wall surface of the sidewall portion 46Db opposite to the small diameter hole 361D side in the axial direction of the large diameter hole 46D. At this time, the O-ring 108D also maintains a state in which the pressure storage chamber 148D and the pressure storage chamber 147D are blocked.

The O-ring 108D and the pressure storage chamber 147D constitute an upper-chamber-side volume variable mechanism 186D. The upper-chamber-side volume variable mechanism 186D changes the volume of the upper chamber 22 side by changing the volume of the pressure storage chamber 147D. The upper-chamber-side volume variable mechanism 186D is connected to the passage portion 144D on the extension side.

The upper-chamber-side volume variable mechanism 186D makes a change to increase the volume of the pressure storage chamber 147D when the O-ring 108D is moved in proximity to the small diameter hole 45D in the axial direction of the piston 21D or crushed in contact with the wall surface of the sidewall portion 46Db on the small diameter hole 45D side in the axial direction of the large diameter hole 46D. At this time, the O-ring 108D maintains a state in which the pressure storage chamber 147D and the pressure storage chamber 148D are blocked.

Moreover, the upper-chamber-side volume variable mechanism 186D makes a change to decrease the volume of the pressure storage chamber 147D when the O-ring 108D is moved away from the small diameter hole 45D in the axial direction of the piston 21D or crushed in contact with the wall surface of the sidewall portion 46Db opposite to the small diameter hole 45D in the axial direction of the large diameter hole 46D. At this time, the O-ring 108D also maintains a state in which the pressure storage chamber 147D and the pressure storage chamber 148D are blocked.

The O-ring 108D is shared by the lower-chamber-side volume variable mechanism 185D and the upper-chamber-side volume variable mechanism 186D. The lower-chamber-side volume variable mechanism 185D including the pressure storage chamber 148D and the upper-chamber-side volume variable mechanism 186D including the pressure storage chamber 147D are provided in the pressure storage portion 151D for storing the oil liquid L as the working fluid.

### <Operation>

In the extension stroke of the shock absorber 2D, the piston 21D moves to the upper chamber 22 side, and therefore the pressure of the upper chamber 22 increases and the pressure of the lower chamber 23 decreases. Here, in the first damping force generation mechanisms 41D and 42D, a fixed orifice that continuously connects the upper chamber 22 and the lower chamber 23 with the disc S is formed. Therefore, the oil liquid L of the upper chamber 22 flows into the lower chamber 23 via the fixed orifice. Together with this, the oil liquid L of the upper chamber 22 flows into the pressure storage chamber 147D via a passage in the plurality of passage holes 38 of the piston 21D and the annular groove 55, a passage in the notch 90D, and the passage portion 144D. In other words, the oil liquid L of the upper chamber 22 flows into the pressure storage chamber 147D via the first passage 92, the passage in the notch 90D branching from the first passage 92, and the passage portion 144D. Thereby, the pressure of the pressure storage chamber 147D is increased. For this reason, in the upper-chamber-side volume variable mechanism 186D, the O-ring 108D is moved to the small diameter hole 45D side or crushed in contact with the wall surface of the sidewall portion 46Db on the small diameter hole 45D side of the large diameter hole 46D before the first damping force generation mechanism 41 opens the valve. Then, the O-ring 108D increases the capacity of the pressure storage chamber 147D. Thereby, the upper-chamber-side volume variable mechanism 186D suppresses the increase in the pressure of the pressure storage chamber 147D. At this time, the lower-chamber-side volume variable mechanism 185D including the O-ring 108D decreases the volume of the pressure storage chamber 148D. Also, because a flow path area of the passage in the notch 90D is larger than a flow path area of the fixed orifice of the disc S, the oil liquid L of the upper chamber 22 actively flows into the pressure storage chamber 147D.

Here, in the extension stroke at the time of low-frequency input (at the time of large amplitude excitation) of the shock absorber 2D, an amount of oil liquid L flowing from the upper chamber 22 to the pressure storage chamber 147D as described above is large. For this reason, the O-ring 108D is moved to a limit at the initial stage of the extension stroke and crushed to the limit. Then, thereafter, the O-ring 108D does not move or deform. As a result, the capacity of the pressure storage chamber 147D does not increase.

At this time, when the piston speed is less than an eleventh predetermined value at which the first damping force generation mechanism 41D opens the valve, the oil liquid L flows from the upper chamber 22 to the lower chamber 23 via a fixed orifice of the disc S of the first damping force generation mechanisms 41D and 42D. Therefore, a damping force of the orifice characteristic (in which the damping force is substantially proportional to the square of the piston speed) is generated. For this reason, in the extension stroke in which the piston speed is less than the eleventh predetermined value at which the first damping force generation mechanism 41D opens the valve, the damping force rises rapidly. Moreover, in a region where the piston speed is greater than or equal to the eleventh predetermined value, the first damping force generation mechanism 41D opens the valve. That is, a pressure applied to the main valve 91D increases, a differential pressure increases, the main valve 91D is seated away from the valve seat portion 48, and the oil liquid L flows from the upper chamber 22 to the lower chamber 23 in the first passage 92 on the extension side. Therefore, the oil liquid L of the upper chamber 22 flows into the lower chamber 23 via the passage in the plurality of passage holes 38 and the annular groove 55 and the passage between the main valve 91D and the valve seat portion 48. That is, the oil liquid L of the upper chamber 22 flows into the lower chamber 23 via the first passage 92. Thereby, in the normal speed region where the piston speed is greater than or equal to the eleventh predetermined value, a damping force of the valve characteristic (in which the damping force is substantially proportional to the piston speed) is obtained.

In the extension stroke at the time of high-frequency input (at the time of small amplitude excitation) in which a frequency higher than the low-frequency input described above is input to the shock absorber 2D, an amount of oil liquid L flowing from the upper chamber 22 to the pressure storage chamber 147D is small. For this reason, the sliding and deformation of the O-ring 108D are small. As a result, the upper-chamber-side volume variable mechanism 186D can absorb the volume of the inflow of the oil liquid L into the pressure storage chamber 147D by sliding and deforming the O-ring 108D. For this reason, the damping force in the orifice region where the oil liquid L flows through the fixed orifice with the disc S of the first damping force generation mechanisms 41D and 42D can be reduced.

Therefore, in the extension stroke at the time of high-frequency input, the rise of the extremely low-speed damping force is gradual at the time of low-frequency input or with respect to the conventional damping force characteristic.

Thus, by making the orifice range variable, overdamping at the time of high-frequency input can be suppressed.

Here, in the extension stroke of the shock absorber 2D, the characteristics are also combined with the damping force characteristics due to the damping force generation mechanism 256.

In the compression stroke of the shock absorber 2D, the piston 21D moves to the lower chamber 23 side, and therefore the pressure of the lower chamber 23 increases and the pressure of the upper chamber 22 decreases. Here, in the first damping force generation mechanisms 41D and 42D, the fixed orifice that continuously connects the upper chamber 22 and the lower chamber 23 with the disc S is formed. Therefore, the oil liquid L of the lower chamber 23 flows into the upper chamber 22 via the fixed orifice. Together with this, the oil liquid L of the lower chamber 23 flows into the pressure storage chamber 148D via the first passage 72, the passage in the notch 371D, and the passage portion 145D. Thereby, the pressure of the pressure storage chamber 148D is increased. For this reason, in the lower-chamber-side volume variable mechanism 185D, the O-ring 108D is moved to the small diameter hole 361D side or crushed in contact with the wall surface of the sidewall portion 46Db on the small diameter hole 361D of the large diameter hole 46D before the first damping force generation mechanism 42D opens the valve. Then, the O-ring 108D increases the capacity of the pressure storage chamber 148D. Thereby, the lower-chamber-side volume variable mechanism 185D suppresses the increase in the pressure of the pressure storage chamber 148D. At this time, the upper-chamber-side volume variable mechanism 186D including the O-ring 108D decreases the volume of the pressure storage chamber 147D. Because the flow path area of the passage in the notch 371D is larger than the flow path area of the fixed orifice by the disc S, the oil liquid L of the lower chamber 23 actively flows into the pressure storage chamber 148D.

Here, in the compression stroke at the time of low-frequency input (at the time of large amplitude excitation) of the shock absorber 2D, an amount of oil liquid L flowing from the lower chamber 23 to the pressure storage chamber 148D as described above is large. For this reason, the O-ring 108D is moved to a limit at the initial stage of the compression stroke and crushed to the limit. Then, thereafter, the O-ring 108D does not move or deform. Thereby, the capacity of the pressure storage chamber 148D does not increase.

At this time, when the piston speed is less than a twelfth predetermined value at which the first damping force generation mechanism 42 opens the valve, the oil liquid L flows from the lower chamber 23 to the upper chamber 22 via a fixed orifice with the disc S of the first damping force generation mechanisms 41D and 42D. Therefore, a damping force of the orifice characteristic (in which the damping force is substantially proportional to the square of the piston speed) is generated. For this reason, the damping force rises rapidly in the compression stroke in which the piston speed is less than the twelfth predetermined value at which the first damping force generation mechanism 42 opens the valve. Moreover, in a region where the piston speed is high from the twelfth predetermined value, the first damping force generation mechanism 42D opens the valve. That is, the pressure applied to the main valve 71D increases, the differential pressure increases, the main valve 71D is seated away from the valve seat portion 50, and the oil liquid L flows from the lower chamber 23 to the upper chamber 22 in the first passage 72 on the compression side. Therefore, the oil liquid L of the lower chamber 23 flows into the upper chamber 22 through the passage in the plurality of passage holes 39 and the annular groove 56 and the passage between the main valve 71D and the valve seat portion 50. That is, the oil liquid L of the lower chamber 23 flows into the upper chamber 22 via the first passage 72. Thereby, in the normal speed region where the piston speed is greater than or equal to the twelfth predetermined value, a damping force of the valve characteristic (in which the damping force is substantially proportional to the piston speed) is obtained.

In the compression stroke at the time of high-frequency input (at the time of small amplitude excitation) in which a frequency higher than the low-frequency input described above is input to the shock absorber 2D, an amount of oil liquid L flowing from the lower chamber 23 to the pressure storage chamber 148D is small. For this reason, the sliding and deformation of the O-ring 108D are small. As a result, the lower-chamber-side volume variable mechanism 185D can absorb the volume of the inflow of oil liquid L into the pressure storage chamber 148D by sliding and deforming the O-ring 108D. For this reason, the damping force in the orifice region where the oil liquid L flows through the fixed orifice with the disc S of the first damping force generation mechanisms 41D and 42D can be reduced.

Therefore, in the compression stroke at the time of high-frequency input, the rise of the extremely low-speed damping force is gradual at the time of low-frequency input or with respect to the conventional damping force characteristics.

Thus, by making the orifice range variable, overdamping at the time of high-frequency input can be suppressed.

Here, in the compression stroke of the shock absorber 2D, the characteristics are also combined with the damping force characteristics due to the damping force generation mechanism 255.

In the damping force generation device 1D of the fifth embodiment, the piston 21D configured to divide the cylinder 5D into the upper chamber 22 and the lower chamber 23 includes the first passage 92 connecting the upper chamber 22 and the lower chamber 23 and the first passage 72 provided at least partially parallel to the first passage 92 and connecting the upper chamber 22 and the lower chamber 23. Also, the passage portion 144D branching from the first passage 92 and connected to the pressure storage portion 151D is provided in the piston 21D. Because a function of the pressure storage portion 151D is similar to that of the pressure storage portion 151, the effect of the damping force generation device 1D is similar to the effect of the damping force generation device 1.

Moreover, in the damping force generation device 1D, because the outer shell portion 150D is provided between the piston 21D and the fitting shaft portion 32D of the piston rod 25D inserted into the piston 21D, a dedicate part for forming the outer shell portion 150D is unnecessary and the number of parts can be reduced.

Moreover, the damping force generation device 1D can improve the deterioration of ride comfort due to overdamping.

### Sixth Embodiment

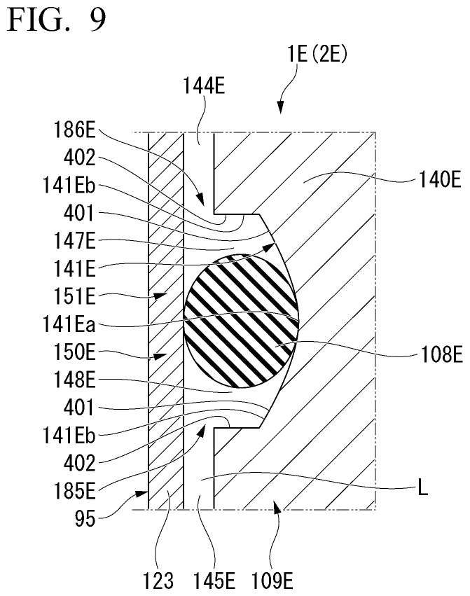

Next, a sixth embodiment will be described mainly on the basis of the differences from the first embodiment on the basis of FIG. 9. Also, parts identical to those of the first embodiment are represented by the same designation and the same reference numerals.

### <Configuration>

As shown in FIG. 9, a damping force generation device 1E of the sixth embodiment is partially different from the damping force generation device 1. A shock absorber 2E is different from the shock absorber 2 in that it has a damping force generation device 1E instead of the damping force generation device 1. The damping force generation device 1E has a valve seat member 109E partially different from the valve seat member 109 instead of the valve seat member 109.

The valve seat member 109E has a main body portion 140E partially different from the main body portion 140 instead of the main body portion 140. In the main body portion 140E, a seal groove 141E (concave portion) is formed at an intermediate position in the axial direction of its outer circumferential portion instead of the seal groove 141. The seal groove 141E is annular and concave radially inward from the outer circumferential surface of the main body portion 140E. The seal groove 141E has a bottom portion 141Ea arranged on a radially inward side of the valve seat member 109E and a pair of sidewall portions 141Eb arranged on both axial sides of the valve seat member 109E. The seal groove 141E is mirror-symmetric in the axial direction of the valve seat member 109E.

The bottom portion 141Ea has a curved groove bottom surface facing outward in the radial direction of the valve seat member 109E. The groove bottom surface of the bottom portion 141Ea has an arc-shaped cross-section shape on a surface including the central axis of the valve seat member 109E. The bottom portion 141Ea has a smallest outer diameter at the central position in the axial direction of the valve seat member 109E. The outer diameter of the bottom portion 141Ea increases as a distance from its central position in the axial direction of the valve seat member 109E increases.

A pair of sidewall portions 141Eb are mirror-symmetric in the axial direction of the valve seat member 109E. Either one of the pair of sidewall portions 141Eb has an inclined portion 401 and a flat portion 402.

The inclined portion 401 of one sidewall portion 141Eb of the pair of sidewall portions 141Eb extends from one end of the bottom portion 141Ea in the axial direction of the valve seat member 109E so that a distance from the bottom portion 141Ea in the axial direction of the valve seat member 109E increases. The inclined portion 401 of the other sidewall portion 141Eb of the pair of sidewall portions 141Eb extends from the other end of the bottom portion 141Ea in the axial direction of the valve seat member 109E so that a distance from the bottom portion 141Ea in the axial direction of the valve seat member 109E increases.

A pair of inclined portions 401 of the pair of sidewall portions 141Eb face outward in the radial direction of the valve seat member 109E and wall surfaces facing each other in the axial direction of the valve seat member 109E are tapered. Therefore, either one of the pair of sidewall portions 141Eb has the inclined portion 401 inclined with respect to the axial direction of the valve seat member 109E.

The inclined portion 401 has a smallest outer diameter at the end of the bottom portion 141Ea side in the axial direction of the valve seat member 109E. The inclined portion 401 has a large outer diameter as a distance from the bottom portion 141Ea in the axial direction of the valve seat member 109E increases. The inclined portion 401 extends in a tangential direction of an end from the end to which the inclined portion 401 of the bottom portion 141Ea is connected.

The flat portion 402 of one sidewall portion 141Eb of the pair of sidewall portions 141Eb extends in a radially outward direction of the valve seat member 109E from an end of the opposite side of the bottom portion 141Ea of the inclined portion 401 of one sidewall portion 141Eb in the axial direction of the valve seat member 109E. The flat portion 402 of the other sidewall portion 141Eb of the pair of sidewall portions 141Eb extends in a radially outward direction of the valve seat member 109E from an end of the opposite side of the bottom portion 141Ea of the inclined portion 401 of the other sidewall portion 141Eb in the axial direction of the valve seat member 109E. A pair of flat portions 402 of a pair of sidewall portions 141Eb form a planar shape in which wall surfaces facing each other in the axial direction of the valve seat member 109E extend perpendicular to the axial direction of the valve seat member 109E.

An O-ring 108E (elastic member) similar to the O-ring 108 of the first embodiment is arranged in the seal groove 141E. In other words, the O-ring 108E is arranged in the seal groove 141E provided in the valve seat member 109E. The O-ring 108E is in contact with the inner circumferential surface of the tubular portion 123 of the case member 95, the groove bottom surface of the bottom portion 141Ea of the seal groove 141E of the valve seat member 109E, or the wall surface of the inclined portion 401 of the sidewall portion 141Eb to continuously seal a gap therebetween.

In a gap between an outer circumferential surface of a portion other than the seal groove 141E of the main body portion 140E of the valve seat member 109E and the inner circumferential surface of the tubular portion 123 of the case member 95, a portion of the bottom portion 122 (see FIG. 3) side of the seal groove 141E in the axial direction of the valve seat member 109E becomes the passage portion 144E similar to the passage portion 144 of the first embodiment. Moreover, in this gap, a portion opposite to the bottom portion 122 (see FIG. 3) of the seal groove 141E in the axial direction of the valve seat member 109E becomes the passage portion 145E similar to the passage portion 145 of the first embodiment. Therefore, the valve seat member 109E has the passage portion 144E and the passage portion 145E with the case member 95. The valve seat member 109E defines the passage portion 144E and the passage portion 145E with the case member 95.

An axial width of the seal groove 141E, i.e., a distance between wall surfaces of a pair of flat portions 402 at both axial ends of the seal groove 141E, is longer than an axial length of the O-ring 108E in a state in which the groove bottom surface of the bottom portion 141Ea of the seal groove 141E arranged in the seal groove 141E is in contact with the inner circumferential surface of the tubular portion 123. Therefore, the O-ring 108E can be moved in the axial direction of the seal groove 141E in the seal groove 141E. During this movement, the O-ring 108E rolls so that the outer circumferential portion moves forward in the movement direction of the O-ring 108E and the inner circumferential portion moves backward in the movement direction of the O-ring 108E or slides on the wall surface of the inclined portion 401 of the sidewall portion 141Eb of the seal groove 141E and the inner circumferential surface of the tubular portion 123.

The O-ring 108E divides the inside of the seal groove 141E into a pressure storage chamber 147E similar to the pressure storage chamber 147 and a pressure storage chamber 148E similar to the pressure storage chamber 148. Therefore, the case member 95 and the valve seat member 109E have the passage portion 144E that connects the case chamber 142 (see FIG. 3) to the pressure storage chamber 147E. The case member 95 and the valve seat member 109E have the passage portion 145E that connects the lower chamber 23 (see FIG. 3) to the pressure storage chamber 148E.

The inner circumferential portion of the tubular portion 123 of the case member 95 and the outer circumferential portion including the seal groove 141E of the main body portion 140E of the valve seat member 109E constitute the outer shell portion 150E. In other words, the outer shell portion 150E is formed by an outer circumferential portion opposite to the piston rod 25 (see FIG. 3) in the radial direction of the valve seat member 109E and an inner circumferential portion of the tubular portion 123 of the case member 95. The outer shell portion 150E constitutes the outer shell of the pressure storage chamber 147E and the pressure storage chamber 148E. The outer shell portion 150E accommodates the O-ring 108E. The O-ring 108E divides the inside of the outer shell portion 150E into the pressure storage chamber 147E and the pressure storage chamber 148E.

The volumes of the pressure storage chamber 147E and the pressure storage chamber 148E change as the O-ring 108E moves or deforms in the axial direction in the seal groove 141E. That is, the O-ring 108E, the pressure storage chamber 147E, the pressure storage chamber 148E, and the outer shell portion 150E constitute the pressure storage portion 151E provided so that the volume can be changed.

The O-ring 108E and the pressure storage chamber 148E constitute a lower-chamber-side volume variable mechanism 185E similar to the lower-chamber-side volume variable mechanism 185.

The lower-chamber-side volume variable mechanism 185E makes a change to increase the volume of the pressure storage chamber 148E when the O-ring 108E is moved in proximity to the bottom portion 122 (see FIG. 3) in the axial direction of the valve seat member 109E or crushed in contact with the wall surface of the flat portion 402 of the sidewall portion 141Eb on the bottom portion 122 (see FIG. 3) side in the axial direction of the seal groove 141E. At this time, the O-ring 108E maintains a state in which the pressure storage chamber 148E and the pressure storage chamber 147E are blocked.

Moreover, the lower-chamber-side volume variable mechanism 185E makes a change to decrease the volume of the pressure storage chamber 148E when the O-ring 108E is moved away from the bottom portion 122 (see FIG. 3) in the axial direction of the valve seat member 109E or crushed in contact with the wall surface of the flat portion 402 of the sidewall portion 141Eb on the opposite side of the bottom portion 122 (see FIG. 3) in the axial direction of the seal groove 141E. At this time, the O-ring 108E also maintains a state in which the pressure storage chamber 148E and the pressure storage chamber 147E are blocked.

The O-ring 108E and the pressure storage chamber 147E constitute an upper-chamber-side volume variable mechanism 186E similar to the upper-chamber-side volume variable mechanism 186.

The upper-chamber-side volume variable mechanism 186E makes a change to increase the volume of the pressure storage chamber 147E when the O-ring 108E is moved away from the bottom portion 122 (see FIG. 3) in the axial direction of the valve seat member 109E or crushed in contact with the wall surface of the flat portion 402 of the sidewall portion 141Eb on the opposite side of the bottom portion 122 (see FIG. 3) in the axial direction of the seal groove 141E. At this time, the O-ring 108E maintains a state in which the pressure storage chamber 147E and the pressure storage chamber 148E are blocked.

Moreover, the upper-chamber-side volume variable mechanism 186E makes a change to decrease the volume of the pressure storage chamber 147E when the O-ring 108E is moved in proximity to the bottom portion 122 (see FIG. 3) in the axial direction of the valve seat member 109E or crushed in contact with the wall surface of the flat portion 402 of the sidewall portion 141Eb of the bottom portion 122 (see FIG. 3) side in the axial direction of the seal groove 141E. At this time, the O-ring 108E maintains a state in which the pressure storage chamber 147E and the pressure storage chamber 148E are blocked.

The O-ring 108E is shared by the lower-chamber-side volume variable mechanism 185E and the upper-chamber-side volume variable mechanism 186E. The lower-chamber-side volume variable mechanism 185E including the pressure storage chamber 148E and the upper-chamber-side volume variable mechanism 186E including the pressure storage chamber 147E are provided in the pressure storage portion 151E for storing the oil liquid L as a working fluid.

### <Operation>

In the extension stroke of the shock absorber 2E, the piston 21 (see FIG. 2) moves to the upper chamber 22 (see FIG. 2) side, and therefore the pressure of the upper chamber 22 (see FIG. 2) increases and the pressure of the lower chamber 23 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the upper chamber 22 (see FIG. 2) and the lower chamber 23 (see FIG. 3). Thus, the oil liquid L of the upper chamber 22 (see FIG. 2) flows into the pressure storage chamber 147E via a passage in the plurality of passage holes 38 (see FIG. 2) of the piston 21 (see FIG. 2) and the annular groove 55 (see FIG. 2), the orifice 175 (see FIG. 2), a passage in the large diameter hole 46 (see FIG. 2) of the piston 21 (see FIG. 2), the piston rod passage portion 51 (see FIG. 2) of the piston rod 25 (see FIG. 3), a passage in the second hole 133 (see FIG. 2) of the valve seat member 109E, the radial passage 222 (see FIG. 2) of the valve seat member 109E, the case chamber 142 (see FIG. 3), and the passage portion 144E shown in FIG. 9. Thereby, the pressure of the pressure storage chamber 147E is increased. For this reason, in the upper-chamber-side volume variable mechanism 186E, the O-ring 108E is moved to the opposite side of the bottom portion 122 (see FIG. 3) in the seal groove 141E or crushed in contact with the wall surface of the flat portion 402 of the sidewall portion 141Eb opposite to the bottom portion 122 (see FIG. 3) of the seal groove 141E before the second damping force generation mechanism 183 (see FIG. 2) opens the valve. Then, the O-ring 108E increases the capacity of the pressure storage chamber 147E. Thereby, the upper-chamber-side volume variable mechanism 186E suppresses the increase in the pressure of the pressure storage chamber 147E. At this time, the lower-chamber-side volume variable mechanism 185E including the O-ring 108E decreases the volume of the pressure storage chamber 148E.

At the time of movement to the opposite side of the bottom portion 122 (see FIG. 3) in the extension stroke, the O-ring 108E rolls and runs on the wall surface of the inclined portion 401 of the sidewall portion 141Eb opposite to the bottom portion 122 (see FIG. 3) from the groove bottom surface of the bottom portion 141Ea shown in FIG. 9. At this time, as the O-ring 108E approaches the wall surface of the flat portion 402 of the sidewall portion 141Eb, the radial amount of compression increases and the resistance to movement increases. Also, the O-ring 108E is compressively deformed in the axial direction in contact with the wall surface of the flat portion 402 of the sidewall portion 141Eb. Therefore, the extremely low-speed damping force of the extension stroke gradually rises and gradually increases.

In the compression stroke of the shock absorber 2E, the piston 21 (see FIG. 2) moves to the lower chamber 23 (see FIG. 3) side, and therefore the pressure of the lower chamber 23 (see FIG. 3) increases and the pressure of the upper chamber 22 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the lower chamber 23 (see FIG. 2) and the upper chamber 22 (see FIG. 2). Therefore, the oil liquid L of the lower chamber 23 (see FIG. 2) flows into the pressure storage chamber 148E via the passage portion 145E between the case member 95 and the valve seat member 109E shown in FIG. 9.

Thereby, the pressure of the pressure storage chamber 148E is increased. For this reason, in the lower-chamber-side volume variable mechanism 185E, the O-ring 108E is moved to the bottom portion 122 (see FIG. 3) side or crushed in contact with the wall surface of the flat portion 402 of the sidewall portion 141Eb on the bottom portion 122 (see FIG. 3) side of the seal groove 141E before the second damping force generation mechanism 173 (see FIG. 2) opens the valve. Then, the O-ring 108E increases the capacity of the pressure storage chamber 148E. Thereby, the lower-chamber-side volume variable mechanism 185E suppresses the increase in pressure of the pressure storage chamber 148E. At this time, the upper-chamber-side volume variable mechanism 186E including the O-ring 108E decreases the volume of the pressure storage chamber 147E.

At the time of movement to the bottom portion 122 (see FIG. 3) side in the compression stroke, the O-ring 108E rolls and runs on the wall surface of the inclined portion 401 of the sidewall portion 141Eb on the bottom portion 122 (see FIG. 3) side from the groove bottom surface of the bottom portion 141Ea. At this time, as the O-ring 108E approaches the wall surface of the flat portion 402 of the sidewall portion 141Eb, the radial amount of compression increases and the resistance to movement increases. Also, the O-ring 108E is compressively deformed in the axial direction in contact with the wall surface of the flat portion 402 of the sidewall portion 141Eb. Therefore, the extremely low-speed damping force of the compression stroke gradually rises and gradually increases.

The damping force generation device 1E of the sixth embodiment has the valve seat member 109E shown in FIG. 9 provided at least partially parallel to the first passage 92 (see FIG. 2) and having the second passage 182 (see FIG. 2) that connects the upper chamber 22 (see FIG. 2) and the lower chamber 23 (see FIG. 2). Also, the passage portion 144E branching from the second passage 182 (see FIG. 2) in a direction from the upper chamber 22 (see FIG. 2) to the second damping force generation mechanism 183 (see FIG. 2) and connected to the pressure storage portion 151E is provided in the valve seat member 109E. Because a function of the pressure storage portion 151E is similar to that of the pressure storage portion 151, the effect of the damping force generation device 1E is similar to that of the damping force generation device 1.

Moreover, the damping force generation device 1E has an inclined portion 401 in which the sidewall portion 141Eb is inclined with respect to the axial direction of the valve seat member 109E. Therefore, the damping force generation device 1E can gradually change the movement resistance of the O-ring 108E in the pressure storage portion 151E. Therefore, the change in the damping force during movement of the O-ring 108E can be facilitated. Moreover, a rate of change in the damping force can be easily changed by adjusting the angle of the inclined portion 401 with respect to the axial direction of the valve seat member 109E.

Moreover, the damping force generation device 1E has the inclined portion 401 in which each of a pair of sidewall portions 141Eb is inclined with respect to the axial direction of the valve seat member 109E. Therefore, the damping force generation device 1E can gradually change the movement resistance of the O-ring 108E in the pressure storage portion 151E in both the extension stroke and the compression stroke.

Also, the shape of the seal groove 141E of the sixth embodiment can be applied to the shape of the seal groove 141A, which is the concave portion of the second embodiment, the shape of the seal groove 141B, which is the concave portion of the third embodiment, or the shape of the large diameter hole 46D, which is the concave portion of the fifth embodiment. When the shape of the seal groove 141E is applied to the shape of the seal groove 141A, which is the concave portion of the second embodiment, the bottom portion 141Ea is arranged on a radially outward side of the valve seat member 109A.

### Seventh Embodiment

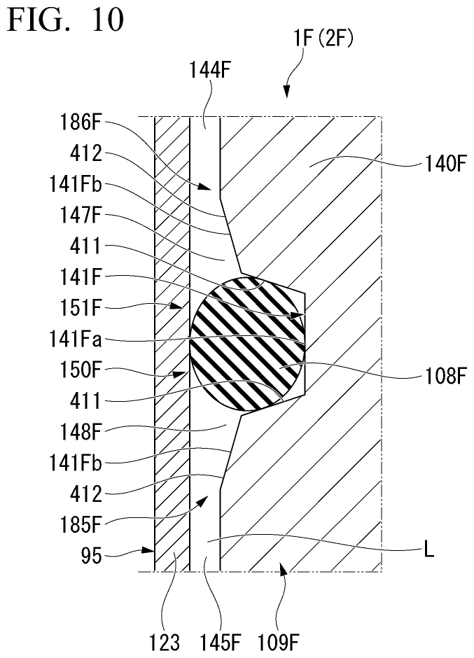

Next, a seventh embodiment will be described mainly on the basis of the differences from the first embodiment on the basis of FIG. 10. Also, parts identical to those of the first embodiment are represented by the same designation and the same reference numerals.

### <Configuration>

As shown in FIG. 10, a damping force generation device 1F of the seventh embodiment is partially different from the damping force generation device 1. A shock absorber 2F is different from the shock absorber 2 in that it has a damping force generation device 1F instead of the damping force generation device 1. The damping force generation device 1F has a valve seat member 109F partially different from the valve seat member 109 instead of the valve seat member 109.

The valve seat member 109F has a main body portion 140F partially different from the main body portion 140 instead of the main body portion 140. In the main body portion 140F, a seal groove 141F (concave portion) is formed at an intermediate position in the axial direction of the outer circumferential portion instead of the seal groove 141. The seal groove 141F is annular and concave radially inward from the outer circumferential surface of the main body portion 140F. The seal groove 141F has a bottom portion 141Fa arranged on a radially inward side of the valve seat member 109F and a pair of sidewall portions 141Fb arranged on both axial sides of the valve seat member 109F. The seal groove 141F is mirror-symmetric in the axial direction of the valve seat member 109F.

The bottom portion 141Fa has a cylindrical surface shape in which the groove bottom surface facing outward in the radial direction of the valve seat member 109F is in the axial direction of the valve seat member 109F.

A pair of sidewall portions 141Fb are mirror-symmetric in the axial direction of the valve seat member 109F. Either one of the pair of sidewall portions 141Fb has a first inclined portion 411 (inclined portion) and a second inclined portion 412 (inclined portion).

The first inclined portion 411 of one sidewall portion 141Fb of the pair of sidewall portions 141Fb extends in a radially outward direction of the valve seat member 109F from one end of the bottom portion 141Fa in the axial direction of the valve seat member 109F. The first inclined portion 411 of the other sidewall portion 141Fb of the pair of sidewall portions 141Fb extends in a radially outward direction of the valve seat member 109F from the other end of the bottom portion 141Fa in the axial direction of the valve seat member 109F.

The pair of first inclined portions 411 of the pair of sidewall portions 141Fb have a tapered wall surface facing each other in the axial direction of the valve seat member 109F. Therefore, either one of the pair of sidewall portions 141Fb has the first inclined portion 411 inclined with respect to the axial direction of the valve seat member 109F.

In the first inclined portion 411, the end of the bottom portion 141Fa side in the axial direction of the valve seat member 109F has a smallest outer diameter. The outer diameter of the first inclined portion 411 increases as a distance from the bottom portion 141Fa in the axial direction of the valve seat member 109F from an end thereof increases.

In one sidewall portion 141Fb of the pair of sidewall portions 141Fb, the second inclined portion 412 extends from the end of the opposite side of the bottom portion 141Fa of the first inclined portion 411 in the radial direction of the valve seat member 109F so that a distance from the bottom portion 141Fa in the axial direction of the valve seat member 109F increases. In the other sidewall portion 141Fb of the pair of sidewall portions 141Fb, the second inclined portion 412 extends from the end of the opposite side of the bottom portion 141Fa of the first inclined portion 411 in the radial direction of the valve seat member 109F so that a distance from the bottom portion 141Fa in the axial direction of the valve seat member 109F increases.

Either one of the pair of second inclined portions 412 of the pair of sidewall portions 141Fb has a tapered wall surface facing outward in the radial direction of the valve seat member 109F. Therefore, either one of the pair of sidewall portions 141Fb has the second inclined portion 412 inclined with respect to the axial direction of the valve seat member 109F.

In the second inclined portion 412, the end of the bottom portion 141Fa side in the axial direction of the valve seat member 109F has a smallest outer diameter. The outer diameter of the second inclined portion 412 increases as a distance from the bottom portion 141Fa in the axial direction of the valve seat member 109F increases.

In the one sidewall portion 141Fb of the pair of sidewall portions 141Fb, the second inclined portion 412 has a smaller angle to the axial direction of the valve seat member 109F, i.e., a smaller angle formed with the central axis of the valve seat member 109F, than the first inclined portion 411. That is, in the one sidewall portion 141Fb, an angle formed between an extension line of the second inclined portion 412 and a portion on the second inclined portion 412 side of an intersection of the central axis of the valve seat member 109F with the extension line of the second inclined portion 412 is smaller than an angle formed between an extension line of the first inclined portion 411 and a portion on the first inclined portion 411 side of an intersection of the central axis of the valve seat member 109F with the extension line of the first inclined portion 411.

In the other sidewall portion 141Fb of the pair of sidewall portions 141Fb, the second inclined portion 412 has a smaller angle to the axial direction of the valve seat member 109F, i.e., a smaller angle formed with the central axis of the valve seat member 109F, than the first inclined portion 411. That is, in the other sidewall portion 141Fb, an angle formed between an extension line of the second inclined portion 412 and a portion on the second inclined portion 412 side of an intersection of the central axis of the valve seat member 109F with the extension line of the second inclined portion 412 is smaller than an angle formed between an extension line of the first inclined portion 411 and a portion on the first inclined portion 411 side of an intersection of the central axis of the valve seat member 109F with the extension line of the first inclined portion 411.

An O-ring 108F (elastic member) similar to the O-ring 108 of the first embodiment is arranged in the seal groove 141F. In other words, the O-ring 108F is arranged in the seal groove 141F provided in the valve seat member 109F. The O-ring 108F is in contact with the inner circumferential surface of the tubular portion 123 of the case member 95 and the groove bottom surface of the bottom portion 141Fa of the seal groove 141F of the valve seat member 109F to continuously seal a gap therebetween.

In a gap between the outer circumferential surface of the portion other than the seal groove 141F of the main body portion 140F of the valve seat member 109F and the inner circumferential surface of the tubular portion 123 of the case member 95, a portion on the bottom portion 122 (see FIG. 3) side of the seal groove 141F in the axial direction of the valve seat member 109F becomes the passage portion 144F similar to that of the passage portion 144 of the first embodiment. Moreover, in this gap, a portion opposite to the bottom portion 122 (see FIG. 3) of the seal groove 141F in the axial direction of the valve seat member 109F becomes the passage portion 145F similar to the passage portion 145 of the first embodiment. Therefore, the valve seat member 109F has the passage portion 144F and the passage portion 145F with the case member 95. The valve seat member 109F defines the passage portion 144F and the passage portion 145F with the case member 95.

A distance between the wall surfaces of the pair of first inclined portions 411 of the seal groove 141F is substantially equivalent to an axial length of the O-ring 108F, which is arranged in the seal groove 141F and is in contact with the groove bottom surface of the bottom portion 141Fa of the seal groove 141F and the inner circumferential surface of the tubular portion 123. Therefore, the O-ring 108F does not substantially roll in the seal groove 141F and is compressively deformed.

The O-ring 108F divides the inside of the seal groove 141F into a pressure storage chamber 147F similar to the pressure storage chamber 147 and a pressure storage chamber 148F similar to the pressure storage chamber 148. Therefore, the case member 95 and the valve seat member 109F have the passage portion 144F that connects the case chamber 142 (see FIG. 3) to the pressure storage chamber 147F. The case member 95 and the valve seat member 109F have the passage portion 145F that connects the lower chamber 23 (see FIG. 3) to the pressure storage chamber 148F.

An inner circumferential portion of the tubular portion 123 of the case member 95 and an outer circumferential portion including the seal groove 141F of the main body portion 140F of the valve seat member 109F constitute the outer shell portion 150F. In other words, the outer shell portion 150F is formed by an outer circumferential portion opposite to the piston rod 25 (see FIG. 3) in the radial direction of the valve seat member 109F and an inner circumferential portion of the tubular portion 123 of the case member 95. The outer shell portion 150F constitutes the outer shell of the pressure storage chamber 147F and the pressure storage chamber 148E The outer shell portion 150F accommodates the O-ring 108E The O-ring 108F divides the inside of the outer shell portion 150F into the pressure storage chamber 147F and the pressure storage chamber 148F.

The volumes of the pressure storage chamber 147F and the pressure storage chamber 148F change due to the deformation of the O-ring 108F mainly in the axial direction in the seal groove 141F. That is, the O-ring 108F, the pressure storage chamber 147F, the pressure storage chamber 148F, and the outer shell portion 150F constitute the pressure storage portion 151F provided so that the volume can be changed.

The O-ring 108F and the pressure storage chamber 148F constitute a lower-chamber-side volume variable mechanism 185F similar to the lower-chamber-side volume variable mechanism 185.

The lower-chamber-side volume variable mechanism 185F makes a change to increase the volume of the pressure storage chamber 148F when the O-ring 108F is crushed in contact with the wall surface of the sidewall portion 141Fb on the bottom portion 122 (see FIG. 3) side in the axial direction of the seal groove 141F. At this time, the O-ring 108F maintains a state in which the pressure storage chamber 148F and the pressure storage chamber 147F are blocked.

Moreover, the lower-chamber-side volume variable mechanism 185F makes a change to decrease the volume of the pressure storage chamber 148F when the O-ring 108F is crushed in contact with the wall surface of the first inclined portion 411 of the first inclined portion 411 of the sidewall portion 141Fb on the opposite side of the bottom portion 122 (see FIG. 3) in the axial direction of the seal groove 141F. At this time, the O-ring 108F also maintains a state in which the pressure storage chamber 148F and the pressure storage chamber 147F are blocked.

The O-ring 108F and the pressure storage chamber 147F constitute an upper-chamber-side volume variable mechanism 186F similar to the upper-chamber-side volume variable mechanism 186.

The upper-chamber-side volume variable mechanism 186F makes a change to increase the volume of the pressure storage chamber 147F when the O-ring 108F is crushed in contact with the wall surface of the first inclined portion 411 of the sidewall portion 141Fb on the opposite side of the bottom portion 122 (see FIG. 3) in the axial direction of the seal groove 141F. At this time, the O-ring 108F maintains a state in which the pressure storage chamber 147F and the pressure storage chamber 148F are blocked.

Moreover, the upper-chamber-side volume variable mechanism 186F makes a change to decrease the volume of the pressure storage chamber 147F when the O-ring 108F is crushed in contact with the wall surface the first inclined portion 411 of the sidewall portion 141Fb of the bottom portion 122 (see FIG. 3) side in the axial direction of the seal groove 141F. At this time, the O-ring 108F also maintains a state in which the pressure storage chamber 147F and the pressure storage chamber 148F are blocked.

The O-ring 108F is shared by the lower-chamber-side volume variable mechanism 185F and the upper-chamber-side volume variable mechanism 186F. The lower-chamber-side volume variable mechanism 185F including the pressure storage chamber 148F and the upper-chamber-side volume variable mechanism 186F including the pressure storage chamber 147F are provided in the pressure storage portion 151F for storing the oil liquid L as a working fluid.

### <Operation>

In the extension stroke of the shock absorber 2F, the piston 21 (see FIG. 2) moves to the upper chamber 22 (see FIG. 2) side, and therefore the pressure of the upper chamber 22 (see FIG. 2) increases and the pressure of the lower chamber 23 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the upper chamber 22 (see FIG. 2) and the lower chamber 23 (see FIG. 2). Therefore, the oil liquid L of the upper chamber 22 (see FIG. 2) flows into the pressure storage chamber 147F via a passage in the plurality of passage holes 38 (see FIG. 2) of the piston 21 (see FIG. 2) and the annular groove 55 (see FIG. 2), the orifice 175 (see FIG. 2), a passage in the large diameter hole 46 (see FIG. 2) of the piston 21 (see FIG. 2), the piston rod passage portion 51 (see FIG. 2) of the piston rod 25 (see FIG. 3), a passage in the second hole 133 (see FIG. 2) of the valve seat member 109F, the radial passage 222 (see FIG. 2) of the valve seat member 109F, the case chamber 142 (see FIG. 3), and the passage portion 144F shown in FIG. 10. Thereby, the pressure of the pressure storage chamber 147F is increased. For this reason, in the upper-chamber-side volume variable mechanism 186F, the O-ring 108F is crushed in contact with the wall surface of the first inclined portion 411 of the sidewall portion 141Fb opposite to the bottom portion 122 (see FIG. 3) of the seal groove 141F before the second damping force generation mechanism 183 (see FIG. 2) opens the valve. Then, the O-ring 108F increases the capacity of the pressure storage chamber 147F. Thereby, the upper-chamber-side volume variable mechanism 186F suppresses the increase in the pressure of the pressure storage chamber 147F. At this time, the lower-chamber-side volume variable mechanism 185F including the O-ring 108F decreases the volume of the pressure storage chamber 148F. Also, because the O-ring 108F is crushed in contact with the wall surface of the first inclined portion 411 of the sidewall portion 141Fb opposite to the bottom portion 122 (see FIG. 3) of the seal groove 141F immediately when the pressure in the pressure storage chamber 147F increases, a high spring with a relatively high spring constant is set from an initial stage of the extension stroke and the extremely low-speed damping force in the extension stroke is larger than in the sixth embodiment.

If the compressive deformation progresses when the O-ring 108F is compressively deformed on the opposite side of the bottom portion 122 (see FIG. 3) in the extension stroke, the volume of the pressure storage chamber 147F is further extended due to the transition from a state in which the O-ring 108F is in contact with the wall surface of the first inclined portion 411 of the sidewall portion 141Fb opposite to the bottom portion 122 (see FIG. 3) and does not enter a gap between the wall surface of the second inclined portion 412 of the sidewall portion 141Fb and the inner circumferential surface of the tubular portion 123 to a state in which the O-ring 108F is in contact with the wall surface of the first inclined portion 411 of the sidewall portion 141Fb and enters a gap between the wall surface of the second inclined portion 412 of the sidewall portion 141Fb and the inner circumferential surface of the tubular portion 123.

In the compression stroke of the shock absorber 2F, the piston 21 (see FIG. 2) moves to the lower chamber 23 (see FIG. 2) side, and therefore the pressure of the lower chamber 23 (see FIG. 2) increases and the pressure of the upper chamber 22 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the lower chamber 23 (see FIG. 2) and the upper chamber 22 (see FIG. 2). Therefore, the oil liquid L of the lower chamber 23 (see FIG. 2) flows into the pressure storage chamber 148F via the passage portion 145F between the case member 95 and the valve seat member 109F shown in FIG. 10. Thereby, the pressure of the pressure storage chamber 148F is increased. For this reason, in the lower-chamber-side volume variable mechanism 185F, the O-ring 108F is crushed in contact with the wall surface of the first inclined portion 411 of the sidewall portion 141Fb on the bottom portion 122 (see FIG. 3) side of the seal groove 141F before the second damping force generation mechanism 173 (see FIG. 2) opens the valve. Then, the O-ring 108F increases the capacity of the pressure storage chamber 148F. Thereby, the lower-chamber-side volume variable mechanism 185F suppresses the increase in the pressure of the pressure storage chamber 148F. At this time, the upper-chamber-side volume variable mechanism 186F including the O-ring 108F decreases the volume of the pressure storage chamber 147F. Also, because the O-ring 108F is crushed in contact with the wall surface of the first inclined portion 411 of the sidewall portion 141Fb on the bottom portion 122 (see FIG. 3) side of the seal groove 141F immediately when the pressure of the pressure storage chamber 147F increases, a high spring with a relatively high spring constant is set from an initial stage of the compression stroke and the extremely low-speed damping force in the compression stroke is larger than in the sixth embodiment.

If the compressive deformation progresses when the O-ring 108F is compressively deformed on the bottom portion 122 (see FIG. 3) side in the compression stroke, the volume of the pressure storage chamber 148F is further extended due to the transition from a state in which the O-ring 108F is in contact with the wall surface of the first inclined portion 411 of the sidewall portion 141Fb on the bottom portion 122 (see FIG. 3) side and does not enter a gap between the wall surface of the second inclined portion 412 of the sidewall portion 141Fb and the inner circumferential surface of the tubular portion 123 to a state in which the O-ring 108F is in contact with the wall surface of the first inclined portion 411 of the sidewall portion 141Fb and enters a gap between the wall surface of the second inclined portion 412 of the sidewall portion 141Fb and the inner circumferential surface of the tubular portion 123.

The damping force generation device 1F of the seventh embodiment has the valve seat member 109F shown in FIG. 10 provided at least partially parallel to the first passage 92 (see FIG. 2) and having the second passage 182 (see FIG. 2) that connects the upper chamber 22 (see FIG. 2) and the lower chamber 23 (see FIG. 2). Also, the passage portion 144F branching from the second passage 182 (see FIG. 2) in a direction from the upper chamber 22 (see FIG. 2) to the second damping force generation mechanism 183 (see FIG. 2) and connected to the pressure storage portion 151F is provided in the valve seat member 109F. Because a function of the pressure storage portion 151F is similar to that of the pressure storage portion 151, the effect of the damping force generation device 1F is similar to that of the damping force generation device 1.

Moreover, the damping force generation device 1F has the first inclined portion 411 and the second inclined portion 412 in which the sidewall portion 141Fb is inclined with respect to the axial direction of the valve seat member 109F. The first inclined portion 411 and the second inclined portion 412 have different angles with respect to the axial direction of the valve seat member 109F. Therefore, the damping force generation device 1F can gradually change the resistance to compressive deformation of the O-ring 108F in the pressure storage portion 151F. Therefore, the damping force at the time of compression deformation of the O-ring 108F can be gradually changed. For example, it is possible to set a high spring having a relatively high spring constant at the initial stage of compressive deformation of the O-ring 108E Therefore, it is possible to suppress the insufficient damping force at the time of rising. Moreover, a rate of change in the damping force can be easily changed by adjusting an angle of the first inclined portion 411 with respect to the axial direction of the valve seat member 109F.

Moreover, in the damping force generation device 1F, either one of the pair of sidewall portions 141Fb has the first inclined portion 411 and the second inclined portion 412 inclined with respect to the axial direction of the valve seat member 109E. Therefore, the damping force generation device 1F can gradually change the resistance to compressive deformation of the O-ring 108F in the pressure storage portion 151F in both the extension stroke and the compression stroke.

Also, the shape of the seal groove 141F of the seventh embodiment can be applied to the shape of the seal groove 141A, which is the concave portion of the second embodiment, can be applied to the shape of the seal groove 141B, which is the concave portion of the third embodiment, or can be applied to the shape of the large diameter hole 46D, which is the concave portion of the fifth embodiment. When the shape of the seal groove 141F is applied to the shape of the seal groove 141A, which is the concave portion of the second embodiment, the bottom portion 141Fa is arranged on a radially outward side of the valve seat member 109A.

### Eighth Embodiment

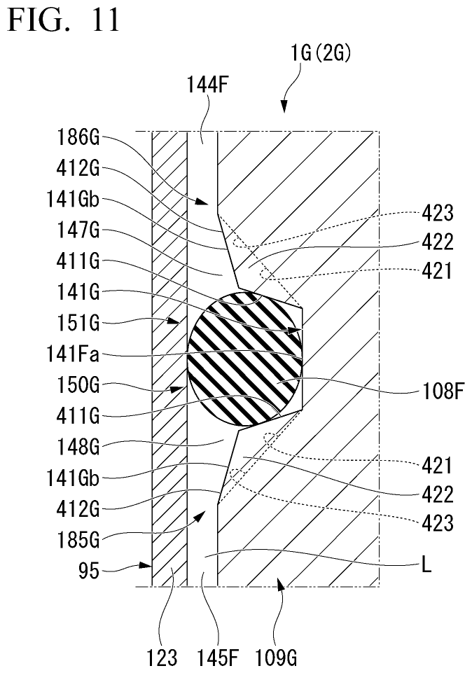

Next, an eighth embodiment will be described mainly on the basis of the differences from the seventh embodiment on the basis of FIG. 11. Also, parts identical to those of the seventh embodiment are represented by the same designation and the same reference numerals.

### <Configuration>

As shown in FIG. 11, a damping force generation device 1G of the eighth embodiment is partially different from the damping force generation device 1F. A shock absorber 2G is different from the shock absorber 2F in that it has a damping force generation device 1G instead of the damping force generation device 1F. The damping force generation device 1G has a valve seat member 109G partially different from the valve seat member 109F instead of the valve seat member 109F.

The valve seat member 109G has a main body portion 140G partially different from the main body portion 140F instead of the main body portion 140F. In the main body portion 140G, a seal groove 141G (concave portion) is formed at an intermediate position in the axial direction of its outer circumferential portion instead of the seal groove 141F. The seal groove 141G is annular and concave radially inward from the outer circumferential surface of the main body portion 140G. The seal groove 141G is mirror-symmetric in the axial direction of the valve seat member 109G.

The seal groove 141G has the same bottom portion 141Fa as the seal groove 141F.

The seal groove 141G has a sidewall portion 141Gb with a difference in which a plurality of groove portions 421 are formed at equal intervals in the circumferential direction with respect to one sidewall portion 141Fb of the pair of sidewall portions 141Fb of the seal groove 141E Thereby, one sidewall portion 141Gb has a plurality of groove portions 421 and a plurality of convex portions 422 other than the plurality of groove portions 421.

The groove portion 421 of the one sidewall portion 141Gb has a third inclined portion 423 (inclined portion) in the groove bottom. In the third inclined portion 423, the wall surface facing outward in the radial direction of the valve seat member 109G is tapered to connect an inner end position and an outer end position in the radial direction of the valve seat member 109G in the one sidewall portion 141Gb.

The plurality of convex portions 422 of the one sidewall portion 141Gb have a first inclined portion 411G (inclined portion) with a difference in which the plurality of groove portions 421 are intermittent in the circumferential direction of the valve seat member 109G with respect to the first inclined portion 411. Moreover, the plurality of convex portions 422 of the one sidewall portion 141Gb have a second inclined portion 412G (inclined portion) with a difference in which the plurality of groove portions 421 are intermittent in the circumferential direction of the valve seat member 109G with respect to the second inclined portion 412.

The groove portion 421 of the one sidewall portion 141Gb is concave further inward in the radial direction of the valve seat member 109G than the wall surface facing outward in the radial direction of the valve seat member 109G in the first inclined portion 411G and the second inclined portion 412G of the convex portion 422 adjacent to both sides in the circumferential direction of the valve seat member 109G. The convex portion 422 of the one sidewall portion 141Gb protrudes further outward in the radial direction of the valve seat member 109G than the wall surface facing outward in the radial direction of the valve seat member 109G in the third inclined portion 423 of the groove portion 421 adjacent to both sides in the circumferential direction of the valve seat member 109G.

In the one sidewall portion 141Gb, the third inclined portion 423 of the groove portion 421 has a smaller angle to the axial direction of the valve seat member 109G, i.e., a smaller angle formed with the central axis of the valve seat member 109G, than the first inclined portion 411G. That is, in the one sidewall portion 141Gb, an angle formed between an extension line of the third inclined portion 423 and a portion on the third inclined portion 423 side of an intersection of the central axis of the valve seat member 109G with the extension line of the third inclined portion 423 is smaller than an angle formed between an extension line of the first inclined portion 411G and a portion on the first inclined portion 411G side of an intersection of the central axis of the valve seat member 109G with the extension line of the first inclined portion 411G.

In the one sidewall portion 141Gb, the third inclined portion 423 of the groove portion 421 has a larger angle to the axial direction of the valve seat member 109G, i.e., a larger angle formed with the central axis of the valve seat member 109G, than the second inclined portion 412G. That is, in the one sidewall portion 141Gb, an angle formed between an extension line of the third inclined portion 423 and a portion on the third inclined portion 423 side of an intersection of the central axis of the valve seat member 109G with the extension line of the third inclined portion 423 is larger than an angle formed between an extension line of the second inclined portion 412G and a portion on the second inclined portion 412G side of an intersection of the central axis of the valve seat member 109G with the extension line of the second inclined portion 412G.

Therefore, in the one sidewall portion 141Gb, the first inclined portion 411G, the second inclined portion 412G, and the third inclined portion 423 are formed so that an angle to the axial direction of the valve seat member 109G differs according to a circumferential position of the valve seat member 109G.

The seal groove 141G has the other sidewall portion 141Gb with a difference in which a plurality of groove portions 421 are formed at equal intervals in the circumferential direction with respect to the other sidewall portion 141Fb of the pair of sidewall portions 141Fb of the seal groove 141F. Thereby, the other sidewall portion 141Gb has a plurality of groove portions 421 and a plurality of convex portions 422 other than the plurality of groove portions 421.

The groove portion 421 of the other sidewall portion 141Gb has the third inclined portion 423 (inclined portion) on a groove bottom. In the third inclined portion 423, the wall surface facing outward in the radial direction of the valve seat member 109G is tapered to connect the inner end position and the outer end position in the radial direction of the valve seat member 109G in the other sidewall portion 141Gb.

The plurality of convex portions 422 of the other sidewall portion 141Gb have the first inclined portion 411G (inclined portion) with a difference in which the plurality of groove portions 421 are intermittent in the circumferential direction of the valve seat member 109G with respect to the first inclined portion 411. Moreover, the plurality of convex portions 422 of the other sidewall portion 141Gb have the second inclined portion 412G (inclined portion) with a difference in which the plurality of groove portions 421 are intermittent in the circumferential direction of the valve seat member 109G with respect to the second inclined portion 412.

The groove portion 421 of the other sidewall portion 141Gb is concave further inward in the radial direction of the valve seat member 109G than the wall surface facing outward in the radial direction of the valve seat member 109G in the first inclined portion 411G and the second inclined portion 412G of the convex portion 422 adjacent to both sides in the circumferential direction of the valve seat member 109G. The convex portion 422 of the other sidewall portion 141Gb protrudes further outward in the radial direction of the valve seat member 109G than the wall surface facing outward in the radial direction of the valve seat member 109G in the third inclined portion 423 of the groove portion 421 adjacent to both sides in the circumferential direction of the valve seat member 109G.

In the other sidewall portion 141Gb, the third inclined portion 423 of the groove portion 421 has a smaller angle to the axial direction of the valve seat member 109G, i.e., a smaller angle formed with the central axis of the valve seat member 109G, than the first inclined portion 411G. That is, in the other sidewall portion 141Gb, an angle formed between an extension line of the third inclined portion 423 and a portion on the third inclined portion 423 side of an intersection of the central axis of the valve seat member 109G with the extension line of the third inclined portion 423 is smaller than an angle formed between an extension line of the first inclined portion 411G and a portion on the first inclined portion 411G side of an intersection of the central axis of the valve seat member 109G with the extension line of the first inclined portion 411G.

In the other sidewall portion 141Gb, the third inclined portion 423 of the groove portion 421 has a larger angle to the axial direction of the valve seat member 109G, i.e., a larger angle formed with the central axis of the valve seat member 109G, than the second inclined portion 412G. That is, in the other sidewall portion 141Gb, an angle formed between an extension line of the third inclined portion 423 and a portion on the third inclined portion 423 side of an intersection of the central axis of the valve seat member 109G with the extension line of the third inclined portion 423 is larger than an angle formed between an extension line of the second inclined portion 412G and a portion on the second inclined portion 412G side of an intersection of the central axis of the valve seat member 109G with the extension line of the second inclined portion 412G.

Therefore, in the other sidewall portion 141Gb, the first inclined portion 411G, the second inclined portion 412G, and the third inclined portion 423 are formed so that an angle to the axial direction of the valve seat member 109G differs according to a circumferential position of the valve seat member 109G.

An O-ring 108F identical to that of the seventh embodiment is arranged in the seal groove 141G. In other words, the O-ring 108F is arranged in the seal groove 141G provided in the valve seat member 109G. The O-ring 108F is in contact with the inner circumferential surface of the tubular portion 123 of the case member 95 and the groove bottom surface of the bottom portion 141Fa of the seal groove 141G of the valve seat member 109G to continuously seal a gap therebetween. The O-ring 108F substantially does not roll in the seal groove 141G and is compressively deformed.

In a gap between the outer circumferential surface of the portion other than the seal groove 141G of the main body portion 140G of the valve seat member 109G and the inner circumferential surface of the tubular portion 123 of the case member 95, a portion on the bottom portion 122 (see FIG. 3) side of the seal groove 141G in the axial direction of the valve seat member 109G becomes the passage portion 144F similar to that of the passage portion 144F of the seventh embodiment. Moreover, in this gap, a portion opposite to the bottom portion 122 (see FIG. 3) of the seal groove 141G in the axial direction of the valve seat member 109G becomes the passage portion 145F similar to the passage portion 145 of the seventh embodiment. Therefore, the valve seat member 109G has the passage portion 144F and the passage portion 145F with the case member 95. The valve seat member 109G defines the passage portion 144F and the passage portion 145F with the case member 95.

The O-ring 108F divides the inside of the seal groove 141G into a pressure storage chamber 147G similar to the pressure storage chamber 147F and a pressure storage chamber 148G similar to the pressure storage chamber 148E Therefore, the case member 95 and the valve seat member 109G have the passage portion 144F that connects the case chamber 142 (see FIG. 3) to the pressure storage chamber 147G. The case member 95 and the valve seat member 109G have the passage portion 145F that connects the lower chamber 23 (see FIG. 3) to the pressure storage chamber 148G.

The inner circumferential portion of the tubular portion 123 of the case member 95 and the outer circumferential portion including the seal groove 141G of the main body portion 140G of the valve seat member 109G constitute an outer shell portion 150G. In other words, the outer shell portion 150G is formed by an outer circumferential portion opposite to the piston rod 25 (see FIG. 3) in the radial direction of the valve seat member 109G and an inner circumferential portion of the tubular portion 123 of the case member 95. The outer shell portion 150G constitutes the outer shell of the pressure storage chamber 147G and the pressure storage chamber 148G. The outer shell portion 150G accommodates the O-ring 108E The O-ring 108F divides the inside of the outer shell portion 150G into the pressure storage chamber 147G and the pressure storage chamber 148G.

The volumes of the pressure storage chamber 147G and the pressure storage chamber 148G change due to the deformation of the O-ring 108F mainly in the axial direction in the seal groove 141G. That is, the O-ring 108F, the pressure storage chamber 147G, the pressure storage chamber 148G, and the outer shell portion 150G constitute a pressure storage portion 151G provided so that the volume can be changed.

The O-ring 108F and the pressure storage chamber 148G constitute a lower-chamber-side volume variable mechanism 185G similar to the lower-chamber-side volume variable mechanism 185F.

The lower-chamber-side volume variable mechanism 185G makes a change to increase the volume of the pressure storage chamber 148G when the O-ring 108F is crushed in contact with the wall surface of the first inclined portion 411G of the sidewall portion 141Gb on the bottom portion 122 (see FIG. 3) side in the axial direction of the seal groove 141G. At this time, the O-ring 108F maintains a state in which the pressure storage chamber 148G and the pressure storage chamber 147G are blocked.

Moreover, the lower-chamber-side volume variable mechanism 185G makes a change to decrease the volume of the pressure storage chamber 148G when the O-ring 108F is crushed in contact with the wall surface of the first inclined portion 411G of the sidewall portion 141Gb on the opposite side of the bottom portion 122 (see FIG. 3) in the axial direction of the seal groove 141G. At this time, the O-ring 108F also maintains a state in which the pressure storage chamber 148G and the pressure storage chamber 147G are blocked.

The O-ring 108F and the pressure storage chamber 147G constitute an upper-chamber-side volume variable mechanism 186G similar to the upper-chamber-side volume variable mechanism 186F.

The upper-chamber-side volume variable mechanism 186G makes a change to increase the volume of the pressure storage chamber 147G when the O-ring 108F is crushed in contact with the wall surface of the first inclined portion 411G of the sidewall portion 141Gb on the opposite side of the bottom portion 122 (see FIG. 3) in the axial direction of the seal groove 141G. At this time, the O-ring 108F maintains a state in which the pressure storage chamber 147G and the pressure storage chamber 148G are blocked.

Moreover, the upper-chamber-side volume variable mechanism 186G makes a change to decrease the volume of the pressure storage chamber 147G when the O-ring 108F is crushed in contact with the wall surface the first inclined portion 411G of the sidewall portion 141Gb of the bottom portion 122 (see FIG. 3) side in the axial direction of the seal groove 141G. At this time, the O-ring 108F also maintains a state in which the pressure storage chamber 147G and the pressure storage chamber 148G are blocked.

The O-ring 108F is shared by the lower-chamber-side volume variable mechanism 185G and the upper-chamber-side volume variable mechanism 186G. The lower-chamber-side volume variable mechanism 185G including the pressure storage chamber 148G and the upper-chamber-side volume variable mechanism 186G including the pressure storage chamber 147G are provided in the pressure storage portion 151G for storing the oil liquid L as a working fluid.

### <Operation>

In the extension stroke of the shock absorber 2G, the piston 21 (see FIG. 2) moves to the upper chamber 22 (see FIG. 2) side, and therefore the pressure of the upper chamber 22 (see FIG. 2) increases and the pressure of the lower chamber 23 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the upper chamber 22 (see FIG. 2) and the lower chamber 23 (see FIG. 2). Therefore, the oil liquid L of the upper chamber 22 (see FIG. 2) flows into the pressure storage chamber 147G via a passage in the plurality of passage holes 38 (see FIG. 2) of the piston 21 (see FIG. 2) and the annular groove 55 (see FIG. 2), the orifice 175 (see FIG. 2), a passage in the large diameter hole 46 (see FIG. 2) of the piston 21 (see FIG. 2), the piston rod passage portion 51 (see FIG. 2) of the piston rod 25 (see FIG. 3), a passage in the second hole 133 (see FIG. 2) of the valve seat member 109G, the radial passage 222 (see FIG. 2) of the valve seat member 109G, the case chamber 142 (see FIG. 3), and the passage portion 144F shown in FIG. 11. Thereby, the pressure of the pressure storage chamber 147G is increased. For this reason, in the upper-chamber-side volume variable mechanism 186G, the O-ring 108F is crushed in contact with the wall surface of the first inclined portion 411G of the sidewall portion 141Gb opposite to the bottom portion 122 (see FIG. 3) of the seal groove 141G before the second damping force generation mechanism 183 (see FIG. 2) opens the valve. Then, the O-ring 108F increases the capacity of the pressure storage chamber 147G. Thereby, the upper-chamber-side volume variable mechanism 186G suppresses the increase in the pressure of the pressure storage chamber 147G. At this time, the lower-chamber-side volume variable mechanism 185G including the O-ring 108F decreases the volume of the pressure storage chamber 148G. Also, because the O-ring 108F is crushed in contact with the wall surface of the first inclined portion 411G of the sidewall portion 141Gb opposite to the bottom portion 122 (see FIG. 3) of the seal groove 141G immediately when the pressure in the pressure storage chamber 147G increases, a high spring with a relatively high spring constant is set from an initial stage of the extension stroke and the extremely low-speed damping force in the extension stroke is larger than in the sixth embodiment.

Here, if the compressive deformation progresses when the O-ring 108F is compressively deformed on the opposite side of the bottom portion 122 (see FIG. 3) in the extension stroke, the volume of the pressure storage chamber 147G is further extended due to the transition from a state in which the O-ring 108F is in contact with the wall surface of the first inclined portion 411G in the sidewall portion 141Gb opposite to the bottom portion 122 (see FIG. 3), does not enter the groove portion 421, and does not enter a gap between the wall surface of the second inclined portion 412G and the inner circumferential surface of the tubular portion 123 to a state in which the O-ring 108F is in contact with the wall surface of the first inclined portion 411G, enters the groove portion 421, and does not enter a gap between the wall surface of the second inclined portion 412G and the inner circumferential surface of the tubular portion 123. If the compression deformation further progresses, the volume of the pressure storage chamber 147G is further extended in a state in which the O-ring 108F is in contact with the wall surface of the first inclined portion 411G in the sidewall portion 141Gb opposite to the bottom portion 122 (see FIG. 3), enters the groove portion 421, and enters a gap between the wall surface of the second inclined portion 412G and the inner circumferential surface of the tubular portion 123.

In the compression stroke of the shock absorber 2G, the piston 21 (see FIG. 2) moves to the lower chamber 23 (see FIG. 2) side, and therefore the pressure of the lower chamber 23 (see FIG. 2) increases and the pressure of the upper chamber 22 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the lower chamber 23 (see FIG. 2) and the upper chamber 22 (see FIG. 2). Therefore, the oil liquid L of the lower chamber 23 (see FIG. 2) flows into the pressure storage chamber 148G via the passage portion 145F between the case member 95 and the valve seat member 109G shown in FIG. 11. Thereby, the pressure of the pressure storage chamber 148G is increased. For this reason, in the lower-chamber-side volume variable mechanism 185G, the O-ring 108F is crushed in contact with the wall surface of the first inclined portion 411G of the sidewall portion 141Gb on the bottom portion 122 (see FIG. 3) side of the seal groove 141G before the second damping force generation mechanism 173 (see FIG. 2) opens the valve. Then, the O-ring 108F increases the capacity of the pressure storage chamber 148G. Thereby, the lower-chamber-side volume variable mechanism 185G suppresses the increase in the pressure of the pressure storage chamber 148G. At this time, the upper-chamber-side volume variable mechanism 186G including the O-ring 108F decreases the volume of the pressure storage chamber 147G. Also, because the O-ring 108F is crushed in contact with the wall surface of the first inclined portion 411G of the sidewall portion 141Gb on the bottom portion 122 (see FIG. 3) side of the seal groove 141G immediately when the pressure of the pressure storage chamber 148G increases, a high spring with a relatively high spring constant is set from an initial stage of the compression stroke and the extremely low-speed damping force in the compression stroke is larger than in the sixth embodiment.

Here, if the compressive deformation progresses when the O-ring 108F is compressively deformed on the bottom portion 122 (see FIG. 3) in the compression stroke, the volume of the pressure storage chamber 147G is further extended due to the transition from a state in which the O-ring 108F is in contact with the wall surface of the first inclined portion 411G in the sidewall portion 141Gb on the bottom portion 122 (see FIG. 3) side, does not enter the groove portion 421, and does not enter a gap between the wall surface of the second inclined portion 412G and the inner circumferential surface of the tubular portion 123 to a state in which the O-ring 108F is in contact with the wall surface of the first inclined portion 411G, enters the groove portion 421, and does not enter a gap between the wall surface of the second inclined portion 412G and the inner circumferential surface of the tubular portion 123. If the compression deformation further progresses, the volume of the pressure storage chamber 147G is further extended in a state in which the O-ring 108F is in contact with the wall surface of the first inclined portion 411G in the sidewall portion 141Gb on the bottom portion 122 (see FIG. 3) side, enters the groove portion 421, and enters a gap between the wall surface of the second inclined portion 412G and the inner circumferential surface of the tubular portion 123.

The damping force generation device 1G of the eighth embodiment has the valve seat member 109G shown in FIG. 11 provided at least partially parallel to the first passage 92 (see FIG. 2) and having the second passage 182 (see FIG. 2) that connects the upper chamber 22 (see FIG. 2) and the lower chamber 23 (see FIG. 2). Also, the passage portion 144A branching from the second passage 182 (see FIG. 2) in a direction from the upper chamber 22 (see FIG. 2) to the second damping force generation mechanism 183 (see FIG. 2) and connected to the pressure storage portion 151G is provided in the valve seat member 109G. Because a function of the pressure storage portion 151G is similar to that of the pressure storage portion 151F, the effect of the damping force generation device 1G is similar to that of the damping force generation device 1F.

Moreover, the damping force generation device 1G has the first inclined portion 411G and the second inclined portion 412G in which the sidewall portion 141Gb is inclined with respect to the axial direction of the valve seat member 109G. The first inclined portion 411G and the second inclined portion 412G have different angles with respect to the axial direction of the valve seat member 109G. Therefore, the damping force generation device 1G can gradually change the resistance to compressive deformation of the O-ring 108F in the pressure storage portion 151G. Therefore, the damping force at the time of compression deformation of the O-ring 108F can be gradually changed. For example, it is possible to set a high spring having a relatively high spring constant at the initial stage of compressive deformation. Therefore, it is possible to suppress the insufficient damping force at the time of rising. Moreover, a rate of change in the damping force can be easily changed by adjusting an angle of the first inclined portion 411G with respect to the axial direction of the valve seat member 109G.

Moreover, in the damping force generation device 1G, the first inclined portion 411G, the second inclined portion 412G, and the third inclined portion 423 are formed so that an angle to the axial direction of the valve seat member 109G differs according to a circumferential position of the valve seat member 109G. For this reason, the damping force generation device 1G can easily change the damping force by adjusting the number of third inclined portions 423 and the length of the third inclined portion 423 in the circumferential direction of the valve seat member 109G.

Moreover, in the damping force generation device 1G, either one of the pair of sidewall portions 141Gb has the first inclined portion 411G and the second inclined portion 412G inclined with respect to the axial direction of the valve seat member 109G. Therefore, the damping force generation device 1G can gradually change the resistance to compressive deformation of the O-ring 108F in the pressure storage portion 151F in both the extension stroke and the compression stroke.

Also, the shape of the seal groove 141G of the eighth embodiment can be applied to the shape of the seal groove 141A, which is the concave portion of the second embodiment, can be applied to the shape of the seal groove 141B, which is the concave portion of the third embodiment, or can be applied to the shape of the large diameter hole 46D, which is the concave portion of the fifth embodiment. When the shape of the seal groove 141G is applied to the shape of the seal groove 141A, which is the concave portion of the second embodiment, the bottom portion 141Fa is arranged on a radially outward side of the valve seat member 109A.

### Ninth Embodiment

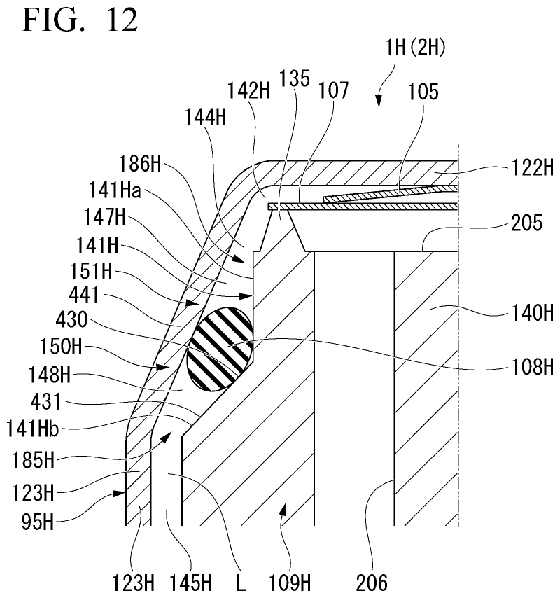

Next, a ninth embodiment will be described mainly on the basis of the differences from the first embodiment on the basis of FIG. 12. Also, parts identical to those of the first embodiment are represented by the same designation and the same reference numerals.

### <Configuration>

As shown in FIG. 12, the damping force generation device 1H of the ninth embodiment is partially different from the damping force generation device 1. The shock absorber 2H is different from the shock absorber 2 in that it has a damping force generation device 1H instead of the damping force generation device 1. The damping force generation device 1H has a valve seat member 109H partly different from the valve seat member 109 instead of the valve seat member 109.

The valve seat member 109H has a main body portion 140H partially different from the main body portion 140 instead of the main body portion 140. In the main body portion 140H, a notch 141H (concave portion) is formed at an end position on the valve seat portion 135 side in an axial direction of the outer circumferential portion instead of the seal groove 141. The notch 141H is formed outside of the valve seat portion 135 in the radial direction of the main body portion 140H. The notch 141H is annular and concave radially inward from the outer circumferential surface of the main body portion 140H. Moreover, the notch 141H is concave from an end surface of the valve seat portion 135 side in an axial direction of the main body portion 140H to the opposite side of the valve seat portion 135.

The notch 141H has a bottom portion 141Ha arranged on the valve seat portion 135 side in the axial direction of the valve seat member 109H and arranged inside of the valve seat member 109H in the radial direction and a sidewall portion 141Hb arranged on the opposite side of the valve seat portion 135 in the axial direction of the valve seat member 109H.

In the bottom portion 141Ha, a bottom surface facing outward in the radial direction of the valve seat member 109H has a cylindrical surface shape in the axial direction of the valve seat member 109H.

The sidewall portion 141Hb has a curved portion 430 and an inclined portion 431. The curved portion 430 extends from the end of the opposite side of the valve seat portion 135 of the bottom portion 141Ha in the axial direction of the valve seat member 109H so that a distance from the bottom portion 141Ha in the axial direction of the valve seat member 109H increases. The curved portion 430 has a curved wall surface facing outward in the radial direction of the valve seat member 109H. The wall surface of the curved portion 430 has an arc-shaped cross-section shape on a surface including the central axis of the valve seat member 109H. The outer diameter of the curved portion 430 is a smallest diameter at the end of the bottom portion 141Ha side in the axial direction of the valve seat member 109H. The outer diameter of the curved portion 430 increases as a distance from the bottom portion 141Ha in the axial direction of the valve seat member 109H from an end thereof increases. The bottom portion 141Ha extends from the end of the curved portion 430 connected to the bottom portion 141Ha in a tangential direction of the end.

The inclined portion 431 extends from the end of the opposite side of the bottom portion 141Ha of the curved portion 430 in the axial direction of the valve seat member 109H so that a distance from the bottom portion 141Ha in the axial direction of the valve seat member 109H increases. The inclined portion 431 has a tapered wall surface facing outward in the radial direction of the valve seat member 109H and facing toward the valve seat portion 135 side in the axial direction of the valve seat member 109H. Therefore, the sidewall portion 141Hb has an inclined portion 431 inclined with respect to the axial direction of the valve seat member 109H.

The inclined portion 431 has a smallest outer diameter at the end of the curved portion 430 side in the axial direction of the valve seat member 109H. The inclined portion 431 has a large outer diameter as a distance from the curved portion 430 in the axial direction of the valve seat member 109H increases. The inclined portion 431 extends from the end of the curved portion 430 to which the inclined portion 431 is connected in the tangential direction of the end.

The damping force generation device 1H has a case member 95H partially different from the case member 95 instead of the case member 95. The case member 95H has a bottom portion 122H having a smaller outer diameter than the bottom portion 122, a tubular portion 123H having a shorter axial length than the tubular portion 123, and an inclined tubular portion 441 connecting them. The inclined tubular portion 441 connects the outer circumferential portion of the bottom portion 122H and the end of the bottom portion 122H side in the axial direction of the tubular portion 123H. The inclined tubular portion 441 is tapered and both the outer diameter and a small diameter decrease as a distance to the bottom portion 122H in the axial direction decreases.

Like the case member 95, the case member 95H covers the valve seat member 109H and is attached to the piston rod 25 (see FIG. 3). Then, the case member 95H aligns the inclined tubular portion 441 with the notch 141H of the valve seat member 109H in the axial direction. In other words, in the radial direction of the case member 95H and the valve seat member 109H, the inclined tubular portion 441 and the notch 141H are opposed. The case member 95H forms a case chamber 142H similar to the case chamber 142 with the valve seat member 109H.

An O-ring 108H (elastic member) similar to the O-ring 108 of the first embodiment is arranged on the notch 141H. In other words, the O-ring 108H is arranged on the notch 141H provided in the valve seat member 109H. The O-ring 108H is in contact with the inner circumferential surface of the inclined tubular portion 441 of the case member 95H and the wall surface of the curved portion 430 of the sidewall portion 141Hb, the bottom surface of the bottom portion 141Ha, or the wall surface of the inclined portion 431 of the sidewall portion 141Hb to continuously seal the gap therebetween.

Here, a distance between each end of the notch 141H in the axial direction of the valve seat member 109H and the inner circumferential surface of the inclined tubular portion 441 of the case member 95H is set to a distance in which the O-ring 108H cannot pass. A gap between the end of the bottom portion 122H side of the notch 141H in the axial direction of the valve seat member 109H and the inner circumferential surface of the inclined tubular portion 441 of the case member 95H becomes the passage portion 144H like the passage portion 144 of the first embodiment. A gap between the outer circumferential surface of the portion opposite to the bottom portion 122H of the notch 141H in the axial direction of the main body portion 140E of the valve seat member 109E and the inner circumferential surface of the tubular portion 123H of the case member 95H becomes the passage portion 145H like the passage portion 145 of the first embodiment. Therefore, the valve seat member 109H has the passage portion 144H and the passage portion 145H with the case member 95H. The valve seat member 109H defines the passage portion 144H and the passage portion 145H with the case member 95H.

A width of the notch 141H in a direction along the inclined tubular portion 441, i.e., a distance between two ends of the notch 141H, is longer than a length in the direction along the inclined tubular portion 441 of the O-ring 108H arranged in the notch 141H. Therefore, the O-ring 108H can be moved along the inclined tubular portion 441 in the notch 141H. During this movement, the O-ring 108H rolls so that a portion of the outer circumferential side moves forward in a movement direction of the O-ring 108H and a portion of the inner circumferential side moves backward in a movement direction of the O-ring 108H or slides on the bottom surface of the bottom portion 141Ha of the notch 141H or the wall surface of the inclined portion 431 of the side wall portion 141Hb and the inner circumferential surface of the inclined tubular portion 441.

The O-ring 108H divides the inside of the notch 141H into a pressure storage chamber 147H similar to the pressure storage chamber 147 and a pressure storage chamber 148H similar to the pressure storage chamber 148. Therefore, the case member 95H and the valve seat member 109H have the passage portion 144H that connects the case chamber 142H to the pressure storage chamber 147H. The case member 95H and the valve seat member 109H have the passage portion 145H that connects the lower chamber 23 (see FIG. 3) to the pressure storage chamber 148H.

The inner circumferential portion of the inclined tubular portion 441 of the case member 95H and the outer circumferential portion including the notch 141H of the main body portion 140H of the valve seat member 109H constitute the outer shell portion 150H. In other words, the outer shell portion 150H is formed by the outer circumferential portion opposite to the piston rod 25 (see FIG. 3) in the radial direction of the valve seat member 109H and the inner circumferential portion of the inclined tubular portion 441 of the case member 95H. The outer shell portion 150H constitutes the outer shell of the pressure storage chamber 147H and the pressure storage chamber 148H. The outer shell portion 150H accommodates the O-ring 108H. The O-ring 108H divides the inside of the outer shell portion 150H into the pressure storage chamber 147H and the pressure storage chamber 148H.

The volumes of the pressure storage chamber 147H and the pressure storage chamber 148H change when the O-ring 108H is moved along the inclined tubular portion 441 in the notch 141H or deformed along the inclined tubular portion 441. That is, the O-ring 108H, the pressure storage chamber 147H, the pressure storage chamber 148H, and the outer shell portion 150H constitute the pressure storage portion 151H provided so that the volume can be changed.

The O-ring 108H and the pressure storage chamber 148H constitute a lower-chamber-side volume variable mechanism 185H similar to the lower-chamber-side volume variable mechanism 185.

The lower-chamber-side volume variable mechanism 185H makes a change to increase the volume of the pressure storage chamber 148H when the O-ring 108H is moved in proximity to the bottom portion 122H along the inclined tubular portion 441 or crushed by restricting movement at the end of the bottom portion 122H side of the notch 141H and the inclined tubular portion 441. At this time, the O-ring 108H maintains a state in which the pressure storage chamber 148H and the pressure storage chamber 147H are blocked.

Moreover, the lower-chamber-side volume variable mechanism 185H makes a change to decrease the volume of the pressure storage chamber 148H when the O-ring 108H is moved away from the bottom portion 122H along the inclined tubular portion 441 or crushed by restricting movement at the end of the opposite side of the bottom portion 122H of the notch 141H and the inclined tubular portion 441. At this time, the O-ring 108H also maintains a state in which the pressure storage chamber 148H and the pressure storage chamber 147H are blocked.

The O-ring 108H and the pressure storage chamber 147H constitute the upper-chamber-side volume variable mechanism 186H like the upper-chamber-side volume variable mechanism 186.

The upper-chamber-side volume variable mechanism 186H makes a change to increase the volume of the pressure storage chamber 147H when the O-ring 108H is moved away from the bottom portion 122H along the inclined tubular portion 441 or crushed by restricting movement at the end of the opposite side of the bottom portion 122H of the notch 141H and the inclined tubular portion 441. At this time, the O-ring 108H maintains a state in which the pressure storage chamber 147H and the pressure storage chamber 148H are blocked.

Moreover, the upper-chamber-side volume variable mechanism 186H makes a change to decrease the volume of the pressure storage chamber 147H when the O-ring 108H is moved in proximity to the bottom portion 122H along the inclined tubular portion 441 or crushed by restricting movement at the end of the opposite side of the bottom portion 122H of the notch 141H and the inclined tubular portion 441. At this time, the O-ring 108H also maintains a state in which the pressure storage chamber 147H and the pressure storage chamber 148H are blocked.

The O-ring 108H is shared by the lower-chamber-side volume variable mechanism 185H and the upper-chamber-side volume variable mechanism 186H. The lower-chamber-side volume variable mechanism 185H including the pressure storage chamber 148H and the upper-chamber-side volume variable mechanism 186H including the pressure storage chamber 147H are provided in the pressure storage portion 151H for storing the oil liquid L as a working fluid.

### <Operation>

In the extension stroke of the shock absorber 2H, the piston 21 (see FIG. 2) moves to the upper chamber 22 (see FIG. 2) side, and therefore the pressure of the upper chamber 22 (see FIG. 2) increases and the pressure of the lower chamber 23 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the upper chamber 22 (see FIG. 2) and the lower chamber 23 (see FIG. 3). Therefore, the oil liquid L of the upper chamber 22 (see FIG. 2) flows into the pressure storage chamber 147H via a passage in the plurality of passage holes 38 (see FIG. 2) of the piston 21 (see FIG. 2) and the annular groove 55 (see FIG. 2), the orifice 175 (see FIG. 2), a passage in the large diameter hole 46 (see FIG. 2) of the piston 21 (see FIG. 2), the piston rod passage portion 51 (see FIG. 2) of the piston rod 25 (see FIG. 3), a passage in the second hole 133 (see FIG. 2) of the valve seat member 109H, the radial passage 222 (see FIG. 2) of the valve seat member 109H, the case chamber 142H shown in FIG. 12, and the passage portion 144H. Thereby, the pressure of the pressure storage chamber 147H is increased. For this reason, in the upper-chamber-side volume variable mechanism 186H, the O-ring 108H is moved to the opposite side of the bottom portion 122H in the notch 141H or crushed by restricting movement at the end of the opposite side of the bottom portion 122H of the notch 141H and the inclined tubular portion 441 before the second damping force generation mechanism 183 (see FIG. 2) opens the valve. Then, the O-ring 108H increases the capacity of the pressure storage chamber 147H. Thereby, the upper-chamber-side volume variable mechanism 186H suppresses the increase in the pressure of the pressure storage chamber 147H. At this time, the lower-chamber-side volume variable mechanism 185H including the O-ring 108H decreases the volume of the pressure storage chamber 148H.

At the time of movement to the opposite side of the bottom portion 122H in the extension stroke, the O-ring 108H rolls and runs on the wall surface of the inclined portion 431 of the sidewall portion 141Hb from the wall surface of the curved portion 430 of the sidewall portion 141Hb. At this time, as the O-ring 108H approaches the end of the opposite side of the bottom portion 122H of the notch 141H, the amount of radial compression increases and the resistance to movement increases. Also, the O-ring 108H is compressively deformed in the axial direction by restricting movement at the end of the opposite side of the bottom portion 122H of the notch 141H and the inclined tubular portion 441. Therefore, the extremely low-speed damping force of the extension stroke gradually rises and gradually increases.

In the compression stroke of the shock absorber 2H, the piston 21 (see FIG. 2) moves to the lower chamber 23 (see FIG. 3) side, and therefore the pressure of the lower chamber 23 (see FIG. 3) increases and the pressure of the upper chamber 22 (see FIG. 2) decreases. Here, none of the first damping force generation mechanisms 41 and 42 (see FIG. 2) and the second damping force generation mechanisms 173 and 183 (see FIG. 2) has a fixed orifice that continuously connects the lower chamber 23 (see FIG. 2) and the upper chamber 22 (see FIG. 2). Therefore, the oil liquid L of the lower chamber 23 (see FIG. 2) flows into the pressure storage chamber 148H via the passage portion 145H between the case member 95H and the valve seat member 109H shown in FIG. 12. Thereby, the pressure of the pressure storage chamber 148H is increased. For this reason, in the lower-chamber-side volume variable mechanism 185H, the O-ring 108H is moved to the bottom portion 122H side or crushed by restricting movement at the end of the bottom portion 122H side of the notch 141H and the inclined tubular portion 441 before the second damping force generation mechanism 173 (see FIG. 2) opens the valve. Then, the O-ring 108H increases the capacity of the pressure storage chamber 148H. Thereby, the lower-chamber-side volume variable mechanism 185H suppresses the increase in the pressure of the pressure storage chamber 148H. At this time, the upper-chamber-side volume variable mechanism 186H including the O-ring 108H decreases the volume of the pressure storage chamber 147H.

At the time of movement to the bottom portion 122H side in the compression stroke, the O-ring 108H rolls and runs on the groove bottom surface of the bottom portion 141Ha from the wall surface of the curved portion 430 of the sidewall portion 141Hb. At this time, as the O-ring 108H approaches the end of the bottom portion 122H side of the notch 141H, the amount of radial compression increases and the resistance to movement increases. Also, the O-ring 108H is compressively deformed in the axial direction by restricting movement at the end of the bottom portion 122H side of the notch 141H and the inclined tubular portion 441. Therefore, the extremely low-speed damping force of the compression stroke gradually rises and gradually increases.

The damping force generation device 1H of the ninth embodiment includes the valve seat member 109H shown in FIG. 12 having the second passage 182 (see FIG. 2) provided at least partially parallel to the first passage 92 (see FIG. 2) and configured to connect the upper chamber 22 (see FIG. 2) and the lower chamber 23 (see FIG. 2). Also, the passage portion 144H branching from the second passage 182 (see FIG. 2) in a direction from the upper chamber 22 (see FIG. 2) to the second damping force generation mechanism 183 (see FIG. 2) and connected to the pressure storage portion 151H is provided in the valve seat member 109H. Because a function of the pressure storage portion 151H is similar to that of the pressure storage portion 151, the effect of the damping force generation device 1H is similar to that of the damping force generation device 1.

Moreover, the damping force generation device 1H has an inclined portion 431 in which the sidewall portion 141Hb is inclined with respect to the axial direction of the valve seat member 109H. Therefore, the damping force generation device 1H can gradually change the movement resistance of the O-ring 108H in the pressure storage portion 151H in the extension stroke. Therefore, the change in the damping force during movement of the O-ring 108H can be facilitated in the extension stroke. Moreover, a rate of change in the damping force can be easily changed by adjusting the angle of the inclined portion 431 with respect to the axial direction of the valve seat member 109H.

Moreover, the damping force generation device 1H has an inclined tubular portion 441 in which the case member 95H is inclined with respect to the axial direction of the valve seat member 109H and the bottom portion 141Ha is also inclined with respect to the inclined tubular portion 441. Therefore, the damping force generation device 1H can gradually change the movement resistance of the O-ring 108H in the pressure storage portion 151H in the compression stroke. Therefore, the change in the damping force during movement of the O-ring 108H can be facilitated in the compression stroke. Moreover, the rate of change in the damping force can be easily changed by adjusting the angle of the inclined portion 431 with respect to the axial direction of the valve seat member 109H.

Moreover, in the damping force generation device 1H, because the notch 141H is provided at the axial end of the valve seat member 109H, the notch 141H can be easily formed on the valve seat member 109H. For example, when the valve seat member 109H is formed in sintering, the notch 141H can be formed at the time of sintering.

### INDUSTRIAL APPLICABILITY

A damping force generation device according to the above-described aspect of the present invention can suppress the occurrence of abnormal noise.

### REFERENCE SIGNS LIST

1, 1A to 1H Damping force generation device
3 Inner tube (tubular member)
5D Cylinder (tubular member)
22 Upper chamber (first chamber)
23 Lower chamber (second chamber)
21, 21D Piston (first regulation member)
25, 25D Piston rod (shaft member)
92 First passage (first flow path)
95C Case member (second regulation member)
108, 108A to 108F, 108H O-ring (elastic member)
109, 109A, 109B, 109E to 109H Valve seat member (second regulation member)
141E to 141G Seal groove (concave portion)
141Ea, 141Fa, 141Ga, 141Ha Bottom portion
141Eb, 141Fb, 141Gb, 141Hb Sidewall portion
141H Notch (concave portion)
144, 144A to 144H Passage portion (third flow path)
145, 145A to 145H Passage portion (fourth flow path)
147, 147A to 147H Pressure storage chamber (third chamber)
148, 148A to 148H Pressure storage chamber (fourth chamber)
150, 150A to 150H Outer shell portion
151, 151A to 151H Pressure storage portion
182 Second passage (second flow path)
295B Chamber forming member (second regulation member)
304C Elastic disc (elastic member)
308C Passage disc (second regulation member)
144C Passage portion (third flow path)
321C Disc spring (first disc spring)
331C Disc spring (second disc spring)
401, 431 Inclined portion
411, 411G First inclined portion (inclined portion)
412, 412G Second inclined portion (inclined portion)
423 Third inclined portion (inclined portion)

1. A damping force generation device comprising:
a first regulation member configured to divide an inside of a tubular member into a first chamber and a second chamber and have a first flow path connected between the first chamber and the second chamber; and
a second regulation member having a second flow path provided at least partially parallel to the first flow path and connected between the first chamber and the second chamber and a third flow path branching from the second flow path and connected to a pressure storage portion whose volume is changeable,
wherein the pressure storage portion comprises,
an elastic member; and
an outer shell portion whose inside is divided into a third chamber and a fourth chamber by the elastic member,
wherein the third flow path is connected to one or the third chamber and the fourth chamber,
wherein the elastic member is an annular O-ring having elasticity, and
wherein the outer shell portion is provided between the second regulation member and a shaft member inserted into the second regulation member.

2. A damping force generation device comprising:
a first regulation member configured to divide an inside of a tubular member into a first chamber and a second chamber and have a first flow path connected between the first chamber and the second chamber; and
a second regulation member having a second flow path provided at least partially parallel to the first flow path and connected between the first chamber and the second chamber and a third flow path branching from the second flow path and connected to a pressure storage portion whose volume is changeable,
wherein the pressure storage portion comprises
an elastic member; and
an outer shell portion whose inside is divided into a third chamber and a fourth chamber by the elastic member,
wherein the third flow path is connected to one of the third chamber and the fourth chamber,
wherein the elastic member is arranged on a concave portion provided on the second regulation member,
wherein the concave portion has
a bottom portion arranged inside or outside of the second regulation member in a radial direction; and
a sidewall portion arranged on at least one side of the second regulation member in an axial direction, and
wherein the sidewall portion has an inclined portion inclined with respect to the axial direction of the second regulation member.

3. (canceled)

4. The damping force generation device according to claim 2,
wherein the elastic member is an annular O-ring having elasticity, and
wherein the outer shell portion is provided between the second regulation member and a shaft member inserted into the second regulation member.

5. The damping force generation device according to claim 2, wherein the second regulation member has a fourth flow path for connecting the second chamber to the other of the third chamber and the fourth chamber.

6. (canceled)

7. The damping force generation device according to claim 2, wherein the inclined portion has a first inclined portion and a second inclined portion with different angles with respect to the axial direction of the second regulation member.

8. The damping force generation device according to claim 2, wherein the inclined portion is formed so that an angle formed with respect to the axial direction of the second regulation member differs according to a position of the second regulation member in a circumferential direction.

9. The damping force generation device according to claim 2, wherein the concave portion is provided at an end of the second regulation member in the axial direction.

10. The damping force generation device according to claim 1, wherein the second regulation member has a fourth flow path for connecting the second chamber to the other of the third chamber and the fourth chamber.
